(19) United States
(12) Patent Application Publication
(10) Pub. No.: US 2024/0424470 A1
(43) Pub. Date: Dec. 26, 2024

(54) RADIATIVELY RECUPERATED REACTOR SYSTEM AND RELATED METHODS, SUCH AS CHEMICAL LOOPING PROCESSES

(71) Applicant: Massachusetts Institute of Technology, Cambridge, MA (US)

(72) Inventors: Aniket Sanjay Patankar, Mumbai (IN); Ahmed Fouad Ghoniem, Winchester, MA (US); Xiao Yu Wu, Qingyuan City (CN); Wonjae Choi, Cambridge, MA (US); Harry L. Tuller, Wellesley Hills, MA (US)

(73) Assignee: Massachusetts Institute of Technology, Cambridge, MA (US)

(21) Appl. No.: 18/294,831

(22) PCT Filed: Aug. 5, 2022
(86) PCT No.: PCT/US2022/039518

§ 371 Date: Feb. 2, 2024

Related U.S. Application Data
(60) Provisional application No. 63/229,946, filed on Aug. 5, 2021.

(51) Int. Cl. B01J 19/24

(52) U.S. Cl. CPC B01J 19/245; B01J 19/2465; B01J 2219/00281; B01J 2219/0059

(57) ABSTRACT

What is disclosed relates to a novel reactor system design for chemical looping solar fuel production processes incorporating temperature swing between two or more zones, wherein two or more individual reactors are employed, and heat is recuperated between the reactors by means including radiative heat exchange. Each individual reactor comprising the overall system is isolated from other reactors and the external environment for gas exchange purposes, so that the inflow and outflow of chemical species from individual reactors can be controlled. Individual reactors are arranged in the form of a moving train, and heat exchange between a pair of reactors is facilitated by radiative exchange. External heat addition and removal between the system and its environment may be achieved by means including radiative heat exchange with the hot source and convective exchange with the cold source. This may include, in a particular embodiment, the use of solar irradiation. The disclosure also includes procedures for operating such a system.

### RELATED APPLICATIONS

This application claims priority under 35 U.S.C. § 119 (e) to U.S. Provisional Patent Application No. 63/229,946 filed Aug. 5, 2021, and entitled “Radiatively recuperated reactor system for temperature-swing chemical looping fuel-production processes,” which is incorporated herein by reference in its entirety for all purposes.

### BACKGROUND

Thermochemical redox cycles provide a pathway for producing hydrogen and carbon monoxide by splitting water and carbon dioxide respectively at temperature and pressure conditions that can be realized in engineering systems. As a particular example, thermochemical cycles employing metal oxide redox materials can harness heat from the sun to undergo reduction. The reduced metal oxides can then be re-oxidized by reacting with water, producing hydrogen or with carbon dioxide, producing carbon monoxide [1,2]. This process can be repeated, cycling the metal oxide between reducing and oxidizing conditions.

Such systems, as well as other chemical looping systems, often employ temperature swing between the two steps to achieve enhanced performance [3,4].

### SUMMARY

This Summary introduces a selection of concepts in simplified form that are described further below in the Detailed Description. This Summary does not necessarily identify key or essential features, nor necessarily limits the scope, of the claimed subject matter.

The following Detailed Description references the accompanying drawings which form a part this application, and which show, by way of illustration, specific example implementations. Other implementations may be made without departing from the scope of the disclosure.

Certain aspects of the present disclosure relate to the design of temperature-swing chemical looping systems. Pressure-swing may also be implemented. This novel design and operating procedure can significantly improve system efficiency by recuperating and reusing heat as the reactor switches between hot and cold steps, while overcoming the practical limitations of previously proposed designs [5-7].

In one aspect, a system is disclosed. In some embodiments, the system comprises: a first reactor (R1); a second reactor (R2); a high-temperature reaction zone (HT); a low-temperature reaction zone (LT); and a heat exchange zone (Recuperation); wherein the system is configured to cycle through the following four successive steps: a. R1 in LT and R2 in HT; b. R1 and R2 in Recuperation; c. R2 in LT and R1 in HT; and d. R1 and R2 in Recuperation; and wherein following step d, the system returns to step a.

In another aspect, a method is disclosed. In some embodiments, the method is a method of operating a system disclosed herein. In some embodiments, a method of operating a system comprising a first reactor (R1), a second reactor (R2), a high-temperature reaction zone (HT), a low-temperature reaction zone (LT), and a heat exchange zone (Recuperation) is disclosed, the method comprising: cycling through the following four successive steps: a. positioning R1 in LT and R2 in HT; b. positioning R1 and R2 in Recuperation; c. positioning R2 in LT and R1 in HT; and d. positioning R1 and R2 in Recuperation; and following step d. positioning R1 in LT and R2 in HT.

### BRIEF DESCRIPTION OF THE DRAWINGS

FIG. 1 is a schematic of a quasi-continuous mode of operation for a two-step thermochemical cycle with temperature swing, according to some embodiments. There are two reactors (R1 and R2) and three zones in these embodiments. The arrows indicate the direction of motion of reactors in each step.

FIG. 2 is a schematic of a reactor train in a continuous mode of operation, according to some embodiments. The system in these embodiments comprises (e.g., consists of) n reactors, with i reactors 208 in LT-SS (zone 204), j-i reactors being radiatively heated in the recuperation zone (zone 206), k-j reactors in HT-SS (zone 202), and n-k reactors being radiatively cooled in the recuperation zone. The arrows indicate the direction of motion of reactors along the train.

FIG. 3 is (Left) a cross-section of an evacuated tube 322 carrying liquid metal 324, which serves as a heat transfer fluid, according to some embodiments. FIG. 3 (Right) is a bundle of evacuated tubes 322 carrying liquid metal 324 exchanging heat with reactors 308 in HT-SS zone 302, according to some embodiments.

FIG. 4 (Top) is a schematic of a Reactor Train (RT) system, according to some embodiments. Thick arrows mark the direction of motion of reactors. FIG. 4 (Bottom) shows details of an individual reactor, according to some embodiments.

FIG. 5 illustrates an exemplary 3D geometry of a reactor, according to some embodiments. The window is shown at the top, while the central cavity-shaped components are the redox material. Numbers on the axes show dimensions in meters.

FIG. 6 is a side view of the reactor in FIG. 5 showing the mass transfer system in detail, along with external piping and gas tanks, according to some embodiments. At the point of connection, between the moving and stationary regions, the inlet and outlet streams flow through two co-axial pipes having an annular region for inflow (outer straight thin arrows) and central region for outflow (inner straight thin arrows).

FIG. 7 (Left) is a cross-section of a graphite pipe (circle outline) carrying molten metal (e.g., molten tin) (circle filling), according to some embodiments. FIG. 7 (Right) is a schematic of a reduction zone of a Reactor Train system heated by an array of such pipes, according to some embodiments. Compare to the reduction zone in FIG. 4 which uses a rectangle on the left hand side of the top figure to indicate a radiative heat source.

FIG. 8 is a schematic of an oxidation zone, wherein oxidation is done by water-splitting, according to some embodiments. Motion of reactors is shown by short arrows; the flow water-hydrogen mixture is indicated by long arrows. Nonstoichiometry of the redox material in reactor i is marked 8; and the hydrogen mole fraction leaving reactor i is marked x_{H2}, i. As the reactors get oxidized: δ_{red}>δ₁>δ₂>δ₃>δ₄>δ_{oxd}. Simultaneously, as the steam gets converted to hydrogen: xᵢ>x_{H}_{₂}_{, 1}>x_{H}_{₂}_{, 2}>x_{H}_{₂}_{, 3}>x_{H}_{₂}_{, 4}>x_{f}.

FIG. 9 (Top) shows three RT systems having double-windowed reactors, according to some embodiments. FIG. 9 (Bottom) shows details of a double-windowed reactor, according to some embodiments. Reactors in a train can exchange heat with reactors in neighboring trains (shown by vertical arrows). Thus, in some embodiments, reactors being heated up in the cold steam of the heat recovery zone receive heat from two reactors (above and below) instead of one.

FIG. 10 is a schematic of a Reactor Train System (RTS) for solar-driven thermochemical water-splitting, according to some embodiments. This RTS embodiment has a buffer thermal energy storage (TES). Waste heat recovery is implemented in this embodiment with a radiative heat sink coupled to a power cycle that produces electricity. In this embodiment, oxygen is evolved in the reduction zone and steam is converted to hydrogen in the oxidation zone. Radiative heat transfer (\dot{q}_{recov.}) can be employed for heat recovery between Tₕₒₜ and T_{cold}.

FIG. 11 is a schematic of an example of the reactor in FIG. 4 showing the mass transfer system in detail, along with internal channels and external manifolds, according to some embodiments. A retractable conduit can carry inlet and outlet streams through two co-axial pipes having an annular region for inflow (outer straight thin arrows) and central region for outflow (inner straight thin arrows).

FIGS. 12A-12B show depressurizing reactors by connecting them to low pressure manifold(s). The multi-manifold system in FIG. 12B can also be referred to as a Pressure Cascade.

FIGS. 13A-13B are schematics of thermochemical oxygen pumping, according to some embodiments. In some such embodiments, in FIG. 13A, oxygen released by ceria during the reduction phase of TC is absorbed by SFO. In such embodiments, the SFO is regenerated by heating it up to a temperature around 750° C. FIG. 13B illustrates counterflow between a first train of reactors that perform water splitting and a second train of reactors that perform oxygen pumping, wherein the counterflow spans all of a reduction zone, a recuperation zone, and an oxidation zone, according to some embodiments.

FIG. 14 is a schematic of twelve (12) RTS trains linked to a single thermal energy storage unit, according to some embodiments.

FIG. 15 illustrates a reactor train system, according to some embodiments.

FIG. 16 illustrates details of an individual reactor, according to some embodiments.

FIG. 17 illustrates a schematic of a reduction zone of a reactor train system heated by an array of graphite tubes carrying molten metal, according to some embodiments.

FIG. 18 illustrates a ‘layered’ model of a reactor as it exchanges heat with a radiative heat source, with a 2D (two-dimensional) reactor shown in inset along with corresponding dotted boundaries, according to some embodiments.

FIG. 19 illustrates a base configuration of a reactor train system, with eight (8) reactors each in reduction (R) and oxidation (O) zones, and 20 reactors each on the hot (H) and cold (C) sides of a heat recovery zone, according to some embodiments.

FIG. 20 illustrates the temperature of ceria in various reactors at the end of an exchange, where each cross or circle represents a reactor, with some reactor positions marked with reference to FIG. 19, according to some embodiments.

FIG. 21 illustrates non-stoichiometry of ceria in various reactors at the end of an exchange, where each cross or circle represents a reactor, with some reactor positions marked with reference to FIG. 19, according to some embodiments.

FIG. 22 illustrates average rates of heat transfer and hydrogen production in kilowatts, according to some embodiments.

FIG. 23 illustrates temperature profiles within the insulation at various positions of the cycle-C1 (solid), R8 (dashed), H20 (dash-dot), O8 (dotted), according to some embodiments.

FIG. 24 illustrates Thermochemical Water-splitting with Ceria, according to some embodiments.

FIG. 25 is a Schematic of Thermochemical Oxygen Pumping (TcOP) with SrFeO₃, according to some embodiments.

FIG. 26 is a Schematic of a Reactor Train System (RTS) [M55] with Thermal Energy Storage, in which Waste Heat recovered from oxidation is recovered and converted to electricity in a Heat Engine, or alternatively, the heat may be used directly for TcOP, according to some embodiments.

FIG. 27 is a Schematic of Pressure Recovery within the low-temperature sub-section of a Heat Recovery Zone, according to some embodiments.

FIG. 28A-28C illustrate vacuum pumping configurations for RTS, according to some embodiments. FIG. 28A illustrates a single-manifold vacuum pumping scheme, according to some embodiments. FIG. 28B illustrates a multi-manifold ‘Pressure Cascade’, according to some embodiments. FIG. 28C illustrates another set of embodiments of the Pressure Cascade, used in the modeling described herein, wherein n_{O}_{₂}₋ᵢ is in moles, and Ŵ_{ideal-i} is in KJ/mol-O₂.

FIG. 29 illustrates variation of pump efficiency (ηₚᵤₘₚ from Brendelberger et al. [M56]), cascade efficiency (η_{cascade-∞}) and the ratio of cascade and single-manifold pumping work (f_{cascade-∞}) with p_{red}, wherein efficiencies are denoted as fractions rather than percentage, according to some embodiments.

FIG. 30A-30B are schemes for driving the flow of oxygen from the ceria reactor to SFO reactor, according to some embodiments. FIG. 30A illustrates pressure-driven flow, according to some embodiments. FIG. 30B illustrates circulating inert gas, according to some embodiments.

FIG. 31 illustrates counterflow between ceria and SFO reactors in a reduction zone, according to some embodiments.

FIG. 32 is a schematic of an SFO regeneration section, wherein after oxidation the SFO reactor comes in on the left, is heated and reduced in the middle, and finally cooled down on the right, according to some embodiments.

FIG. 33 illustrates a model for oxygen exchange between counter-moving streams of ceria and SFO, according to some embodiments.

FIG. 34 is a graphical representation of non-stoichiometry profiles in counter-moving streams of ceria and SFO, according to some embodiments.

FIG. 35 illustrates the effect of lowering T_{red} on the improved system efficiency of RTS+VP (dashed curve) and RTS+TcOP (solid curve) systems, according to some embodiments.

FIG. 36 illustrates a reactor train involving splitting of water and/or carbon dioxide, which produces hydrogen and/or carbon monoxide respectively, in some cases co-occurring within the same reactor, according to some embodiments.

### DETAILED DESCRIPTION

What is disclosed, in accordance with certain embodiments, relates to a novel reactor system design for chemical looping solar fuel production processes incorporating temperature swing between two or more zones, wherein two or more individual reactors are employed, and heat is recuperated between the reactors by radiative heat exchange. According to certain embodiments, each individual reactor comprising the overall system is isolated from other reactors and the external environment for gas exchange purposes, so that the inflow and outflow of chemical species from individual reactors can be controlled. In some embodiments, individual reactors are linked in the form of a moving train, and heat exchange between a pair of reactors is facilitated by radiative exchange. In certain embodiments, external heat addition and removal between the system and its environment may be achieved by means including radiative heat exchange with the hot source and convective exchange with the cold source. This may include, in a particular embodiment, the use of solar irradiation. The disclosure also includes procedures for operating such a system.

Reference numbers in brackets “[ ]” herein (which may or may not include the prefix “M” in the reference number) refer to the corresponding literature listed in the attached Bibliography which forms a part of this Specification, and the literature is incorporated by reference herein.

Herein is described two non-limiting modes of operation of embodiments of the invention, relating to quasi-continuous and continuous operation, including two different designs of the system. Also described are of components of the system, including individual reactors, external heat exchange mechanisms, materials used, mechanism of operation, and the like.

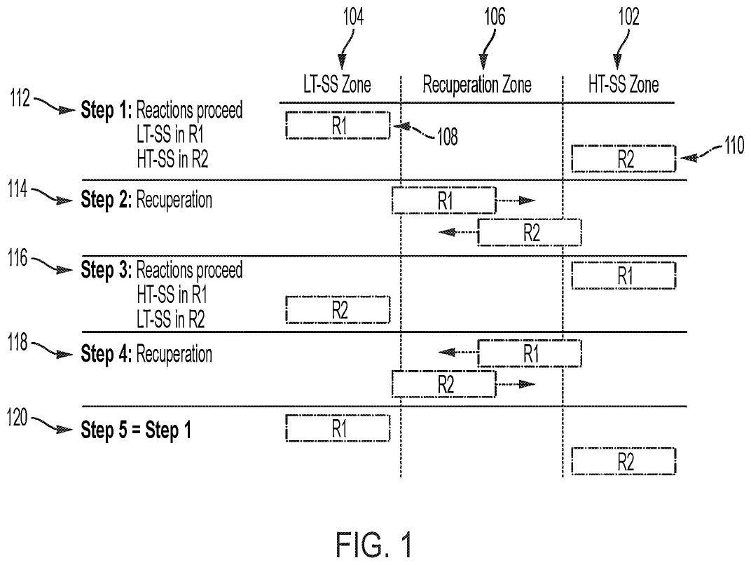

### Quasi-Continuous Mode of Operation (e.g., FIG. 1)

In a particular embodiment of this mode of operation, two reactors (e.g., R1 (108) and R2 (110) of FIG. 1) are employed in a cyclic process having one high temperature sub-step (HT-SS) and one low temperature sub-step (LT-SS). The overall system may comprise (e.g., consists of) three zones: one zone each for HT-SS (e.g., zone 102 in FIG. 1) and LT-SS (e.g., zone 104 in FIG. 1), and one zone for heat exchange between reactors, called the Recuperation Zone (e.g., zone 106 in FIG. 1). A schematic of the thermochemical cycle with this embodiment is shown in FIG. 1. Both LT-SS and HT-SS reactions may proceed simultaneously in steps 1 (112) and 3 (116) of FIG. 1, leading to a quasi-continuous operation. This is in contrast to the case with a single reactor, wherein either the LT-SS or the HT-SS can proceed at one time.

A key feature of certain embodiments of the invention is heat recovery between HT-SS and LT-SS, which proceeds by radiative heat exchange between R1 and R2 in steps 2 (114) and 4 (118) (with reference to FIG. 1). Moreover, the motion of R1 and R2 may be such that a ‘counter-flow effect’ is achieved in these steps, so that very high effectiveness of heat exchange can be realized. The ‘counter-flow effect’ may occur in counterflow heat exchangers, which can achieve much higher effectiveness than parallel flow heat exchangers. This effect can be achieved by making the lengths of R1 and R2 much longer than the radiative gap between them. The speed of R1 and R2 as they move past each other in the recuperation zone can be selected to ensure a quick transition as well as efficient heat exchange.

### Continuous Mode of Operation

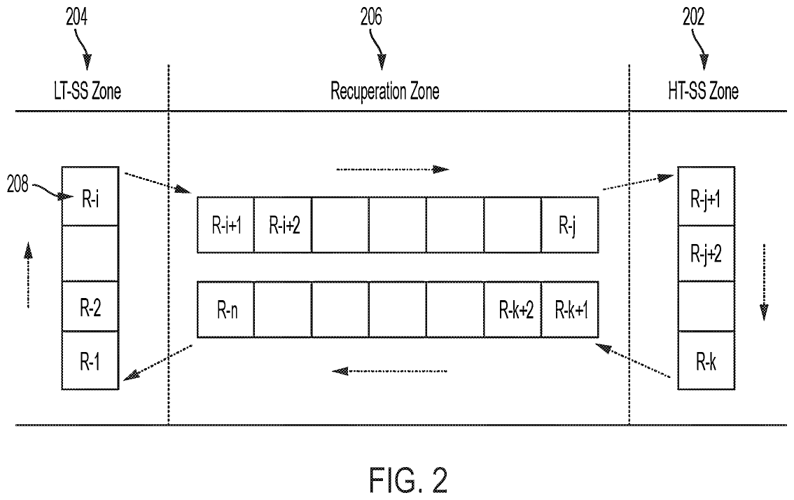

In a particular embodiment of this mode of operation, a train of several reactors is employed, so that different reactors can be in each of the three zones shown in FIG. 1 at the same time. In other words, HT-SS, LT-SS and heat exchange can take place simultaneously, so that reactions proceed continuously in the overall system. A schematic of such a reactor train is shown in FIG. 2. The reactor train may comprise (e.g., is made of) identical reactors 208, R−j+1, and others, e.g., linked to each other (e.g., using flexible hinges), that can allow them to circle around the loop. Neighboring reactors do not necessarily communicate with each other thermally, or exchange gases.

The continuous mode of operation may facilitate continuous use of an external high temperature heat source, which may be, for example, concentrated solar radiation. Additionally, the number of reactors (equivalently, the residence time) in each of the three zones can be varied independently consistent with the timescales of the chemical reactions and heat exchange happening in each region. The recuperation zone may resemble a counterflow heat exchanger, with individual reactors exchanging energy with the opposite ‘stream’ of reactors. Consequently, this configuration may be capable of very high effectiveness of heat exchange by reducing the temperature difference between two reactors facing each other.

### Configuration of Individual Reactors

Each individual reactor in FIGS. 1 and 2, and other embodiments of this invention, may comprise (e.g., consists of) an active redox material, along with any possible inert or participating materials, enclosed in a casing that may be sealed and/or insulated. The reactor casing may be designed to facilitate individual reactors to operate at atmospheric pressure, sub-atmospheric pressure or vacuum, or higher than atmospheric pressure. A reactor may include pressure and flow control devices, including vacuum pumps, valves, switches, etc. within its structure.

The reactor casing may have one or more windows or other external surfaces for radiative heat exchange with its surroundings. The reactor may also have ports for exchanging chemical species with its surroundings, especially in the LT and HT zones. The reactor may additionally have features to enhance heat and mass flow within itself and across its boundaries to exchange heat via radiation with the reactor facing it while moving through the Recuperation Zone. A reactor may further exchange charge or electric current with its environment, including other reactors. The design of all reactors in a system need not be the same; there may be variability to achieve enhanced overall chemical and thermal performance.

### Heat Exchange Mechanisms

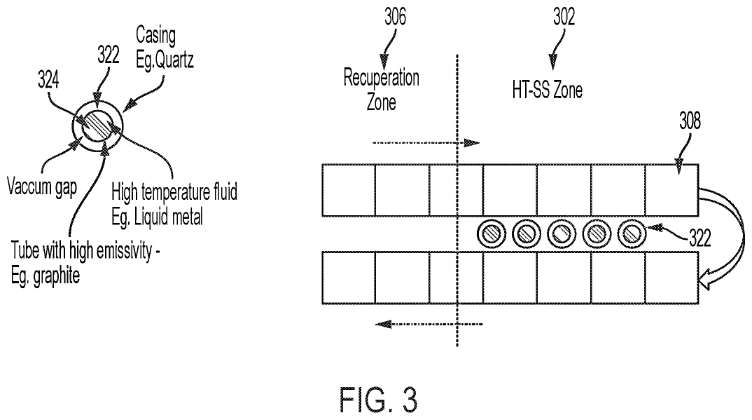

In a particular embodiment of the invention, the temperature of LT-SS and HT-SS zones may be maintained by radiative heat exchange with a stream of fluid or solid particles, or with a bath of fluid, or a solid mass, etc. A particular embodiment is shown in FIG. 3 for the HT-SS zone 302. Heat exchange can also be convective, depending on the temperature and the design of the HT and LT zone.

The medium or media responsible for maintaining the temperature in particular zones of the system, like the liquid metal in FIG. 3, may supply or carry away heat depending on the endothermic or exothermic nature of the reactions occurring in that zone, respectively. Heat may also be supplied or extracted to compensate for imperfect heat exchange in the recuperation zone. In a particular embodiment of the invention, the medium may be heated by an external heat source, including but not limited to solar heat, nuclear heat, heat of combustion, waste process heat, etc. On the other hand, excess heat carried away by the medium may be used, among other things, for powering one or more bottoming power cycles, as process heat in cycle-related or other processes, etc.

### Gas Exchange and Progress of Reactions

In a particular embodiment of the invention, gas exchange (reactants, products, diluents, etc.) to and from individual reactors can be achieved by mating mass exchange ports present on individual reactors with external mass exchange ports, or the ports on other reactors. These connections may be connected or disconnected as the reactor moves along the reactor train. The said gas exchange processes may or may not proceed in any region of the system, including the recuperation zone. Chemical reactions may or may not proceed in any region of the system depending on the particular embodiment of the invention, including the recuperation zone.

### Materials

In particular embodiments of the invention, individual reactors can be made up of materials including but not limited to glass, ceramics, metals and metallic alloys, graphite, silica, etc. as well as composites thereof. These may be in the form of the active chemical species, catalytic substances, support structures, structures facilitating flow or containment of mass, heat and charge, etc., depending on the position within the cycle.

### Mechanisms

In particular embodiments of the invention, the motion of reactors and the reactor train may be along a straight line, along a circular path, or other geometries. Connections between a reactor and its environment, and with other reactors, may allow for independent translation and rotation of individual reactors.

Embodiments of the invention may use more than one contiguous reactor train in linear, circular, or other configurations, with any particular reactor train exchanging heat and/or mass with other reactor trains.

### Examples of Advantages and Improvements Over Existing Methods, Devices and Materials

A particular field for which the invention is well-suited is that of thermochemical redox cycles that absorb heat at high temperatures and split water (WS) and/or carbon dioxide (CDS) to produce hydrogen and/or carbon monoxide respectively. Such systems usually employ a temperature swing and operate at elevated temperatures where radiative heat transfer can be effective [1,6,8-12].

With regard to previously proposed reactor designs for such systems, embodiments of the present invention can have the following novel features and/or address the following shortcomings:
1. Certain embodiments of the invention allow for efficient radiative heat exchange between individual reactors and their contents as they pass from the high-temperature zone to the low temperature zone. This can drastically improve the energy efficiency of the system. Reactors that do not incorporate this form of heat recuperation have been shown to use up to 60% of total energy input for reheating the reactors [9,10].
2. Certain embodiments of the invention allow for isolation of the fluid phase of each reactor. Existing reactors that facilitate efficient heat recuperation suffer from the inter-mixing of gaseous species across the high and low temperature zones [6,13]. Certain embodiments of the present invention prevent mixing of reactants and products between any two reactors, including those in the recuperation zone. Consequently, different reactors may be at different pressures and still be in physical proximity to each other. Sealing issues, which have posed significant challenges for some existing reactors [14], may be greatly simplified by using self-contained reactors.
3. Certain embodiments of the invention allow for flexibility of the heat source. Heat from a hot fluid or solid may be supplied radiatively to individual reactors in the HT. The said hot fluid or solid may be heated by an external energy source including solar, nuclear, chemical, etc. Further, the particular design and geometry of the system can be adjusted to facilitate direct heating by solar irradiation.
4. Certain embodiments of the invention allow for disparate residence times in the low and high temperature regions, and in the recuperation zone. This allows certain embodiments of the invention to be adapted for different kinds of chemical reactions. In the context of Water Splitting/Carbon Dioxide Splitting (WS/CDS) thermochemical cycles, this means that different redox materials can be used, and the timescales for thermal reduction and WS/CDS steps can be different. Existing reactors use complex control strategies to accommodate this difference of timescales [9].
5. Certain embodiments of the invention allow for reactions to proceed in the recuperation zone, facilitated by the isolation of each reactor in terms of mass exchange. At the same time, a reactor may exchange chemical species with its surroundings in a controllable manner using appropriate mass exchange ports and connecting mechanisms. This can speed up the overall cycle.
6. Certain embodiments of the invention allow for greater reliability and longevity because they involve the movement of entire reactors. Particle-based redox reactor systems for WS/CDS, which involve the movement of active redox particles, possibly along with supporting materials, are prone to changes in particle morphology [11]. On the other hand, systems using high temperature heat transfer fluids for temperature swing and heat recovery face challenges in terms of pumping, flow control, and heat loss through pipes [7]. In embodiments of the present invention, each reactor can be adequately insulated, so that moving them is easier and safer, and heat losses are minimized.

### Commercial Potential

Certain embodiments of the invention are most ideally suited for high temperature, temperature-swing chemical looping processes. An emerging application which has immense commercial potential is the generation of synthetic fuels using renewable energy [15]. Recently, the production of kerosene using water, carbon dioxide and solar energy was demonstrated [16]. The system involved high temperature, temperature-swing chemical looping processes for water and carbon dioxide splitting. These solar fuel technologies facilitate storage of intermittent renewable energy in the form of chemical energy. They can also play a key role in decarbonizing transportation and industry sectors, where electrification might be expensive [2].

As such, the commercial potential of certain embodiments of the present system and associated methods lies in facilitating efficient conversion of heat to chemical energy using a scalable reactor design. Further, certain embodiments of the present system and associated methods can make use of a variety of heat sources and provide opportunities for thermal integration with other systems. Certain embodiments of the present system and associated methods can also take advantage of new advances in materials science, chemistry, heat transfer etc.

In one aspect, a system is disclosed. In some embodiments, the system comprises a first reactor (R1). For example, in FIG. 1, the system comprises reactor R1 (108). In some embodiments, the system further comprises a second reactor (R2). As one example, in FIG. 1, the system comprises reactor R2 (110). Additional reactors may also be present. For example, in some embodiments, the system comprises at least 5 reactors, at least 10 reactors, at least 20 reactors, or more. As noted below, the reactors can be arranged in a train, in accordance with certain embodiments.

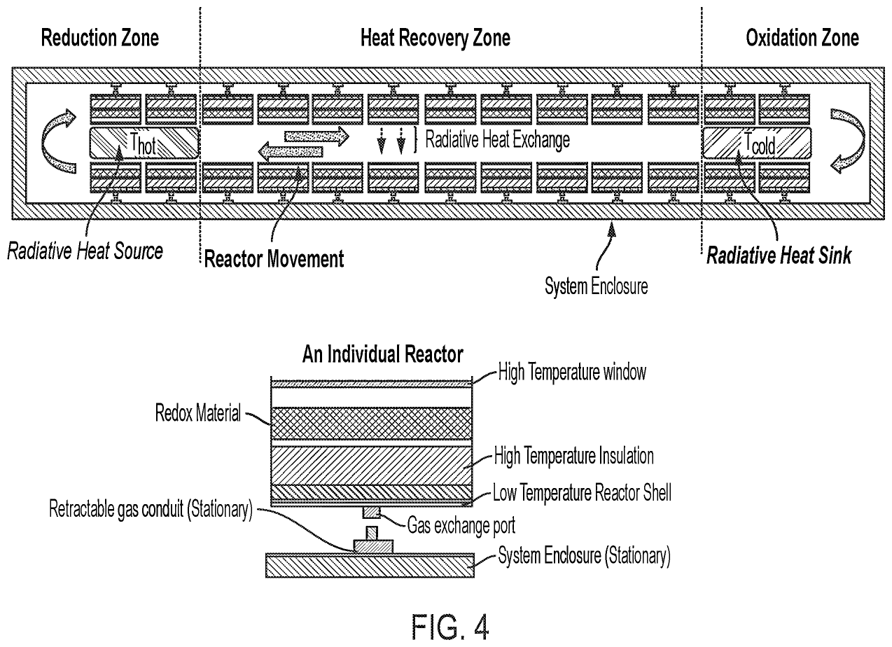

R1 or R2 or both and/or additional reactor(s) in the system may comprise a catalyst, active redox material, or both. As one example, the reactor shown in FIG. 4 includes a redox material. In some embodiments, the catalyst or the active redox material or both may be porous. In certain embodiments, the catalyst or the redox material or both may be enclosed in a casing that is sealed and/or insulated. In some embodiments. R1 or R2 or both and/or additional reactor(s) in the system consists of active redox material and optional inert or participating materials. The redox material may be enclosed in a casing that is sealed and/or insulated.

R1 or R2 or both and/or additional reactor(s) in the system may operate at atmospheric pressure, sub-atmospheric pressure or vacuum, or higher than atmospheric pressure. In some embodiments, R1 or R2 or both and/or additional reactor(s) in the system comprise pressure and flow control devices. R1 or R2 or both and/or additional reactor(s) in the system may comprise vacuum pumps, valves, electrochemical membranes and/or switches within its structure. In certain embodiments, the pressure within each reactor can be controlled, and systems for such control are described in more detail below.

R1 or R2 or both and/or additional reactor(s) in the system may comprise one or more windows or other surfaces for radiative heat exchange with its surroundings. One example of this is illustrated in FIG. 4, in which the reactor comprises a high temperature window that permits radiative heat exchange with other reactors in the system (illustrated via arrows in the top portion of FIG. 4). The reactor casing of R1 or R2 or both and/or additional reactor(s) in the system may comprise one or more windows or other external surfaces for radiative heat exchange with its surroundings.

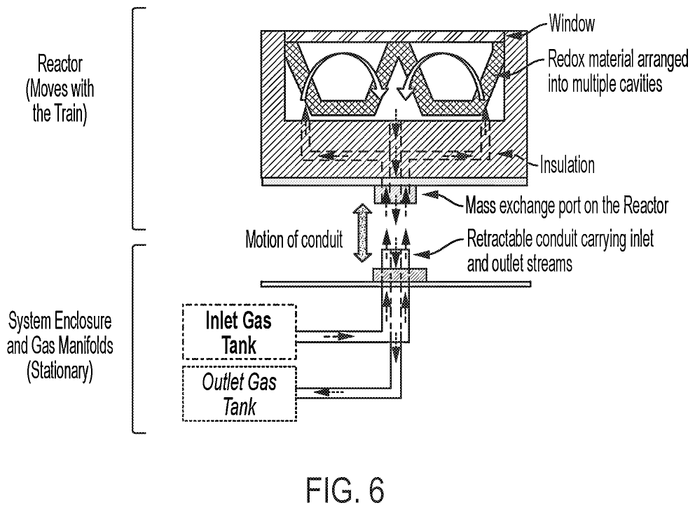

In some embodiments, R1 or R2 or both and/or additional reactor(s) in the system comprise ports for exchanging chemical species with its surroundings in the LT zone or the HT zone or the Recuperation zone or more than one of these. The ports may be fluidically connected to fluidic channels that form heat exchangers within R1 or R2 or both and/or additional reactor(s) in the system. R1 or R2 or both and/or additional reactor(s) in the system may comprise ports for exchanging chemical species with its surroundings in the LT and HT zones. As one example, FIG. 6 is a schematic illustration of a reactor that includes ports connected to an inlet gas tank and an outlet gas tank.

In some embodiments, the system comprises a high-temperature reaction zone (HT) and a low-temperature reaction zone (LT). For example, in FIG. 1, the system includes HT zone 102 and LT zone 104. In some embodiments, the HT zone is be configured to contain an endothermic reaction, and the LT zone is configured to contain an exothermic reaction. An endothermic reaction generally refers to a non-spontaneous reaction, and an exothermic reaction generally refers to a spontaneous reaction.

In some embodiments, the system comprises a heat exchange zone (Recuperation). For example, in FIG. 1, the system comprises Recuperation Zone (106). In accordance with certain embodiments, the Recuperation Zone can be configured such that heat from relatively hot reactors leaving HT (e.g., the reactors shown at the top of the system illustrated at the top of FIG. 4) is transferred to relatively cold reactors leaving LT (e.g., the reactors shown at the bottom of the system illustrated at the top of FIG. 4).

In some embodiments, the system is configured to cycle through the following four successive steps: (a) R1 in LT and R2 in HT; (b) R1 and R2 in Recuperation; (c) R2 in LT and R1 in HT; and (d) R1 and R2 in Recuperation; and wherein following step d, the system returns to step a. By cycling the reactors in this way, in accordance with certain embodiments, each reaction can be used to perform a step in a chemical process (e.g., a reversible chemical process, such as a reversible redox reaction) while using hot reactors to pre-heat reactors for which the heat can be used to drive a subsequent reaction.

In some embodiments, at least one product of the reaction conducted in the HT zone is a reactant in the LT zone. The product can remain within the reactor throughout each reaction, in accordance with certain embodiments. For example, in some embodiments, a product (or more than one product) of the reaction performed in the HT zone (e.g., an exothermic reaction) may be contained within a reactor, the reactor may be transported from the HT zone to the LT zone, and then the product can be used as a reactant of a reaction performed in the LT zone (e.g., an endothermic reaction). As one non-limiting example, in some embodiments, multiple reactors in the system can be cycled from the HT zone (where one chemical reaction is performed in the reactor) to the Recuperation zone (where heat from the reactor is transferred to one or more other reactors in the train), to the LT zone (where a chemical reaction is performed in the reactor that uses, as a reactant, a product of the chemical reaction that was performed in that reactor in the HT zone), to the Recuperation zone (wherein heat from one or more reactors in the train is transferred to the reactor), and back to the HT zone. In certain embodiments, this product/reactant that is used in the reactor is a redox material that is retained within the reactor. In some such embodiments, other products in the gas phase are removed from the reactor.

In some embodiments, the endothermic reaction is a reduction reaction, and the exothermic reaction is an oxidation reaction.

In some embodiments, the system is configured such that, during step b, at least 50%, at least 60%, at least 70%, at least 80%, at least 90%, or at least 95% of the thermal energy that is transferred from R2 to one or more other reactors in the system (e.g., R1 or another reactor) is transferred via radiative heat transfer. In some embodiments, the system is configured such that, during step d, at least 50%, at least 60%, at least 70%, at least 80%, at least 90%, or at least 95% of the thermal energy that is transferred from R1 to one or more other reactors in the system (e.g., R2 or another reactor(s)) is transferred via radiative heat transfer. In some embodiments, at least 50%, at least 60%, at least 70%, at least 80%, at least 90%, or at least 95% of the thermal energy that is transferred between reactors within the Recuperation Zone is transferred via radiative heat transfer.

R1 or R2 or both and/or additional reactor(s) in the system may comprise features to enhance heat and mass flow within the reactor(s) and/or across the boundaries or the reactor(s) to exchange heat via radiation with the reactor facing it while moving through the Recuperation Zone. In some embodiments, such features include forming the redox material into one or more cavities. The presence of one or more cavities in the redox material can allow for faster radiative heat exchange.

R1 or R2 or both and/or additional reactor(s) in the system may exchange charge or electric current with its environment. For example, one or more electrical conductors may be placed in electrical communication with the catalyst or redox material or both, and one or more of (e.g., each of) the electrical conductor(s) may be extended into one or more portions of the environment. Alternatively, at least one of (e.g., each of) the one or more electrical conductors may be connected to one or more device assemblies within the reactor, e.g., one or more of heaters, pumps, electrochemical membranes, etc.

In some embodiments, the speed of R1 and R2 as they move past each other in the Recuperation zone is configured for a quick transition and/or an efficient heat exchange. The speed or residence time in the Recuperation zone may be selected to reduce heat losses and/or increase heat recuperation and system throughput. In some embodiments, this residence time (e.g., in step b and/or d) is greater than or equal to 5 minutes, greater than or equal to 10 minutes, greater than or equal to 20 minutes, or greater than or equal to 30 minutes. In some embodiments, this residence time (e.g., in step b and/or d) is less than or equal to 60 minutes, less than or equal to 50 minutes, or less than or equal to 40 minutes. Combinations of the above-referenced ranges are also possible (e.g., greater than or equal to 5 minutes and less than or equal to 60 minutes, greater than or equal to 10 minutes and less than or equal to 50 minutes, greater than or equal to 20 minutes and less than or equal to 40 minutes). Other ranges are also possible.

In some embodiments, the maximum temperature within HT is at least 750° C., at least 850° C., at least 1000° C., at least 1100° C., at least 1200° C., at least 1300° C., at least 1400° C., or at least 1500° C. In some embodiments, the maximum temperature within HT is at most 1700° C. or at most 1600° C. Combinations of the above-referenced ranges are also possible (e.g., at least 750° C. and at most 1700° C., at least 1100° C. and at most 1700° C., at least 1200° C. and at most 1600° C.). Other ranges are also possible. In certain embodiments, the temperature in HT can be at least 1100° C. and at most 1700° C.

In some embodiments, the maximum temperature within LT is less than or equal to 700° C., less than or equal to 600° C., less than or equal to 500° C., less than or equal to 400° C. less than or equal to 350° C., less than or equal to 250° C., less than or equal to 150° C., less than or equal to 100° C., or less than or equal to 50° C. In some embodiments, the maximum temperature within LT is at least 0° C., at least 20° C., or at least 25° C. Combinations of the above-referenced ranges are also possible (e.g., at least 0° C. and less than or equal to 700° C., at least 20° C. and less than or equal to 350° C.). Other ranges are also possible.

In some embodiments, the difference between the maximum temperature in the HT zone and the maximum temperature in the LT zone can be relatively high. For example, in some embodiments, the difference between the maximum temperature in the HT zone and the maximum temperature in the LT zone can be at least 50° C., at least 100° C., at least 250° C., at least 500° C. at least 750° C., at least 1000° C., or higher. In some embodiments, the difference between the maximum temperature in the HT zone and the maximum temperature in the LT zone can be less than or equal to 2500° C., less than or equal to 1500° C., less than or equal to 1250° C., or less. Combinations of the above-referenced ranges are also possible. Other ranges are also possible.

In some embodiments, a reactor (e.g., R1 or R2 or both and/or additional reactors in the system) comprises (e.g., consists of) at least one reactive material (e.g., a redox active material), and some form of an enclosing structure.

In some embodiments, during step a: contents of R1 are at a first pressure; and contents of R2 are at a second pressure that is lower than the first pressure.

The first pressure may be greater than or equal to 0.5 atmospheres, greater than or equal to 1 atmosphere, greater than or equal to 2 atmospheres, greater than or equal to 3 atmospheres, greater than or equal to 4 atmospheres, or greater than or equal to 5 atmospheres. The first pressure may be less than or equal to 15 atmospheres, less than or equal to 10 atmospheres, less than or equal to 9 atmospheres, less than or equal to 8 atmospheres, less than or equal to 7 atmospheres, or less than or equal to 6 atmospheres. Combinations of the above-referenced ranges are also possible (e.g., greater than or equal to 0.5 atmospheres and less than or equal to 15 atmospheres, greater than or equal to 1 atmospheres and less than or equal to 10 atmospheres, greater than or equal to 2 atmospheres and less than or equal to 9 atmospheres). Other ranges are also possible. In certain embodiments, the first pressure is greater than 0.5 atmosphere. R1 can potentially be pressurized to higher pressures like 10 bar. In certain embodiments, pressures in the upper ranges on the order of 10 bar increase efficiency and compactness of system.

The second pressure may be greater than or equal to 0.00001 atmospheres, greater than or equal to 0.0001 atmosphere, or greater than or equal to 0.001 atmospheres. The second pressure may be less than or equal to 0.1 atmospheres, less than or equal to 0.05 atmospheres, or less than or equal to 0.01 atmospheres. Combinations of the above-referenced ranges are also possible (e.g., greater than or equal to 0.00001 atmospheres and less than or equal to 0.1 atmospheres, greater than or equal to 0.0001 atmospheres and less than or equal to 0.05 atmospheres, greater than or equal to 0.001 atmospheres and less than or equal to 0.01 atmospheres). Other ranges are also possible. In certain embodiments, the second pressure is less than or equal to 0.1 atmospheres.

In other embodiments, contents of R1 are at a first pressure; and contents of R2 are at a second pressure that is higher than the first pressure. In such embodiments, the high temperature step can be at higher pressure than the low-temperature step.

It should be understood, however, that in other embodiments, the second pressure (in R2) can be higher than the first pressure (in R1). Accordingly, in some embodiments, the second pressure may be greater than or equal to 0.5 atmospheres, greater than or equal to 1 atmosphere, greater than or equal to 2 atmospheres, greater than or equal to 3 atmospheres, greater than or equal to 4 atmospheres, or greater than or equal to 5 atmospheres and/or may be less than or equal to 15 atmospheres, less than or equal to 10 atmospheres, less than or equal to 9 atmospheres, less than or equal to 8 atmospheres, less than or equal to 7 atmospheres, or less than or equal to 6 atmospheres. In addition, in some embodiments, the first pressure may be greater than or equal to 0.00001 atmospheres, greater than or equal to 0.0001 atmosphere, or greater than or equal to 0.001 atmospheres, and/or less than or equal to 0.1 atmospheres, less than or equal to 0.05 atmospheres, or less than or equal to 0.01 atmospheres.

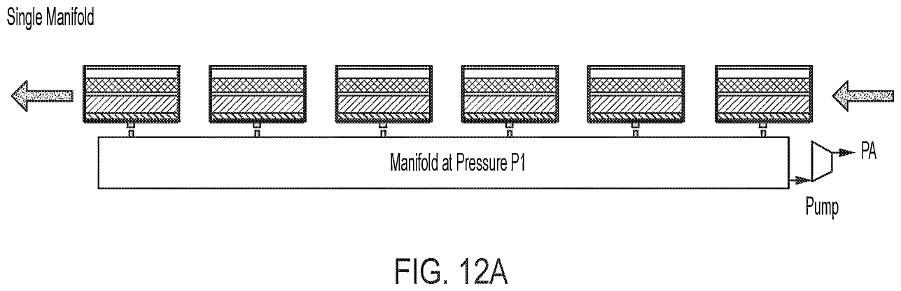

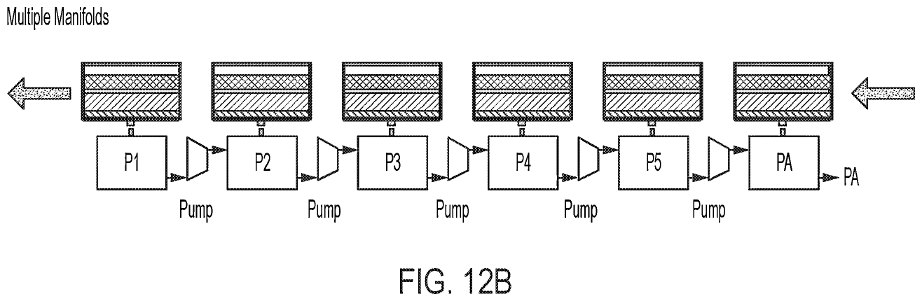

The system may comprise a third reactor (R3). Additional reactors can also be present. For example, FIG. 2 is a schematic illustration of a system that comprises 22 reactors, including reactor R1 (shown as reactor 208), reactor R2 (shown as reactor R−j+1) and reactor R3 (shown as reactor R-n). In some embodiments, during step a, contents of R3 are at a third pressure that is lower than the first pressure and greater than the second pressure. In certain embodiments, during step a, contents of R3 are at a third pressure that is lower than the second pressure and greater than the first pressure. In some embodiments, the third pressure is within 50%, within 40%, within 30%, within 20%, within 10%, within 5%, or within 1% of the geometric mean of the first pressure and the second pressure. Other ranges are also possible. In some embodiments: R1 is connected to a first external manifold that is at the first pressure; R2 is connected to a second external manifold that is at the second pressure; and R3 is connected to a third external manifold that is at the third pressure. One example of such a system is shown in FIG. 12B, in which a series of reactors are each connected to external manifolds that are at different pressures. In some embodiments, the pressures of the reactors in the recuperation zone form a gradient, such that pressures within the reactors successively decrease (or increase) as one moves from HT to LT. Gradients in electric potential and/or charge from one reactor to another are also possible.

In some embodiments, the system comprises a reactor train, e.g., a reactor train that is made of reactors linked to each other. The reactors can be linked to each other, for example, using flexible hinges, a conveyor belt, a track, or by any other suitable connection. Reactors need not be physically linked. In certain embodiments, the only physical connection or link between reactors is that they are placed on the same conveyer belt or rails. In some embodiments, reactors follow each other along a closed path but each reactor can have its own driving mechanism that moves it. For example, reactors may be arranged like baggage on a conveyer belt, wherein some and/or all of the bags are placed on and driven by the belt, but not otherwise connected to each other. In some such examples, reactors are placed on rails.

The reactor train may be configured such that the reactors can circle in a loop. In some embodiments, while the reactors circle in the loop, neighboring reactors do not communicate with each other thermally or exchange gases. Neighboring reactors may or may not exchange heat and/or mass with neighbors. In some embodiments, the Recuperation zone acts as a counterflow heat exchanger between regions of the reactor train.

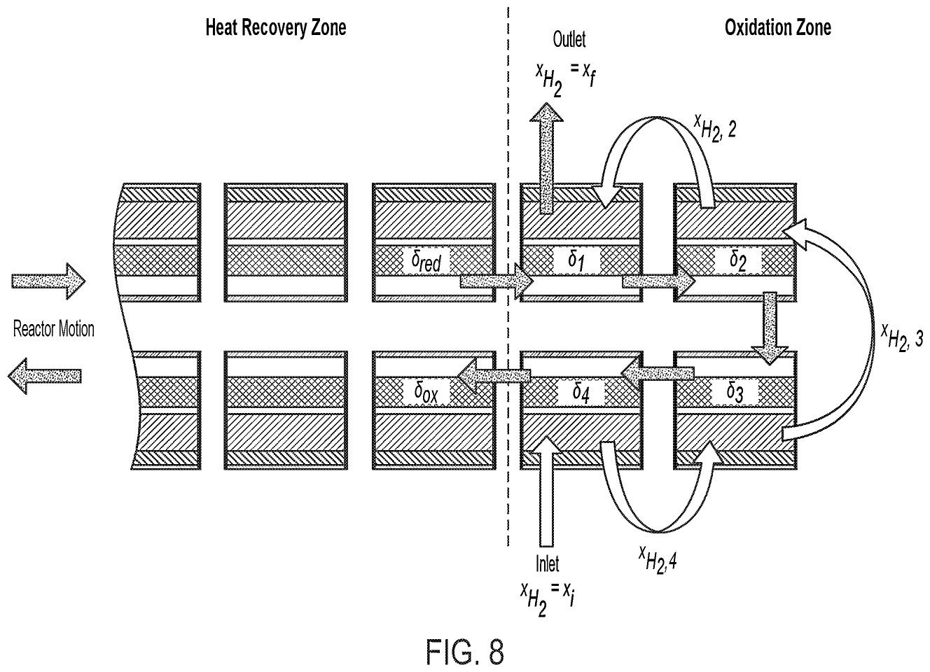

The system may be configured, in some embodiments, such that some fluid-phase (e.g., gas phase) reaction products from a reactor may be transferred to a neighboring reactor in the train. In some embodiments, each reactor in the LT zone transfers reaction products to the reactor immediately ‘behind’ it in the train. For example, in FIG. 8, each reactor transfers a water-hydrogen mixture to the reactor immediately behind it in the train relative to the motion of the reactors shown by short arrows, with the transfer shown by long arrows. A similar transfer action can be implemented in HT zone as well.

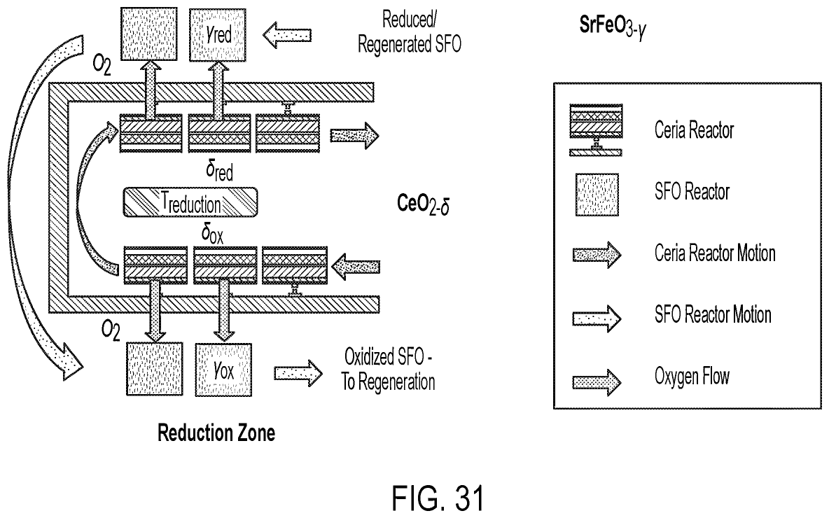

The system may further comprise, in some embodiments, a second train of reactors. The second train of reactors may, in some embodiments, be distinct in construction from reactors of the first train. In some embodiments, the reactors of the second train carry a different catalyst and/or redox active material than is carried in the reactors of the first train. In some embodiments, the two trains are configured to exchange heat and/or mass between them. For example, FIG. 31 shows a first train of reactors containing ceria (a first redox active material) and a second train of reactors containing SFO. The reactors in the second train in FIG. 31 are distinct in construction from the reactors of the first train and, in addition, carry a different catalyst/redox active material. In addition, the train of SFO reactors and the train of ceria reactors are configured to exchange heat and mass between them (heat via radiative heat transfer, as well as oxygen flowing from the ceria reactors to the SFO reactors).

In some embodiments, the system comprises a reactor train that is made of identical reactors linked to each other using flexible hinges such that they can circle in a loop while neighboring reactors do not communicate with each other thermally or exchange gases, and further comprises an external high temperature heat source, wherein the number of reactors in each of the three zones can be varied independently, and wherein the number of reactors in each of the three zones can be varied independently, and wherein the Recuperation zone acts as a counterflow heat exchanger between regions of the reactor train.

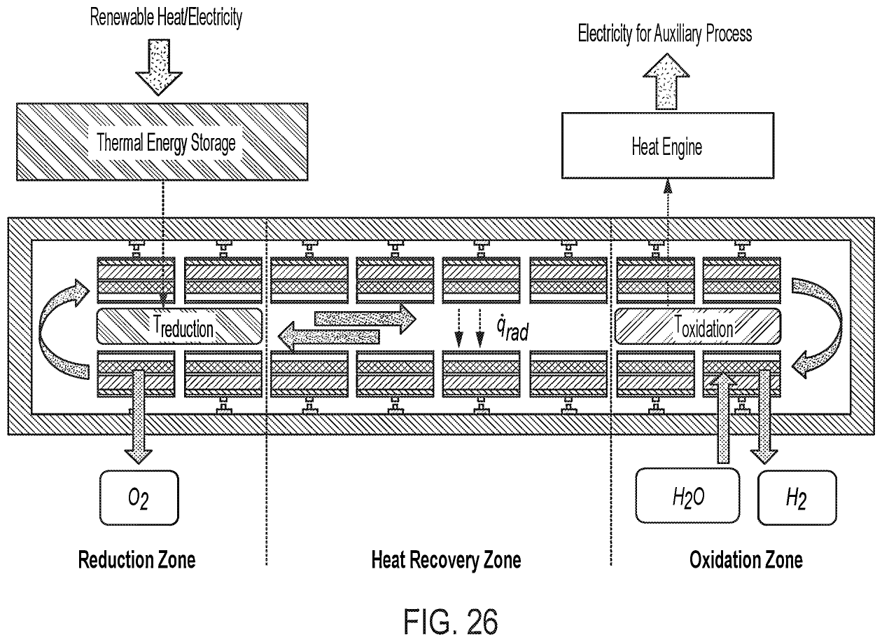

The system may further comprise an external high temperature heat source. One example of such a system is illustrated in FIG. 26, in which the system comprises an external thermal energy storage. Other types of external high temperature heat sources are described elsewhere herein.

In some embodiments, the number of reactors in each of HT. LT, and Recuperation can be varied independently.

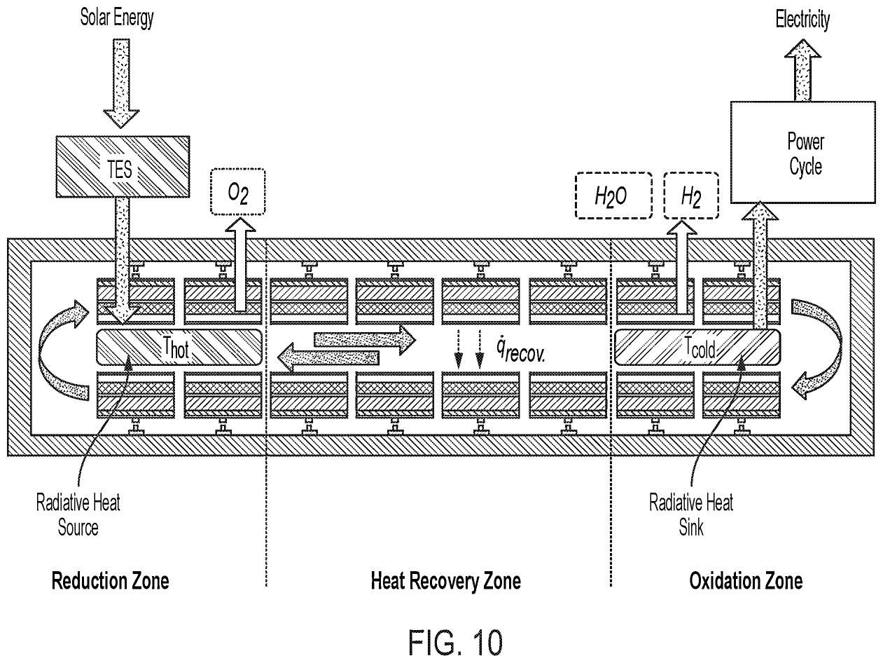

In some embodiments, the system comprises a heat sink to extract heat from reactors for external use. For example, FIG. 10 shows a system comprising a radiative heat sink to extract heat from reactors for external use, wherein the radiate heat sink is coupled to a power cycle that produces electricity. In some embodiments, at least 25%, at least 50%, at least 75%, at least 90%, at least 95%, or at least 99% of this heat is extracted radiatively. In certain embodiments, it is desirable for heat generated in the low temperature zone to be removed from the system, as heating those reactors within the low temperature zone may reduce reaction efficiency. In certain embodiments, it is advantageous for reactors in the low temperature zone to not be heated until they enter the heat recovery zone.

In some embodiments, in step (b) R1 and R2 are both in Recuperation. In some such embodiments, R1 can be in the low temperature series of reactors in Recuperation, and R2 can be in the high temperature series of reactors in Recuperation. In some embodiments, in step (d), R1 and R2 are both in Recuperation. In some such embodiments. R1 can be in the high temperature series of reactors in Recuperation, and R2 can be in the low temperature series of reactors in Recuperation.

In some embodiments, in step (b) R1 and R2 are adjacent in Recuperation. In some embodiments, in step (d), R1 and R2 are adjacent in Recuperation. In some embodiments, in step (b) R1 and R2 are adjacent and facing each other in Recuperation. In some embodiments, in step (d), R1 and R2 are adjacent and facing each other in Recuperation.

In some embodiments, the lengths of R1 and/or R2 are much longer than the radiative gap between them in the Recuperation zone. The length of a reactor, in this context, generally refers to the dimension of the reactor that is parallel to the face of the reactor that faces the other reactors in the Recuperation zone. In some embodiments, the lengths of R1 and/or R2 is/are at least 2 times, at least 5 times, at least 10 times, at least 25 times, or at least 100 times longer than the radiative gap between R1 and R2 in the Recuperation zone.

In some embodiments, the lengths of R1 and/or R2 are much longer than the radiative gap between that reactor and another reactor in the Recuperation zone. For example, in some embodiments, the length of R1 is at least 2 times, at least 5 times, at least 10 times, at least 25 times, or at least 100 times longer than the radiative gap between R1 and an adjacent reactor facing R1 in the Recuperation zone. In certain embodiments, the length of R2 is at least 2 times, at least 5 times, at least 10 times, at least 25 times, or at least 100 times longer than the radiative gap between R2 and an adjacent reactor facing R2 in the Recuperation zone.

In another aspect, a method is disclosed. In some embodiments, the method is a method of operating a system described herein. The method may be a method of operating a system comprising a first reactor (R1), a second reactor (R2), a high-temperature reaction zone (HT), a low-temperature reaction zone (LT), and a heat exchange zone (Recuperation). In some embodiments, the method comprises cycling through the following four successive steps: a. positioning R1 in LT and R2 in HT; b. positioning R1 and R2 in Recuperation; c. positioning R2 in LT and R1 in HT; and d. positioning R1 and R2 in Recuperation. In some embodiments, following step d. R1 is positioned in LT and R2 is positioned in HT.

In some embodiments of the method, an endothermic reaction proceeds in the HT zone, and an exothermic reaction proceeds in the LT zone. In some embodiments of the method, a product of the exothermic reaction is a reactant of the endothermic reaction. In some embodiments of the method, the endothermic reaction is a reduction reaction, and the exothermic reaction is an oxidation reaction.

In some embodiments of the method, during step b, at least 50%, at least 60%, at least 70%, at least 80%, at least 90%, or at least 95% of the thermal energy that is transferred from R2 to one or more other reactors in the system (e.g., R1 or another reactor) is transferred via radiative heat transfer. In some embodiments of the method, during step d, at least 50%, at least 60%, at least 70%, at least 80%, at least 90%, or at least 95% of the thermal energy that is transferred from R1 to one or more other reactors in the system (e.g., R2 or another reactor(s)) is transferred via radiative heat transfer. In some embodiments, at least 50%, at least 60%, at least 70%, at least 80%, at least 90%, or at least 95% of the thermal energy that is transferred between reactors within the Recuperation Zone is transferred via radiative heat transfer.

In some embodiments of the method, during step a: contents of R1 are at a first pressure; and contents of R2 are at a second pressure that is lower than the first pressure. The pressures in R1 and R2 can be any of the pressures described above with respect to the system. As noted above, the system may further comprise a third reactor (R3). During step a, contents of R3 may be at a third pressure that is lower than the first pressure and greater than the second pressure. Also, as noted above, the third pressure may be within 30% of the geometric mean of the first pressure and the second pressure. Also as noted above, in some embodiments of the method: R1 is connected to a first external manifold that is at the first pressure; R2 is connected to a second external manifold that is at the second pressure; and R3 is connected to a third external manifold that is at the third pressure.

The temperatures within the reactors can be any of the temperatures mentioned above with respect to the system.

In some embodiments of the method, the system comprises a reactor train, e.g., that is made of reactors linked to each other using flexible hinges. The reactors within the train may be circulated in a loop during operation. In some embodiments of the method, while the reactors circle in the loop, neighboring reactors do not communicate with each other thermally or exchange gases.

In some embodiments of the method, heat is transferred from an external high temperature heat source to R1 or R2 or both and/or additional reactor(s) in the system. One example is illustrated in FIG. 26, in which the system comprises an external thermal energy storage. Other types of external high temperature heat sources are described elsewhere herein.

In some embodiments of the method, the Recuperation zone is operated as a counterflow heat exchanger between regions of the reactor train.

In some embodiments of the method, R1 or R2 or both and/or additional reactor(s) in the system comprise a catalyst, active redox material, or both. The catalyst or the active redox material or both may be porous. The catalyst or the redox material or both may be enclosed in a casing that is sealed and/or insulated. In some embodiments of the method, the reactor casing of R1 or R2 or both and/or additional reactor(s) in the system comprises one or more windows or other external surfaces for radiative heat exchange with its surroundings.

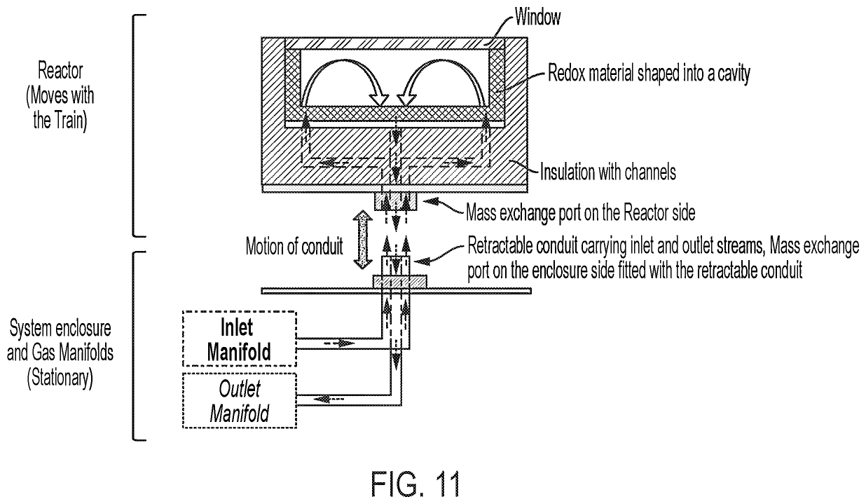

In some embodiments of the method, R1 or R2 or both and/or additional reactor(s) in the system exchange chemical species with their surroundings, via ports in R1 or R2 or both and/or additional reactor(s) in the system, in the LT zone or the HT zone or the Recuperation zone or more than one of these. For example, in FIG. 11, a reactor exchanges chemical species with gas manifolds, via a mass exchange port in the reactor, wherein the reactor may be in the LT zone or the HT zone or the Recuperation zone.

In some embodiments of the method, R1 or R2 or both and/or additional reactor(s) in the system exchange charge or electric current with its environment.

In some embodiments of the method, the speed of R1 and R2 as they move past each other in the Recuperation zone is configured for a quick transition and an efficient heat exchange. The speed or residence time in the Recuperation zone may be improved to reduce heat losses and increase heat recuperation and system throughput. In some embodiments, this residence time (e.g., in steps b and/or d) is greater than or equal to 5 minutes, greater than or equal to 10 minutes, greater than or equal to 20 minutes, or greater than or equal to 30 minutes. In some embodiments, this residence time (e.g., in steps b and/or d) is less than or equal to 60 minutes, less than or equal to 50 minutes, or less than or equal to 40 minutes. Combinations of the above-referenced ranges are also possible (e.g., greater than or equal to 5 minutes and less than or equal to 60 minutes, greater than or equal to 10 minutes and less than or equal to 50 minutes, greater than or equal to 20 minutes and less than or equal to 40 minutes). Other ranges are also possible. This residence time e.g., in (steps b and/or d) is, in certain embodiments, greater than or equal to 5 minutes and less than or equal to 60 minutes.

In some embodiments of the method, during step a, a mass transfer port of R1 is in fluidic communication with LT, and a mass transfer port of R2 is in fluidic communication with HT. In some such embodiments, subsequently, the fluidic communication between R1 and LT is terminated and the fluidic communication between R2 and HT is terminated. In some such embodiments, subsequently, during step c, a mass transfer port of R1 is in fluidic communication with HT, and a mass transfer port of R2 is in fluidic communication with LT.

The present disclosure is applicable to high temperature chemical looping processes, wherein a chemically active agent undergoes cyclical variation in temperature, pressure and/or chemical environment. In certain embodiments, the particular case of solar thermochemical cycles for fuel production (one of the pathways for making “solar fuels”) demonstrates the novelty and usefulness of the invention.

Solar Fuels offer a route for deep-decarbonization of the energy sector. They can be used for affordable, long-term storage of renewable electricity, in long-distance transportation, and for providing high-temperature heat in industry. Thermochemical redox cycles are a promising pathway for converting solar heat directly to energy carriers like syngas and liquid fuels. In some thermochemical cycles, metal oxides like ceria may undergo endothermic thermal reduction using solar thermal energy, typically at 1500° C. and oxygen partial pressures lower than 1 mbar. The metal oxide may subsequently be regenerated in a water-splitting or CO₂-splitting step (gas-splitting), typically around 800° C. and atmospheric pressure. The temperature and pressure swings may be contributing factors such that each step is thermodynamically favored. The redox reactions are shown below for a generic non-stoichiometric metal oxide of the form MO_{x-δ} where δ is the oxygen deficiency or ‘non-stoichiometry’. Thus, in certain embodiments, δ_{red}>δₒₓ.

$$Reduction$$

$${MO}_{x - {δ}_{ox}} \to {MO}_{x - {δ}_{red}} + \frac{{δ}_{red} - {δ}_{ox}}{2} {O}_{2} \qquad ( 1 )$$

$$Oxidation with water$$

$${MO}_{x - {δ}_{red}} + ( {δ}_{red} - {δ}_{ox} ) {H}_{2} O \to {MO}_{x - {δ}_{ox}} + ( {δ}_{red} - {δ}_{ox} ) {H}_{2} \qquad ( 2 )$$

Carbon dioxide can be used as the oxidant in Equation 2 in place of water. This may result in the production of carbon monoxide. Hydrogen and carbon monoxide can subsequently be converted to other energy carriers, including liquid fuel, leading to a broader class of ‘Solar Fuels’. Significant efficiency improvements are desirable for this technology to produce hydrogen at less than $3/kg-H₂—a key price target for making solar fuels viable. A dominant cause of low efficiency is the lack of heat recovery from solid materials between the reduction and oxidation temperatures. Other factors include inefficient gas exchange processes like vacuum pumping, low fuel production per cycle, intermittent operation and the lack of waste heat recovery at the lower temperature. Additionally, many reactor designs face significant technical challenges like sealing between reduction and oxidation zones, and transporting materials at high temperatures. Although several reactor designs have been proposed, it has not been possible to demonstrate even 50% solid heat recovery in a realistic thermochemical system. In this disclosure is presented a novel “Reactor Train” design that can achieve high fuel production efficiency in a technically feasible manner.

The ‘Reactor Train’ (RT) design can achieve high thermochemical fuel production efficiency in a technically feasible manner. Embodiments of this design are estimated to achieve about 75-80% solid heat recovery, leading to a heat-to-fuel conversion efficiency of up to 30% with ceria. The system may comprise several reactors arranged in a closed loop and cycling between reduction and oxidation steps. In between the reduction and oxidation steps, the reactors may undergo solid heat recovery, whereby reactors that are being cooled exchange heat with reactors that are being heated. This may significantly reduce net energy consumption. Embodiments of the RT system use multiple reactors to facilitate continuous solar energy utilization and achieve highly scalable fuel production.

In the particular embodiment shown in FIG. 4, reduction and oxidation reactions take place in the Reduction Zone on the left and the Oxidation Zone on the right, respectively. The Heat Recovery Zone in the middle may have a ‘hot stream’ of reactors (row of reactors on the top in FIG. 4, exiting the reduction zone and moving to the right) and a ‘cold stream’ (row of reactors at the bottom in FIG. 4, exiting the oxidation zone and moving to the left). This may form a counterflow, radiative heat exchanger (CfRHx). The number of reactors in the three zones can be varied to change the residence time of reactors in a particular zone independent of other zones. FIG. 4 (bottom) shows an exemplary reactor of an RTS.

Certain of the designs described herein significantly reduce the technical difficulties of operation encountered in previous counterflow heat exchange processes, resulting in a practical and reliable design. In particular, the challenges or high-temperature material conveying and sealing may be addressed by moving the entire reactor instead of only transporting the redox material. Each reactor may be heavily insulated and sealed. Reactors can be heated or cooled by radiative exchange through windowed openings, avoiding the use of high-temperature heat transfer fluids. Since the redox material (e.g., ceria) is held within its reactor for the entire cycle, its mechanical strength can be lower as compared to systems that employ, for example, bricks or streams of redox material. This may result in greater flexibility in its design, e.g., shaping it into one or more cavities. This may facilitate the use of material morphologies and geometries that have better heat and mass transfer characteristics. All moving parts of the train can be maintained at low temperature (e.g., between 50-250° C.) throughout the cycle, in some embodiments. The RT design thus can achieve significant efficiency improvement over existing reactor designs, while addressing some of their most pressing technical challenges.

The reduction zone may be maintained at high temperature by a radiative heat source (e.g., shown in the left-hand side of FIG. 4). This radiative heat source could be a coil of tubes (e.g., graphite or metal tubes) heated by the flow of a heat transfer medium (e.g., a molten metal). The heat transfer medium can subsequently be reheated by solar energy (e.g., in a high-temperature solar receiver). Such an indirect coupling between solar collection and the thermochemical system may facilitate thermal energy storage, guarding against intra-day transients in solar irradiation and potentially facilitating continuous fuel production through the night. The oxidation zone on the right of the top of FIG. 4 has a radiative heat sink that may harvest unrecovered sensible heat and/or exothermic reaction heat from the reactors. This heat can be used in a power cycle to produce electricity.

Some embodiments of the RT design also include a mechanism for moving reactors to exchange reactants and products with their surroundings. The chemical atmosphere of any particular reactor can be controlled, and mass transfer between reactors can be achieved in a controllable manner. Thus, chemical reactions can be executed in an efficient manner, resulting in higher fuel production and lower auxiliary energy requirements like vacuum pumping, gas separation, etc.

The core of certain embodiments of the proposed system is a train of reactors moving in a closed circuit. The train shown in FIG. 4 moves through three zones: a reduction zone, an oxidation zone, and a heat recovery zone. Each individual reactor can be insulated and sealed. This can facilitate effective separation of temperature, pressure, and chemical species between reactors. As a result, the transition in temperature, pressure, and chemical composition between the reduction and oxidation zones can be achieved gradually as the reactor moves between these zones. This is in contrast to systems that flow the active material in and out of a single large reduction chamber or oxidation chamber. In such systems, the redox material can experience sudden changes in temperature, leading to thermal shock. The RT system can maintain a gradient in temperature, pressure, and chemical potential within a particular zone. For an example, chemical potential gradient in the oxidation zone can be harnessed to reduce overall water usage. In general, such gradients can help reduce irreversibilities in operation.

Residence time within each zone of the RT can be tuned independently. Even when all reactors comprising the train move at the same average speed, residence time within a zone can be varied by changing the number of reactors in that zone. For example, residence time in the oxidation zone can be set to be twice the residence time in the reduction zone by having twice as many reactors in the oxidation zone. Fuel production and solar heat utilization may be continuous, and the rate can be varied to some degree by varying the speed of the train. It is noted that this would change the residence times, and cycle performance may vary. Fuel production can also be scaled up by increasing the size of individual reactors, or using multiple trains. These trains may interact with each other.

Heat transfer to and from individual reactors can be achieved radiatively through transparent windows or highly absorbing/emitting surfaces on individual reactors. Other means of heat transfer like heat transfer media or electric heating may also be employed. Mass transfer to and from individual reactors can be achieved through one or more mass-exchange ports on reactors. The design of all reactors in a system need not be the same; there may be variability to achieve enhanced overall chemical and thermal performance. For example, distinct reactors and redox materials may be used within the same system for water-splitting and CO₂-splitting to produce hydrogen and carbon monoxide fuels, respectively.

One of the novel features of certain embodiments of the RT system is the Heat Recovery Zone (see top of FIG. 4). Hot and cold streams of reactors may move in a counterflow manner, and heat may be transferred from hot reactors to cold ones through radiative exchange. There may be a preferred residence time for reactors within this zone: if residence time is too short, less heat may be transferred between reactors, and temperature rise of the cold stream might be small. On the other hand, if residence time is too long, more heat may be lost to the surroundings, and the temperature rise in the cold stream might again reduce. It was found that an illustrative preferred residence time is on the order of 30 minutes for certain reactor embodiments.

Heat transfer in the reduction and oxidation zones can also be achieved radiatively with a heat source and a heat sink as shown in the top of FIG. 4. If chemical reactions and mass transfer are fast, heat transfer can be the limiting factor in determining rate of progress of reactions. This can be the case for ceria, a thermochemical redox material that has fast reduction and oxidation kinetics. Moreover, the magnitudes of enthalpy of reduction and oxidation may be large in this material. In some embodiments, a lot of endothermic heat is to be supplied during reduction, and nearly half of this is released during water-splitting.

When thermal reduction is limited by heat transfer, calculations show that reactors may need a residence time of at least about 15 minutes in the reduction zone for complete reduction. In some such cases, the target reduction temperature is 1500° C., reduction pressure is between 10-100 Pascals, there is 75-80% solid heat recovery, and the radiative heat source is maintained at at least 1520° C. (that is, an overheat of at least 20° C. beyond the target reduction temperature of 1500° C.). Residence time can be reduced further by increasing overheat of the radiative heat source. Similarly, in one example, a residence time of about 15 minutes was found to be sufficient in the oxidation zone when the heat sink was a few tens of Kelvins below the target oxidation temperature of 800° C. These illustrative results suggest a net cycle time of 90 minutes: 15 minutes each in reduction and oxidation zones, and two passes of the heat recovery zone with a 30-minute residence time for each pass. Thus, in this example, a major fraction of the cycle time is spent in the heat recovery zone.

The proposed disclosure can be used for thermochemical cycles with a variety of redox materials, including metal oxides that reduce in a stoichiometric or non-stoichiometric manner. The reduction temperature can range between 700-1600° C. The reduction temperature may be limited at higher temperatures, in some cases, by the stability and longevity of materials. Reduction can be assisted by vacuum pumping, inert gas sweep, and/or thermochemical and/or electrochemical oxygen pumping. Reducing species (e.g., fuels like methane, etc.) can also be used. Oxidation temperature can range between, e.g., 700-1600° C. Even lower temperatures can be used if slower radiative heat transfer rates can be accepted. Oxidation can be achieved by water and/or carbon dioxide to produce hydrogen and/or carbon monoxide respectively. Other oxidants can be used to produce other chemical species and/or heat. RT can also be used for thermochemical energy storage systems, in which case oxygen can be used as the oxidizing agent, producing large amounts of heat. Oxidation pressure can be varied independent of pressure in other parts of the RT system.

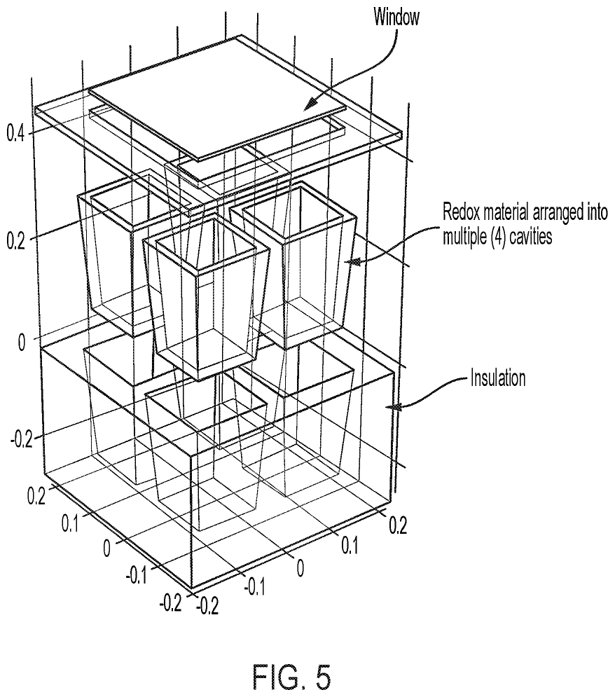

Also provided herein are possible embodiments of individual reactors of a reactor train. A schematic example of such a reactor is shown in FIG. 5. This figure shows the assembly of a reactor comprising (e.g., consisting of) a window, the redox material, insulation and supporting components. Design embodiments of the window, redox material, and insulation are presented herein. This is followed by a description of some heat transfer considerations in the design of this reactor. Embodiments of the mass transfer system are also presented.

Heat transfer to and from individual reactors can be achieved radiatively through windows that are at least partially transparent or through highly absorbing opaque surfaces (e.g., silicon carbide) on individual reactors. For example, high-temperature, infra-red transparent materials can be used to create one or more windows that transmit high radiative heat fluxes across them. An example of such a window is shown in FIG. 5. The use of windows can create a closed reactor with controllable chemical atmosphere and pressure. An open reactor could face several challenges in operation. For example, there might be significant crossover of oxygen between reduced and oxidized reactors in the heat recovery zone (the top and bottom row of reactors in the top of FIG. 4). Such oxygen crossover can drastically reduce cycle efficiency. Sapphire can be a particularly advantageous window material due to its infra-red transparency and stability at high temperature in different chemical environments.

Windows may or may not be actively cooled. Uncooled, high-temperature windows may avoid the energy penalty of losing heat to a coolant. However, they can present technical challenges with sealing and managing thermal stresses. On the other hand, a long heat up time of several tens of minutes in the heat recovery zone may reduce temperature gradients and thermal shock within the window material. High temperature materials like graphite and tungsten can be used for scalings.

It is noted that reactors in the proposed system may not be directly irradiated with concentrated solar radiation, according to certain embodiments. In some such embodiments, re-radiation losses are not a consideration in their design, and it is beneficial to have a large window area to maximize the rate of heat exchange between reactors.

Embodiments of the proposed system are compatible with any redox material that remains predominantly in solid state throughout the cycle. This includes materials like doped and undoped ceria, perovskites, supported or unsupported metal ferrites, and composites thereof.

Some previously proposed thermochemical reactors have had the redox material moving between reduction and oxidation zones. These ‘moving redox’ designs use redox in the form of particles, bricks, or rotating cylinders. Some drawbacks of these systems include mechanical wear of redox particles, fracture of cylinder and bricks due to thermal and/or mechanical shock, and slow heat diffusion within the redox material. In certain embodiments of the present disclosure, the movement of redox material is achieved by moving the entire reactor. This can afford increased flexibility in the design of redox material geometry and morphology. For example, in some embodiments, monolithic redox structures (such that those employing multiple cavities and/or honeycombs) can be used. FIG. 5 shows an example of a design comprising multiple cavities. In FIG. 5, the reactor has four smaller cavities instead of a single large cavity. This can lead to a more compact reactor with efficient and homogenous radiative heating because of the cavity effect. Moreover, the cavities can comprise (e.g., be made out of) ceramic foams for efficient radiative heat exchange. Such foams could otherwise be difficult to use in existing ‘moving redox’ systems due to their low mechanical strength. Similarly, catalysts can be used with relative ease, since the redox surfaces do not experience moving mechanical contact during the course of operation.

The use of radiative transfer in the heat recovery zone can lead to extended cycle times that make heat losses an important consideration. Thick, multilayer insulation comprising (e.g., consisting of) ceramics, foams, fiberglass, etc. can be used to reduce heat loss through the insulation, and to reduce the temperature at the outer wall of the reactor. Moving parts of the reactor conveying mechanism and the mass transfer mechanism can be exclusively located in the low-temperature regions of the reactor, thus eliminating high-temperature moving parts. For example, it was found that, in certain cases, a 10-25 cm thick multilayer insulation results in acceptably low heat loss. Temperature of the reactor outer wall may be between 50-250° C. during the entire operating cycle, in some embodiments. Meanwhile, the temperature of the redox material inside the reactor may vary between 800-1500° C. over a cycle time of 60-100 minutes, in some embodiments.

One of the novel features of certain embodiments of the RT design is that the entire reactor is moved between different zones, instead of moving just the redox material. One of the potential drawbacks of this scheme may be the added thermal inertia due to the insulation and supporting structures within the reactor. This may increase the amount of heat that is to be recovered between the reduction and oxidation zones, and can slow down the process of heat recovery. Calculations show that while the cyclic operation occurs over 60-100 minutes, the timescale of heat diffusion over the thickness of the insulation can be several hours. Consequently, only a small region of the insulation may undergo significant temperature swing and may contribute to thermal inertia once the cyclic steady-state is reached. It was found that the thermal inertia due to the insulation may be about 70% of the thermal inertia of the redox material in a configuration similar to that of FIG. 5.

In certain embodiments, efficient heat transfer is important or even essential for the success of the RT system. In the context of some thermochemical cycles, the following points of consideration for improved performance are noted:
a) Increasing the rate of useful radiative exchange between reactors in the heat recovery zone.
b) Uniformity of temperature within the redox materials to facilitate the progress of chemical reactions and low thermal stress.
c) Minimizing heat loss through the insulation.

The rate of useful radiative exchange between reactors can be increased by increasing the area of radiative transfer surfaces (like windows) for a given amount of active material loading within the reactor. Some other ways of increasing the rate of radiative transfer include minimizing losses due to the window, and increasing the effective emittance of the redox material. The former can be achieved by choosing appropriate window materials that have good transparency in the infrared spectrum. In some embodiments, at temperatures between 800-1500° C. most of the black body radiative emission occurs at wavelengths between 0.5-10 microns. The window can be made thinner to reduce absorption, although this may be limited by mechanical strength considerations. Effective emittance of the redox material can be increased by shaping it into one or more cavities as shown in FIG. 5. This “multi-cavity” can facilitate a more efficient use of the volume within a reactor than a single cavity. Apart from making the system compact, this can become important when the reactors are scaled up in size, and the thickness of the cavity is restricted, as described below.

Thermal conductivity of the active material can be very low at the desired operating conditions, slowing down the diffusion of heat to the material further away from the window. This can be especially true of metal oxides used in thermochemical cycles. Thermochemical reactor-receivers that are directly irradiated with concentrated solar radiation may experience large temperature gradients within the redox material. This can be because of the mismatch between high solar heat flux entering the cavity and getting absorbed on the top layer of the redox material, and the low heat flux through the thickness of the redox material. This can result in thermal stresses and cracking of the redox material, as well as melting and sublimation at the “hot spots” on the irradiated surface. Certain embodiments of the present disclosure can avoid this issue by decoupling the solar receiver and thermochemical cycle.

One way to reduce temperature gradients within the redox material is to harness radiative transfer in the bulk of the material. A porous morphology with small extinction coefficient can facilitate volumetric absorption and emission of radiant energy. The effective thermal conductivity based on the Rosseland diffusion approximation might also be higher when the extinction coefficient is small. Small extinction coefficients can be achieved with a foam-like morphology with large pore size of, for example, 1-10 mm. Accordingly, in some embodiments, at least 50 vol %, at least 75 vol %, at least 90 vol %, at least 95 vol %, at least 99 vol %, or 100 vol % of the pores in the redox material have a cross-sectional diameter of from 1 mm to 10 mm. Such pore cross sections can be determined, for example, using porosimetry. Limiting the length over which heat is to be conducted can also lead to more homogenous temperature distribution. In the cavity design, this may mean limiting the thickness of the cavity (e.g., the vertical dimension of the cavity in FIG. 5) to 1-5 cm. The multi-cavity design can admit greater mass loading of redox material within the reactor (compared to a single cavity) while still restricting the thickness of cavities. This can be achieved by increasing the surface area of the redox material that can be directly irradiated through the window.

Heat losses through the insulation can be minimized by reducing the heat flux through it. This can be achieved by choosing appropriate insulating materials, and increasing the thickness of insulation. Heat losses can also be reduced by minimizing the outer surface area of the reactor through which heat is lost to the surroundings. Scaling up the reactor can increase the volume to area ratio, resulting in lower heat losses per unit mass of the active material.

Mass transfer between moving reactors and their stationary surroundings can be important for the progress of chemical reactions. This can be achieved by temporary connections between external gas tanks and the mobile reactors. The reactors may be moving or stationary while such a connection is made; in the latter case, the motion of the train will be intermittent rather than continuous. Sliding connections can facilitate continuous movement of the reactor train and avoid mechanical loading and shocks resulting from intermittent motion.

An example of a mass transport system is shown in FIG. 6. This system can be used at multiple points within the reactor train, as illustrated in FIG. 4. The example system shown in FIG. 6 can involve intermittent motion of the reactor train. A reactor may move along the train and halt above a retractable conduit that is connected to a gas tank (see FIG. 6). The conduit can then move as shown by the thick arrow in FIG. 6 to attach to the mass exchange port on the reactor. Mass can then be exchanged to and from the reactor. After a certain residence time, the conduit can detach from the reactor, and the reactor train can move again. FIG. 4 shows a series of mass transfer ports on the system enclosure wall. Reactors can hop from port to port, spending a certain residence time at each port. Thus, highly controllable mass transfer is possible at every point in the RT, including in the heat recovery zone.

Thermal insulation on reactors can be made sufficiently thick so that moving parts involved in the attaching and detaching of the conduit are at low temperatures. Fluid cooling (such as liquid cooling with, for example, oil or water) can be used to further reduce the temperature at some locations as needed. The conduit and related components may comprise (e.g., be made out of) high-temperature materials like steel, ceramics, silicone, etc.

In some embodiments, the number of such mass transport ports on a reactor is to be minimized to reduce the complexity of the system. A single connection can be used for both inflow and outflow as shown in FIG. 6. In some such embodiments, the retractable conduit system comprises (e.g., consists of) two co-axial pipes, with mass flowing into the reactor through the annular region (outer straight thin arrows), and mass flowing out through the central pipe (inner or central straight thin arrows). When inert gas sweep is used during reduction, outer straight thin arrows can represent inert gas, while inner straight thin arrows can represent an inert and oxygen mixture exiting the reactor. During oxidation, outer straight thin arrows can represent steam, while inner straight thin arrows can represent a steam and hydrogen mixture,

The piping within the reactor as shown in FIG. 6 comprises (e.g., consists of) hollow passages within the insulation of the reactor. The insulation on reactors can be, e.g., 10-25 cm thick for reducing heat losses. The idea of having two coaxial pipes for inflow and outflow as shown in FIG. 6 can make it possible to have only one point of connection between the reactor and its surroundings. Such a system also may facilitate gas-phase heat recovery from the hot gas stream to the cold gas stream. This can happen within the reactor as well as outside the reactor.

In some embodiments, the locations of inlets and outlets within the reactor cavity are configured to ensure good contact between the gas phase and the active solid material. As an example, this can be achieved by placing the inlets at the corners and the outlet at the center of the cavity floor (shown in FIG. 6). Some alternative inlet and outlet locations include near the window, along the side walls of cavity, etc. It may be important to avoid ‘dead zones’ within the reactor, especially during the oxidation step of thermochemical cycles. In other words, in certain embodiments, all parts of the redox material should be exposed to the flow of fresh oxidizing agent like steam or carbon dioxide. The locations of the inlet and outlet, and the shape of the redox material may together ensure that this is the case. Volumetric flowrate of gases may be quite high if the temperature is high and/or the pressure is low. Thus, residence times of gases within the reactor cavity may be very short.

The outlet can feed into a gas tank as shown by the inner or central straight thin arrows and outlet gas tank in FIG. 6. Alternatively, a vacuum pump or valve can be placed between the reactor and tank to keep the reactor at a different pressure than the tank. The pressure of the tank can itself be different than ambient pressure. The overall system can have multiple gas tanks for handling different chemical species, and at different temperatures and/or pressures. These may be interconnected through pumps, manifolds, heat exchangers and surge tanks to minimize the overall pumping work, and to maintain a desired pressure or chemical potential gradient. Direct or indirect mass transfer between reactors can also be achieved. The gas handling system can also incorporate thermochemical and electrochemical sub-systems to efficiently separate fuel from oxidizer, or oxygen from sweep gas.

The thermochemical cycle may need external heat input to drive endothermic reactions like thermal reduction of metal oxides. Heat may also be supplied to raise the temperature of redox material beyond the temperature increase achieved during heat recovery. In some embodiments of the RT system, one of the ways this heat can be supplied is radiative transfer through radiative transfer surfaces. It may be possible to control the path of the train and orientation of reactors so that heat is supplied directly in the form of concentrated solar irradiation. FIG. 4 shows an alternative scheme wherein a high-temperature radiative heat source is used to supply heat to reactors.

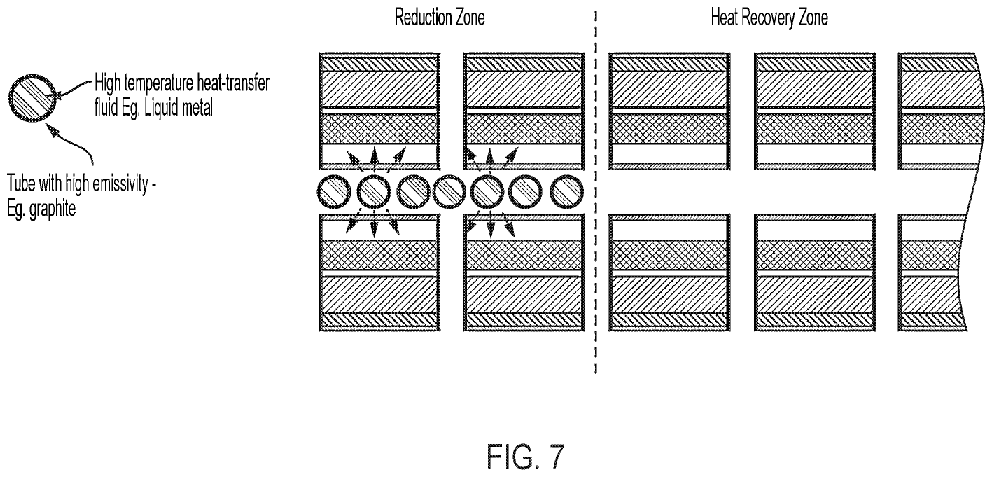

In a particular embodiment, the radiative heat source can be a high emissivity element heated by the flow of a heat transfer medium. An example could be graphite pipes carrying molten tin. This is shown schematically in FIG. 7. Multi-layered pipes can be used to achieve corrosion resistance on the inner tube surface and high radiative emissivity on the outer surface. The molten tin can subsequently be reheated in a high temperature concentrated solar receiver. Such an indirect coupling between solar heat and the thermochemical cycle may facilitate energy storage in the form of hot molten metal between the solar receiver and the thermochemical system. This storage capacity can act as a buffer during intra-day fluctuations of solar irradiation (for example, due to passing clouds) which can pose a serious operational challenge for directly irradiated thermochemical reactors. A larger storage capacity may facilitate round-the-clock operation of the thermochemical cycle, thus increasing its capacity factor and reducing size and capital cost.

Other heat transfer and heat storage media may include refractory particles like alumina or zirconia, molten silicon, and other molten metals. This heating system may avoid direct contact between the heat transfer medium and reactors. The heat transfer medium may be circulated in a dedicated high-temperature circuit that is independent of the rest of the reactor train.

The concept of a radiative heat source as exemplified in FIG. 7 effectively decouples the heat source from the thermochemical cycle. It can thus take advantage of other energy source like cheap electricity to heat up the heat transfer medium, increasing the flexibility of the system. The radiative heat source can be a high emissivity element heated electrically to maintain a desired temperature. Alternatively, resistive heating can be done within each reactor to supply heat directly to the redox material. Heat sources like nuclear and biomass energy can also be used with or without additional solar heat input. Indirect use of solar heat can also give a greater degree of control on the heating rate of reactors, and can avoid problems of thermal shock and redox material melting or vaporization, which have been reported in directly irradiated receiver-reactors. A radiative heat source can provide a sufficient heat flux to the reactors so that sensible heating (after heat recovery) and heat for endothermic reactions can be supplied within a residence time of, e.g., 5-20 minutes.

Low oxygen partial pressure can enhance reduction, and thermochemical cycles can use an oxygen deficient atmosphere during reduction. This can be done by creating a vacuum and/or sweeping an inert gas through the reactor. Other techniques like electrochemical or thermochemical pumping of oxygen can also be used. In the case of vacuum pumping, since pump efficiency decreases substantially at pressures below 103 bar, a step-wise reduction in pressure (sometimes called a ‘pressure cascade’) can lead to significant reductions in pumping work. Such a pressure cascade can be employed in RT because the pressure of each reactor can be controlled directly using a system described herein. In such a cascade, pressure within a reactor can be gradually reduced as it moves through the reduction zone, and only the last few reactors may operate at extremely low pressures where pump efficiency is low. This is an example of harnessing the chemical potential gradient within the reduction zone to reduce irreversibilities.

A heat recovery zone can be used to recover heat from reactors as they cool down from the reduction temperature to the oxidation temperature. The top of FIG. 4 shows a counterflow, radiative heat exchanger (CfRHx) between the high-temperature reduction zone and low-temperature oxidation zone. The counterflow configuration may facilitate a high effectiveness of heat recovery, and using radiative transfer can avoid direct contact of redox materials with a heat transfer medium.

Certain embodiments of the RT system described herein use a scheme whereby the entire reactor is moved, and the redox material stays within the reactor for the entire cycle. Heat transfer can be achieved, e.g., through windows, and mass transfer can be achieved, e.g., by making intermittent connections with external gas tanks. Such features represent a significant advance in the state of the art of thermochemical systems using the counterflow, radiative heat recovery principle. Apart from making material conveying practical and reliable, the use of reactors in this way can provide, in accordance with certain embodiments, the following advantages.

First, designs in which a reactor is not used can suffer from oxygen exchange between the reduced and oxidized material within the CfRHx. This can significantly reduce the impact of solid heat recovery on cycle efficiency, potentially leading to a net negative impact. The use of reactors as described in certain embodiments of the present disclosure can prevent unwanted mass transfer between reactors by enclosing them in a windowed reactor. Certain embodiments of the RT design also isolate reactors from other reactors in the same stream. Thus, the hottest reactor in the cold stream of the CfRHx may not have to share a gas-phase atmosphere with the coldest reactor in the stream. Such communication could also lead to loss of fuel production due to oxygen crossover from the less reduced (cold) to the more reduced (hot) material. This also may facilitate the creation of a gradient in temperature, pressure, and/or chemical potential as you move from reactor to reactor along the train. The utility of such a gradient is demonstrated by a pressure cascade described herein and a gas-solid counterflow configuration described herein.

Second, housing the redox material permanently within the reactor can afford great flexibility in redox material shape and morphology selection. This can greatly enhance heat and mass transfer rates. Cavity structures as shown in FIG. 5 can be employed, and ceramic foams with large pore size can be used for volumetric absorption and emission of thermal radiation. Such foams have low mechanical strength and are unlikely to survive a mounting-unmounting mechanism.

Third, the present disclosure can facilitate reactions to take place within the heat recovery zone. This can be facilitated by isolation of a reactor from all other reactors, and the availability of a mass transfer mechanism at all locations of the train. Apart from reducing cycle time, this can be especially advantageous in thermochemical cycles because of the heats of reactions-reduction is generally endothermic, while oxidation by steam or carbon dioxide is generally exothermic. Thus, some of the exothermic heat generated by oxidation in the cooling stream of reactors (the reactors on the top of the train shown at the top of FIG. 4) can be transferred to the reactors that are heating up. The bottom row of reactors (see top of FIG. 4) that is being heated up can use a part of the heat input to undergo endothermic thermal reduction, and the evolved oxygen can be pumped away. In other words, not only the sensible heat, but a portion of the heat of reaction can also be recovered in the heat recovery zone. This novel functionality can further boost the efficiency of the cycle.

Certain embodiments of the RT system involve supplying or harvesting heat from reactors using a radiative source or a sink (e.g., as shown in the top of FIG. 4). In thermochemical fuel production cycles, significant amounts of heat can be harvested in the oxidation zone. This includes unrecovered solid heat and exothermic heat of reactions. This can be achieved in a manner similar to the way heat was supplied in the reduction zone, where a high emissivity surface is heated by a heat transfer medium (see FIG. 7). In accordance with some embodiments, high temperature chloride salts can be used as the heat transfer medium at temperatures between 700-1200° C. Multi-layer pipes can be used to achieve corrosion resistance on the inner pipe surface and high radiative emissivity on the outer surface.

The harvested heat can be at a relatively high temperature-generally greater than 700° C. in thermochemical cycles. This can be used for electricity production in a power cycle. In particular, supercritical carbon dioxide cycles may be ideally suited to produce electricity in this temperature range. This electricity can be used within the thermochemical cycles to drive operations like vacuum pumping, gas separation, gas compression, etc. Excess electricity can be used within the cycle as heat input to the reduction zone, or sold to the grid if electricity prices are favorable. Harvested heat can be stored to shift the time of electricity production, and to take advantage of low-priced renewable energy in a flexible manner.

Thermoelectrics can also be used for heat to electricity conversion if the efficiency and cost are favorable. RT can consume considerable amounts of electricity for vacuum pumping, gas separation, reactor motion, etc. If electricity generated by waste heat cannot meet this demand, cheap, locally produced renewable electricity can be used. Electricity can also be produced from stored high temperature heat using a power cycle of thermal photovoltaics.

Apart from electricity production, heat harvested in the oxidation zone can be used in other fuel production processes like steam reforming of methane and biomass, solid oxide electrolyzers, etc. This can lead to significant technoeconomic advantages and greater operational flexibility. An integrated energy plant can thus be built around the thermochemical cycle, with fuel production, renewable electricity, and storage.

In some embodiments of thermochemical cycles, the oxidizing agent is water or carbon dioxide, while product gases exiting the reactor are a mixture of the oxidant and fuel. For the exemplary case of water as oxidant, the gas stream entering the reactor (outer straight thin arrows in FIG. 6) is steam and the exiting stream (inner or central straight thin arrows in FIG. 6) is a mixture of unreacted steam and hydrogen. The steam-hydrogen mixture can be easily separated by condensing the steam and collecting hydrogen gas at ambient pressure. The liquid water can then be recycled and injected into the reactor again, along with make-up water to account for the hydrogen produced. Although sensible heat can be recovered between the blue and red streams, it can be challenging to recover the latent heat of vaporization of water. Steam generation can impose a significant energy penalty, especially if a large amount of unreacted steam has to be recycled. On the other hand, steam generation can be done cheaply using solar heat and low-temperature concentrating systems like parabolic troughs. Thus, although it may not be energetically efficient, separating steam from hydrogen by condensation might be an economically sound option. A non-limiting alternative separation technique using gas-phase separation of steam and hydrogen can be employed to avoid the energy penalty of vaporizing recycled water. For example, gas-phase separation has been used for CO₂—CO mixtures when carbon dioxide is used as the oxidizing agent.

In the gas flow scheme shown in FIG. 6, the outflow stream from a reactor is collected in a tank and processed thereafter. This may usually be a separation process-separating hydrogen from steam, CO from CO₂, or, when inert gas sweep is used in the reduction zone, separating oxygen from the inert gas. This could be energetically expensive, especially when separation is done at a much lower temperature, and when the concentration of fuel or oxygen is low. This could be remedied by using a gas-solid counterflow configuration, whereby the concentration of fuel or oxygen in the exiting stream is maximized. This configuration can be particularly advantageous for redox materials with lower oxidant conversion, that is, materials that produce a lower mole fraction of hydrogen leaving the reactor during water splitting.

A gas-solid counterflow configuration can be achieved by routing the outflow from one reactor into the preceding reactor in the train. FIG. 8 shows a schematic of the oxidation zone of an RT system using such a counterflow, according to some embodiments. The motion of reactors is shown by short arrows, while the flow of steam-hydrogen mixture is indicated by long arrows. The counterflow is apparent by the two sets of arrows moving in opposite directions.

The advantage of a counterflow can be understood as follows. Without loss of generality, in this example, it was assumed that the redox material is a non-stoichiometric metal oxide of the form MO_{x-δ} where δ is the oxygen deficiency or ‘non-stoichiometry’. In this non-limiting example, reactors enter the oxidation zone in the reduced state (oxygen-deficient) and leave the oxidation zone in an oxidized state. Thus, for example, with reference to FIG. 8, δ₁>δ₂>δ₃>δ₄>, wherein “>” means “greater than”. Considering the equilibrium of the water splitting reaction shown in Equation 2, the above relation between δ's can translate, for most metal oxides, into the following relation between the mole fractions of hydrogen in the exiting streams: x_{f}>x_{H}_{₂}_{, 2}>x_{H}_{₂}_{, 3}>x_{H}_{₂}_{, 4}. Thus, in this non-limiting example, for the purpose of downstream separation processes, the overall conversion ratio is x f. Such a counterflow has been shown to reduce the energy penalties associated with steam re-heating and steam-hydrogen separation. The counterflow configuration may be achievable in this non-limiting example, at least, because RT uses multiple reactors, with each reactor having a controllable chemical atmosphere. The counterflow configuration, in this non-limiting example, takes advantage of the chemical potential gradient across multiple reactors within the oxidation zone to reduce irreversibilities. A similar counterflow can be used when a sweep gas is used in the reduction zone

The Reactor Train system can be housed within an outer enclosure that can be insulated and/or sealed. The system enclosure is shown in FIG. 4. This component can help reduce heat losses from reactors, especially if the enclosure interior is maintained at sub-atmospheric pressure. The outer surfaces of the reactor that face the enclosure walls can be maintained at low temperature to reduce radiative heat losses to the enclosure walls. However, other parts of the reactor like the window may be at high temperatures, e.g., ranging from 700-1600° C. These hot surfaces may not lose heat to the enclosure via direct radiation because the view factor between them can be made very small. On the other hand, convective losses can be significant at the elevated temperatures of the redox material and window. These can be mitigated by reducing the enclosure pressure. Convective losses from the radiative heat sources and sinks (e.g., the graphite pipes in FIG. 7) can also be mitigated by this measure. Further, the enclosure can be filled with an inert gas like nitrogen or argon to prevent undesirable chemical reactions like oxidation of graphite in air.

In certain embodiments, reactors can be mounted on rails, and moved along a linear, circular, or any other trajectory. Further, the motion can be continuous or intermittent. For the retractable gas exchange system depicted in FIG. 6, the motion is intermittent, with reactors moving from one mass exchange port to the next. In certain embodiments, acceleration of reactors during such intermittent motion, as well as during the turn at the two ends (shown by curved arrows in FIG. 4) is to be controlled to reduce mechanical stresses on reactor materials. The reactor materials may have pre-existing internal stresses due to temperature and chemical reaction-induced volume changes, and high accelerations might lead to mechanical failure. At the same time, transit time between two mass exchange ports may be minimized to facilitate maximum possible time for heat and mass transfer. Thus, a smooth and controlled conveying system is useful.

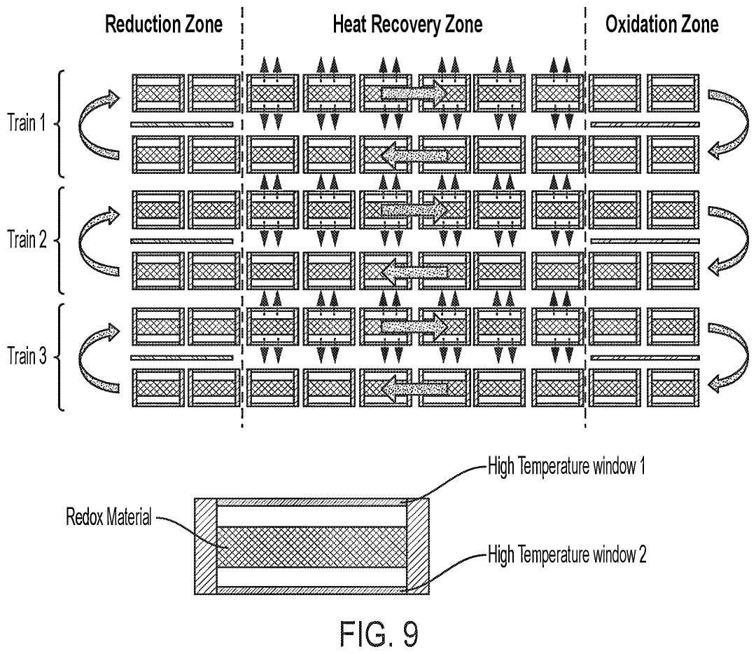

Multiple trains can be used to scale up the rate of fuel production. These trains may interact with each other. An example of multiple trains with heat interaction between them is shown in FIG. 9 with double-windowed reactors. A benefit of this configuration is as follows: Cycle time and heat losses can be reduced if the radiative transfer surface area (window area) is increased for a fixed mass of redox material. The reactors shown schematically in FIG. 9 have two windows, and thus larger area for useful radiative heat exchange. In some embodiments, in the heat recovery zone, each reactor in the cold stream receives a net heat flux from the hot reactors of the same train, as well as the hot reactors from the neighboring train. Similarly, in some embodiments, each hot reactor in the heat recovery zone loses heat to two reactors, and is thus cooled faster. Note that the counterflow effect can still be maintained on both sides of the reactor. Thus, residence time in the heat recovery zone can be reduced with this scheme, leading to lower heat loss per cycle. Moreover, the surface area of each reactor that is exposed to the cold enclosure walls (and thus contributes to heat loss) can be reduced. Lower heat losses can lead to significantly higher heat recovery effectiveness, and higher cycle efficiency. This is in line with conventional wisdom that heat losses become less important as the system is scaled up.

Certain embodiments of the present disclosure are applicable to multi-step, cyclic processes, wherein a chemically active agent undergoes cyclical variation in one or more of the following: temperature, pressure, and chemical environment. In the simplest case of such a process, the chemically active substance executes a useful chemical reaction that leads to a change in its form. It may then be regenerated in a second step to return it to its original state. One example of such a process is two-step thermochemical redox cycles that produce hydrogen or carbon monoxide by splitting water or carbon dioxide. The present disclosure can greatly improve the efficiency of such processes by reducing the inefficiencies arising from the cyclic change in temperature, pressure, and/or chemical environment. The present disclosure also addresses technical challenges of moving high temperature materials and scaling off regions with different pressures and chemical composition. The present disclosure can also be applied to other cyclic redox processes like chemical looping combustion, reforming of methane and biomass, etc.

Zero-emission ‘Green’ Fuels offer a route for deep-decarbonization of the energy sector. They can be used for affordable, long-term storage of renewable electricity, in long-distance transportation, and for providing high-temperature heat in industry. Thermochemical cycles (TC cycles) can use heat to split water (or carbon dioxide) in a multi-step process to produce hydrogen (or carbon monoxide). Hydrogen and carbon monoxide can subsequently be converted to other synthetic fuels (synfuels), including but not limited to hydrocarbons and even ammonia. In some TC cycles, metal oxides like ceria can undergo endothermic thermal reduction using solar thermal energy, typically at 1500° C. and oxygen partial pressures lower than 10 mbar. The metal oxide can subsequently be regenerated in a water-splitting (or CO2-splitting) step, typically around 800° C. and atmospheric pressure. The temperature and pressure swings can facilitate each step to be thermodynamically favored.

Redox reactions are shown in Equations 1 and 2 above for a generic non-stoichiometric metal oxide of the form MO_{x-δ} where δ is the oxygen deficiency or ‘non-stoichiometry’. Thus, in certain embodiments, δ_{red}>δₒₓ. Carbon dioxide can be used as the oxidant in Equation 2 in place of water. This can result in the production of carbon monoxide. Water and carbon dioxide can be used together to produce syngas of variable composition.

The high temperatures involved along with the temperature and pressure swing during each cycle can make implementation of the reactions in Equations 1 and 2 challenging. Some TC cycles have heat-to-hydrogen conversion efficiency lower than 10%. The dominant cause of low efficiency may be the lack of heat recovery from solid materials between the reduction and oxidation temperatures. Other factors can include inefficient gas exchange processes like vacuum pumping, low fuel production per cycle, intermittent operation and the lack of waste heat recovery at the lower temperature. Additionally, many reactor designs can face significant technical challenges like sealing between reduction and oxidation zones, and transporting materials at high temperatures. Although several reactor designs have been proposed, it had previously not been possible to demonstrate even 50% solid heat recovery. In this disclosure, a novel “Reactor Train” design is presented that can achieve high fuel production efficiency in a technically feasible manner.

The ‘Reactor Train System’ (RTS) design can achieve high thermochemical fuel production efficiency in a technically feasible manner. Analysis shows that the RTS can achieve at least 70% (e.g., between 70% and 90%) solid heat recovery. This can lead to a heat-to-fuel conversion efficiency of greater than 10%, or greater than 15% (e.g., up to 40% with ceria). The system may comprise several reactors arranged in a closed loop and cycling between reduction and oxidation steps. In between the reduction and oxidation steps, the reactors can undergo solid heat recovery, whereby reactors that are being cooled exchange heat with reactors that are being heated. This can significantly reduce net energy consumption. The RTS system can use multiple reactors to facilitate continuous solar energy utilization and achieve highly scalable fuel production.

Apart from heat transfer, the RTS can also be equipped for efficient mass transfer. The RTS design can include a mechanism for individual reactors to exchange reactants and products with their surroundings. The chemical atmosphere of any particular reactor can be controlled, and mass transfer between reactors can be achieved in a controllable manner. Thus, chemical reactions can be executed in an efficient manner, resulting in higher fuel production and lower auxiliary energy requirements like vacuum pumping, gas separation, etc. For example, a pressure cascade can be implemented in the reduction by reducing the pressure of reactors in a stepwise manner as they move through the reduction zone. This greatly reduces the energy requirement of vacuum pumping. Additionally, mass transfer between two reactors can facilitate internal pressure equilibration that can further reduce pumping work by ‘Pressure Recovery’.

Certain embodiments of the proposed system are compatible with a variety of redox material including doped and undoped ceria, perovskites, supported or unsupported metal ferrites and other spinels, and composites thereof. The reduction temperature can range between 700-1600° C. Reduction can be assisted by vacuum pumping, inert gas sweep, thermochemical or electrochemical oxygen pumping. Reducing chemical species (e.g., methane, biomass etc.) can also be used. Oxidation temperature can range between 700-1600° C. Even lower temperatures can be used if slower radiative heat transfer rates can be accepted. Oxidation can be achieved by water and/or carbon dioxide to produce hydrogen and/or carbon monoxide respectively. The RTS can also be used for thermochemical energy storage systems, in which case oxygen can be used as the oxidizing agent. Oxidation pressure can be varied independent of pressure in other parts of the RT system.

The core of certain embodiments of the proposed system is a train of reactors moving in a closed circuit executing a cyclic process. The reactors may be identical and at least one reactor (e.g., each reactor) may contain a chemically active material that stays within its reactor throughout the cyclic process. In thermochemical cycles, the active material may be the redox material (metal oxide) and the cyclic process may comprise (e.g., consists of) the reduction and oxidation steps (Equations 1 and 2) with potentially additional steps like heat recovery. The train shown in FIG. 4 moves through three zones: a reduction zone, an oxidation zone, and an intervening solid heat recovery zone.

Each individual reactor can be insulated and sealed, facilitating effective separation of temperature, pressure, and chemical species between reactors. As a result, reactors in the same zone can have different temperature, pressure and chemical composition. Thus, any change in these parameters can be achieved gradually as the reactor moves through a zone. This can contrast with systems where the redox material undergoes a sudden change as it moves from one zone to another, e.g., systems that flow the active material in and out of a single large reduction chamber. In such systems, the redox material can experience sudden changes in temperature, leading to thermal shock. The RTS can maintain a gradient in temperature, pressure and/or chemical potential across different reactors in a particular zone. Such gradients can reduce irreversibilities in operation, for example the pressure cascade for vacuum pumping in the reduction zone (described below).

Heat transfer to and from individual reactors can be achieved radiatively through transparent windows or highly absorbing/emitting surfaces on individual reactors. Other means of heat transfer like circulating heat transfer media or electric heating may also be employed. Mass transfer to and from individual reactors can be achieved through one or more mass-exchange ports on reactors. The design of all reactors in a system need not be the same; there may be variability to achieve enhanced overall chemical and thermal performance. For example, distinct reactors and redox materials may be used within the same system for water-splitting and CO₂-splitting to produce hydrogen and carbon monoxide fuels respectively.

Heat transfer to and from reactors can be achieved by several means including radiative transfer, heat transfer media like gaseous media, liquids including molten salts or molten metals, or solid particles. Radiative heat transfer can be particularly attractive for high-temperature systems because it is a contactless means of heat transfer with minimal moving parts and parasitic energy requirements (e.g., pumping of heat transfer fluids). The RTS in FIG. 4 employs radiative heat transfer for most heat transfer requirements.

Radiative heat transfer to and from individual reactors can be facilitated by one or more windows that are transparent or semi-transparent to electromagnetic radiation in the wavelength range relevant to the application. This may generally be in the infrared range for application temperatures up to 1700° C. Sapphire can be a candidate material that is semi-transparent at those wavelengths and is tolerant to high temperatures and most chemical environments. For example, a 4 mm thick sapphire window has a transmittance of about 60% when the window and radiation source are at a temperature between 1000-1200° C.

Reactors can be directly irradiated with solar radiation, in which case the windows may be transparent to wavelengths most dominant in the solar spectrum. Quartz can be a candidate material that is transparent at those wavelengths. Windows may or may not be actively cooled. Additionally, highly absorbing opaque surfaces (e.g., Silicon Carbide) can be used to facilitate radiative heat transfer to and from reactors. In applications that do not require gas-phase sealing of the reactor, the chemically active material (redox material or catalyst) may be exposed and directly absorb and emit thermal radiation. Many applications like thermochemical cycles do benefit from sealed reactors, in which case radiative exchange surfaces like windows or opaque absorbed-emitter surface can be employed.

The chemically active substance within reactors can be in a form that facilitates volumetric absorption and emission of radiation. This reduces temperature gradients and facilitates faster radiative heat exchange. Examples of structures that facilitate volumetric absorption and emission of radiation include but are not limited to open pore structures like lattices, reticulated porous ceramics, honeycombs, mesh, etc. The material can also be in the form of a particle bed that can optionally be agitated by vibration, stirring or gas circulation. The chemically active substance can be shaped in a form that facilitates radiative heat exchange. For example, it could be shaped into one or more cavities that can efficiently exchange radiative heat with radiative exchange surfaces like windows. The use of multiple smaller cavities instead of a single large cavity can facilitate uniform heating of the chemically active substance while facilitating high mass loading of the substance within reactors.

Reactors of certain embodiments of the proposed system have a supporting structure for the chemically active substance. This can comprise (e.g., consist of) thermal insulation for reducing heat losses during operation. Thermal insulation can also reduce the outer temperature of reactors, which simplifies the process of moving reactors and exchanging mass with them. Insulation materials can include alumina, silica, zirconia, fiberglass, or combinations thereof. High-temperature applications can benefit from multi-layer insulation: for example, a high-temperature ceramic insulation and an outer, low-temperature microporous insulation.

A primary energy source to the reactor system can be in the form of electricity, heat or a combination thereof. In particular, renewable electricity (from wind turbines, solar photovoltaic panels, geothermal, nuclear, etc.) or renewable heat (from concentrated solar, nuclear heat) can be used as a ‘green’ primary energy source with very low greenhouse gas emissions compared to conventional fossil-based energy. An energy storage can be used as a buffer between the primary energy source and the reactor system. This is particularly attractive when the primary energy source experiences fluctuations in availability and/or price—for example wind and solar electricity. FIG. 10 shows a particular embodiment where solar energy is stored in a thermal energy storage (TES). Exemplary TES technologies include sensible heat storage in refractory materials, molten metals, etc. Alternatively, heat can be stored as phase change energy (e.g., solid-liquid transition of iron). Alternatively, heat can be stored by the execution of reversible chemical reactions (e.g., BaCO₃↔BaO+CO₂). The energy storage can be sized to operate the reactor system in the absence of primary energy input for a period of time ranging from 1 hour to 1 week.

Thermal energy can be supplied to reactors through a high-temperature heat source as shown in FIG. 10. Such a heat source can be a body with a high emissivity surface that is maintained at a high temperature by a heat transfer media. For example, it could be a coil of tubes having high surface emissivity and carrying a heat transfer fluid like molten salts or molten metals. The heat transfer medium can be reheated directly with the primary energy source or with stored energy (e.g., from TES). The energy storage and heat source may be combined into a single unit, for example, an electrically heated thermal mass that radiates heat to reactors as it cools down.

Reactors can also be heated radiatively by exposing them to concentrated solar irradiation. Solar radiation can be conditioned by devices like mirrors and lightguides. Other methods of energy transfer can include flowing heat transfer media (gas, liquid, or solid) through reactors, heating reactors inductively, and/or supplying electric current to reactors.

Heat can be radiatively extracted from reactors by the means of a radiative heat sink. This can facilitate useful harvesting of sensible heat content of reactors as they cool down and/or heat generated by exothermic reactions. The heat sink can serve the opposite function of the heat source, and similar physical embodiments can be used for the two devices. The harvested heat can be used within the reactor system, for example to perform thermochemical oxygen pumping. Alternatively, the harvested heat can be used for electricity production with a heat engine (e.g., power cycles, thermoelectric devices, and the like). The electricity produced can be used within the reactor system for auxiliary processes (e.g., pumping, separation, compression, hydrogen liquefaction, and the like) or can be sold as a product. The harvested heat and/or electricity produced from it can be used in other systems like reforming of carbonaceous material, electrolysis systems, and the like.

The system can employ radiation shields to slow down or otherwise modulate the rate of radiative heat transfer between different reactors and the heat sources and heat sinks. The reactors can further have features for storing thermal energy within them to retain heat for longer periods when the primary energy source is not available, or in case of failure of other system components.

Heat transfer between reactors can facilitate internal heat recovery in processes that involve large temperature variations. For example, the Heat Recovery Zone in FIG. 4 and FIG. 10 facilitates heat transfer from hot reactors to cold reactors. This can reduce the primary energy input needed for heating the cold reactors from T_{cold} to Tₕₒₜ. Moreover, the hot and cold reactors can move in opposite directions, similar to the flow of fluids in a counterflow heat exchanger. Heat transfer from hot to cold reactors can be radiative, in which case the Heat Recovery Zone takes the form of a Counterflow Radiative Heat Exchanger (CfRHx). Analysis shows that 75-85% heat recovery may be possible with a CfRHx when the RTS operates between Tₕₒₜ=1500° C. and T_{cold}=800° C. with a cycle time of about 1 hour.

The RTS system can use a scheme whereby the redox material stays within a sealed, insulated reactor for the entire cycle, and the entire reactor is moved. This can make the movement of redox material practical and reliable compared to, for example, bare bricks. Heat transfer and mass transfer can be achieved via windows and gas exchange ports respectively while the redox material stays within the reactor.

Housing the redox material permanently within the reactor can afford great flexibility in redox material shape and morphology selection. This can greatly enhance the rate of radiative heat transfer, for example by facilitating the use of highly porous materials with large pore size, and shaped into cavities. Such materials and structures have low mechanical strength and benefit from the permanent supporting structure of the reactor.

In some embodiments, the use of sealed reactors isolates redox material in a reactor from other reactors. This can facilitate precise, independent control of the atmosphere of every reactor. Embodiments of the present disclosure can facilitate gradual changes in the temperature, pressure, and/or chemical composition of a reactor as it moves through a region, creating a ‘gradient’ within a single zone. Such gradients may reduce irreversibilities in operation, for example the pressure cascade for vacuum pumping in the reduction zone (described below). Additionally, the isolation of gas-phase atmosphere can facilitate chemical reactions to take place within the heat recovery zone. Thus, a fraction of the recovered heat can be used to drive endothermic reduction reactions.

Provisions can be made for mass transfer between mobile reactors and their stationary surroundings. Such mass exchange can serve to introduce chemical reactants and extract products, introduce inert gases to alter the chemical composition within reactor, vary the pressure within reactors, introduce or carry away thermal energy from reactors via heat transfer media, etc. In applications where reactors are not sealed, changing the environment around reactors may be sufficient to effect these objectives. For examples, reactors may be introduced into an evacuated chamber to reduce their pressure. In certain applications that use scaled reactors, mass transfer ports can be used to exchange mass between mobile reactors and their stationary surroundings.

FIG. 11 shows an exemplary system where gas from an Inlet Manifold is being passed through a reactor, and the effluent is collected in the Outlet Manifold. For example, the inlet manifold can contain steam which flows into the reactors and undergoes water-splitting (Equation 2). The effluent can be a mixture of steam and hydrogen that is collected in an outlet manifold and sent to downstream processes like hydrogen separation. The connection between manifolds and the reactor can be made via a retractable conduit. In some embodiments, the conduit extends and latches onto the mass transfer port on the reactor. In some embodiments, once a secure connection is made, mass can flow between the reactor and manifolds. Mass flow may cease after a fixed period of time, and the conduit may disengage from the mass transfer port on the reactor and retract away. The disengaged reactor can now move on along its cyclic path. The engagement-disengagement can be facilitated by valves and seals to ensure a secure, leak-proof connection with low pressure drop. These elements may be designed to facilitate mass transfer even while the reaction is in motion. The thick insulation ensures that the mass transfer port has a much lower temperature than the redox material.

Mass can be transported from the mass transfer port on the reactor to the chemically active substance in it (e.g., the redox material in TC) via internal channels. For example, channels can be drilled into the insulation and their walls can be made impermeable to gas via further treatment. Having two coaxial pipes within the conduit for inflow and outflow (as shown in FIG. 11) facilitates having only one point of connection between the reactor and its surroundings. Such a system can also facilitate heat exchange between the incoming and outgoing streams, facilitating heat recuperation. Such recuperation can happen within the reactor as well as outside the reactor.

Apart from exchanging mass with external manifolds, reactors can also exchange mass amongst themselves. The outlet gas stream in FIG. 11 is collected in an outlet manifold. This can subsequently be processed as appropriate for the application. For example, the water-splitting step of TC produces a steam-hydrogen mixture from which hydrogen is to be separated. Such separation processes require additional energy and equipment, which can be minimized by increasing the conversion of steam to hydrogen during water-splitting. This conversion can be maximized by passing the gas mixture through multiple reactors with successively higher reduction extents of the redox material. This is shown schematically in FIG. 8. In some embodiments, such a flow scheme creates a counterflow between the redox material and steam and is facilitated by mass transfer between two reactors. Similar counterflow schemes can be used in other processes, for example, when an inert gas is used to sweep away oxygen from reactors in the reduction zone.

The mass transfer ports on reactors can be used for varying the pressure inside reactors. This can be achieved by connecting the reactors to a manifold which is at a higher or lower pressure than the pressure within the reactor. For example, FIG. 12A shows a scheme where multiple reactors are connected to a single manifold which is maintained at a pressure P1 which is lower than the ambient pressure PA. The manifold can be maintained at P1 with a vacuum pump. Pumping devices can also be installed onto the moving reactors. Such a system can be used when reactor pressure is varied between different steps of the cyclic process, and/or when gases are evolved or absorbed within the reactor. For example, oxygen may be evolved in the reduction step of TC processes (Equation 1). It may be advantageous to maintain the reactor at low oxygen partial pressure to drive the reduction reaction forward.

In a variation of this system, a series of manifolds can be used to reduce the pressure within reactors gradually as shown in FIG. 12B. This forms a Pressure Cascade. As reactors move in the system, they are connected to different manifolds at successively lower pressures (In FIG. 12B: P1<P2<P3<P4<P5<PA). Manifolds can be maintained at their designated pressures by vacuum pumps. Manifolds may be linked to each other as shown in FIG. 12B. Alternatively, they can be directly linked to the environment. The pressure cascade can reduce the amount of material that is pumped at lower pressures—all of the oxygen is pumped from P1 to PA in the single manifold system (FIG. 12A) whereas a portion of oxygen is pumped at higher pressures (P2, P3, P4 and P5) in the system in FIG. 12B. Analysis shows the pressure cascade can reduce overall pumping work and capital cost of pumps by about a factor of five compared to the single manifold system.

In systems where multiple reactors undergo cyclic pressure variations, it can be beneficial to connect two reactors at different pressure to equilibrate the pressure between them. This can reduce the pumping work required to depressurize reactors. In fact, a reactor being depressurized can be connected to a series of reactors at successively lower pressures to depressurize it to even lower pressures than a single exchange. Such ‘Pressure Recovery’ can be naturally executed in the Heat Recovery Zone of the RTS where the oxidized reactors are depressurized before reduction, and the reduced reactors are repressurized after exiting the Reduction zone.

Low oxygen partial pressure can enhance reduction in TC. This can be done by creating a vacuum and/or sweeping an inert gas through the reactor. Other techniques like electrochemical or thermochemical pumping of oxygen can also be used. Electrochemical elements can be incorporated into the reactors. This may be especially advantageous for electrochemical devices with solid oxide electrolytes that are maintained at high temperatures. Analysis shows that there may be regions within the insulation of RTS reactors that are at a constant temperature of 600-900° C. during operation. Electrochemical oxygen transport devices can be installed in these regions of the reactor.

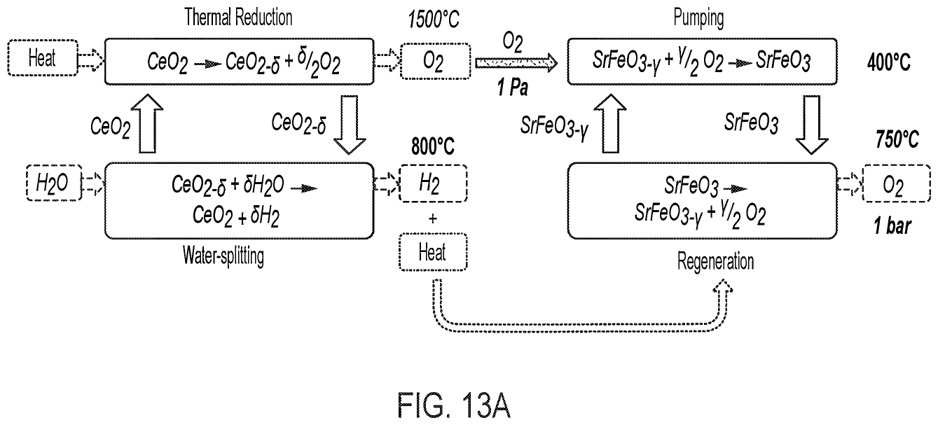

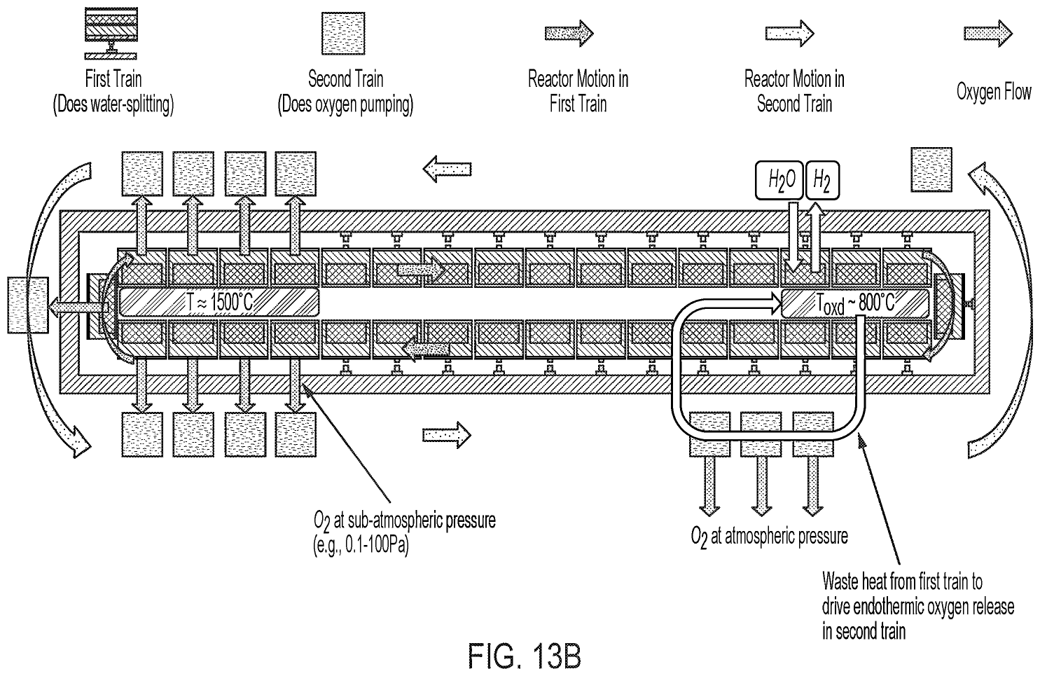

Thermochemical oxygen pumping can involve a pumping material that can absorb or adsorb oxygen as it is evolved from reactors. The pumping material may subsequently be regenerated by heating it up to a higher temperature where it releases oxygen. An example of this is shown schematically in FIG. 13A where the pumping material is Strontium Iron Oxide (SFO)—SrFcO₃ and the TC water-splitting material is ceria. The heat for heating up SFO and driving its regeneration reaction can be supplied from the heat harvested from the oxidation step of ceria TC. An example of thermochemical oxygen pumping is shown in FIG. 13B, wherein, in the high temperature, reduction zone (where the temperature of a heat source is indicated as 1500 degrees Celsius in this embodiment), thermal reduction occurs in a first reactor material in one or more first reactors in the first train of reactors to produce oxygen, and this oxygen flows at sub-atmospheric pressure from the first reactor(s) to second reactor(s) in the second train of reactors. The second reactor(s) pump the oxygen into a second reactor material in the second reactor(s) in the reduction zone. Steam is flowed in as a reactant for a water splitting process in the first reactor material in the low temperature oxidation zone, and waste heat from the exothermic water splitting process drives endothermic oxygen release from the second reactor material in a regeneration step. The cycle can then repeat.

Thermochemical oxygen pumping can be executed with a second set of reactors carrying the pumping material and receiving oxygen with the first set of TC reactors. For example, reactors carrying ceria can be connected to reactors containing SFO. This is shown schematically in FIG. 31. Connections between ceria and SFO reactors can be achieved with mass transfer ports and retractable conduits similar to FIG. 11. The SFO reactors can also be mobile. Further, they can move in the opposite direction of the ceria reactors, as shown by the arrows in FIG. 31. This embodiment creates a counterflow between SFO and ceria that can reduce the amount of SFO needed in the system.

Thermal insulation can reduce the outer temperature of reactors, which simplifies the process of moving reactors and exchanging mass with them. Analysis shows that with a 20 cm thick insulation and cycle time of about 1-2 hours, the outer reactor temperature can remain below 150° C. throughout the cycle, even when the other regions of the reactor reach temperatures as high as 1500° C. The reactor can be mounted on rails or one or more conveyer belts which contact the reactor only at its low temperature outer regions. The motion of reactors may be reciprocating or along a closed loop. The speed of reactors can vary with time, including bringing them to rest for a certain period of time.

In some embodiments, only a small region of the insulation close to the active material undergoes significant temperature variations during the cycle. Thus, in some embodiments, although the insulation may be thick and bulky, its contribution to thermal inertia is small once a steady cyclic state has been achieved. Analysis shows that the thermal inertia due to the insulation may be less than a quarter of the thermal inertia of the redox material in a thermochemical RTS whose reactors have characteristic dimension of 1 meter.

The amount of times reactors spend executing a certain step of the overall chemical process can be varied independent of other steps. For example, residence time within each zone of the RTS (e.g., in FIG. 4) can be tuned independently. Even when all reactors comprising the train move at the same average speed, residence time within a zone can be varied by changing the number of reactors in that zone. For example, residence time in the oxidation zone can be set to be twice the residence time in the reduction zone by having twice as many reactors in the oxidation zone. Fuel production and solar heat utilization can be continuous, and their rates can be varied by varying the cycle time of the train (or the speed of motion of reactors).

The Reactor Train system can be housed within an outer enclosure that can be insulated and/or sealed. The system enclosure is shown, for example, in FIG. 4. This component can help reduce heat losses from reactors. For example, maintaining the enclosure interior at sub-atmospheric pressure can reduce convective heat losses from hot exposed surfaces like reactor windows and the radiative heat source. The enclosure can be filled with an inert gas like argon to prevent undesirable chemical reactions.

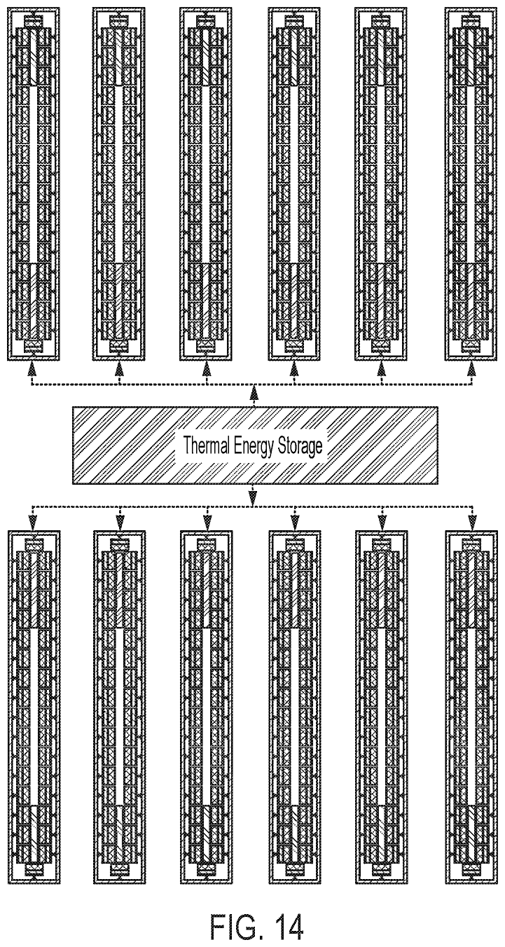

Multiple trains can be used to scale up the rate of fuel production. For example, in some embodiments, the overall system includes at least 2, at least 3, at least 5, at least 10, or more trains. These trains may use a common central thermal energy storage (TES), as shown in FIG. 14. Scaling up the TES can reduce heat losses per unit of energy stored. Multiple such units can be used in a single facility. The multiple trains may further be arranged in a way that reduces heat losses. These trains may interact with each other. An example of multiple trains with heat interaction between them is shown in FIG. 9 with ‘double-windowed’ reactors. These reactors can have two windows, which increases the area for useful radiative heat exchange for a given mass of redox material. At the same time, surface area for heat losses can be minimized.

As noted above, thermochemical redox cycles are a promising route for the production of solar fuels. One aspect of this disclosure relates to a novel Reactor Train system for efficient conversion of solar thermal energy to hydrogen. This system may be capable of recovering thermal energy from redox materials, which is important for achieving high efficiency, but has been difficult to realize in practice. Certain embodiments of the instant Reactor Train System overcame technical challenges of high temperature thermochemical reactors like solid conveying and sealing, while facilitating continuous, round-the-clock fuel production and incorporating efficient gas transfer processes and thermal energy storage.

Certain embodiments of the instant Reactor Train comprised several identical reactors arranged in a closed loop and cycling between reduction and oxidation steps. In some embodiments, in between these steps, the reactors undergo solid heat recovery in a radiative counterflow heat exchanger. This disclosure reports, e.g., a heat recovery effectiveness of 75-82% with a train consisting of 56 reactors and a cycle time of 84 minutes. In one example, with ceria as the redox material, 23% of the high temperature thermal energy input is converted to hydrogen, while 49% was recovered as intermediate-temperature heat at 750° C.

Solar Fuels offer a promising route for deep-decarbonization of the energy sector. They can be used for long-distance transportation, for providing high-temperature heat in industry, and for affordable, long-term storage of renewable electricity. Solar fuels include hydrogen, syngas, liquid fuels, etc. A recent study estimates a hydrogen production cost of $6.22/kg using solar photovoltaics and low-temperature electrolysis [M1]. This is nearly twice the cost of hydrogen produced by steam-methane reforming with carbon capture, which is about $3.5/kg [M2]. Meanwhile, long-term price targets for hydrogen are around $2/kg at the site of production [M3].

Thermochemical redox cycles are a relatively nascent technology that can achieve high efficiency, and potentially meet these stringent cost targets. In some thermochemical cycles, metal oxides like ceria undergo endothermic thermal reduction using solar thermal energy, typically at 1500° C. and oxygen partial pressures lower than 1 mbar. The metal oxide is subsequently regenerated in a water-splitting or CO2-splitting step, typically around 800° C. and atmospheric pressure. The temperature and pressure swings are necessary in these systems for each step to be thermodynamically favored.

Technoeconomic analyses suggest that more than half the cost of hydrogen produced by the thermochemical route can be attributed to the collection of solar thermal energy, especially the heliostat field [M4,M5]. Thus, increasing the heat-to-fuel conversion efficiency of thermochemical cycles can result in substantial cost reductions.

A dominant cause of low efficiency in thermochemical cycles is the lack of solid thermal recovery between the reduction and oxidation temperatures [M6-M8]. Other factors include inefficient gas exchange processes like vacuum pumping, low fuel production per cycle, intermittent operation and the lack of waste heat recovery at the lower temperature. Additionally, many reactor designs include significant technical challenges like scaling between reduction and oxidation zones, and transporting materials at high temperatures [M9-M11]. Although several reactor designs have been proposed, it had previously not been possible to demonstrate even 50% solid thermal energy recovery in a realistic thermochemical system. In certain embodiments of the present disclosure, solid thermal energy recovery of greater than 50% can be achieved.

In accordance with certain aspects of this disclosure, a novel ‘Reactor Train’ system is disclosed that achieves significant efficiency improvement over existing reactor designs, while addressing some of their most pressing technical challenges. In some embodiments, the system comprises several identical reactors arranged in a closed loop and cycling between the reduction and oxidation steps. Between the reduction and oxidation steps, in certain embodiments, the reactors go through a Counterflow Radiative Heat Exchanger (CfRHx), where reactors that are being cooled transfer heat to reactors that are being heated. The Reactor Train can simplify processes like high temperature solid conveying and scaling, while facilitating continuous, round-the-clock fuel production and efficient mass transfer processes.

Following is described embodiments of the Reactor Train design in detail, including example geometries of individual reactors, and some material choices for critical reactor components are identified. Then is described a numerical model which was used to simulate the performance of an example of the Reactor Train. This disclosure reports a heat recovery effectiveness of, e.g., 75-82% for the base configuration, with potential improvements from further modification of the design and operating conditions.

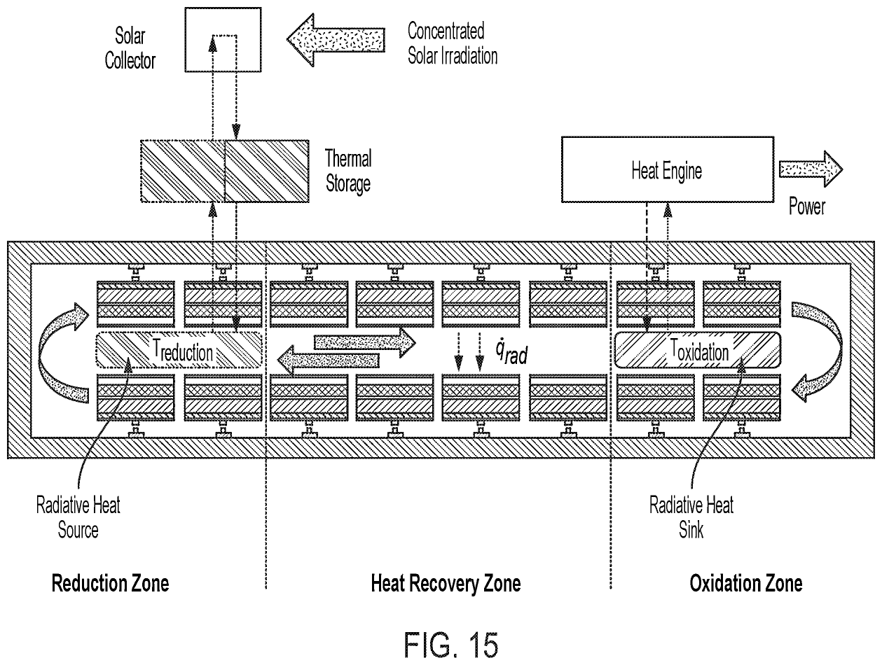

In one example, the Reactor Train comprises several reactors arranged in a closed loop and cycling between reduction and oxidation steps. In between these steps, reactors undergo solid heat recovery. A schematic of a Reactor Train system is shown in FIG. 15. The system has a Reduction Zone on the left-hand side where the redox material undergoes thermal reduction and evolves oxygen. There is an Oxidation Zone on the right-hand side, where the redox material is oxidized by steam to produce hydrogen. Alternatively, carbon dioxide can be used as the oxidizing agent, leading to the production of carbon monoxide.

In some embodiments, the central Heat Recovery Zone has two streams of reactors—a ‘hot’ stream on the top and a ‘cold’ stream at the bottom. The movement of reactors is shown by solid arrows in FIG. 15. Reactors exit the high temperature reduction zone and move to the right along the top stream. As they move toward the oxidation zone, these reactors cool down by radiating heat towards the bottom stream of reactors. Reactors exiting the low temperature oxidation zone move to the left along the bottom stream and are radiatively heated up. The hot and cold streams thus form a counterflow radiative heat exchanger (CfRHx).

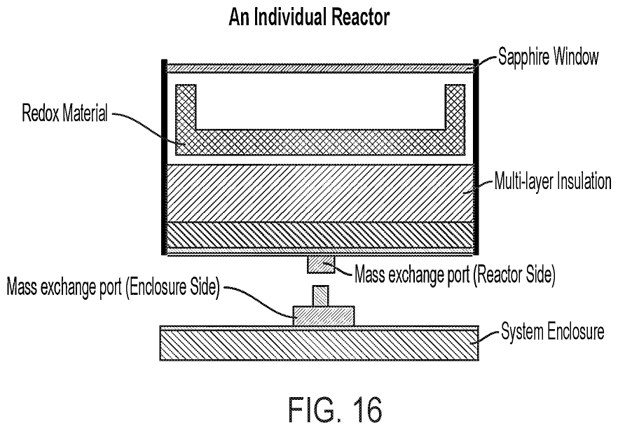

An example of an individual reactor is shown in FIG. 16. The reactor has a sapphire window to facilitate radiative heat transfer. Redox material within the reactor can be shaped into an arbitrary shaped cavity, honeycomb, etc. to enhance absorption and emission of radiant heat. In some embodiments, the reactor has thick, multi-layer insulation to minimize heat losses, and to ensure that the outer surface is at a low temperature. In certain embodiments, all moving contacts are placed on the outer surface of the reactor. In some embodiments, the reactor has a mass exchange port on the outer surface. This port can, in some embodiments, reversibly attach to a mass transfer port on the system enclosure to exchange gases. In some embodiments, after a fixed residence time the connection can be disengaged, and the Reactor Train can move forward one step to the next mass transfer port. An example of a means of moving the reactors is to mount them on rails and move them using intermittently spinning motors. As shown in this disclosure, a thick insulation can ensure that points of contact with the rail system are maintained below 150° C. even as the redox material cycles between 800-1500° C.

In some embodiments, residence time within each zone of the Reactor Train may be varied independently by changing the number of reactors in that zone. For example, residence time in the oxidation zone may be set to twice the residence time in the reduction zone by having twice as many reactors in the oxidation zone. Fuel production and solar heat utilization may generally be continuous. The system may be scaled up by increasing the size of individual reactors or using multiple trains, in some embodiments.

A counterflow radiative heat exchanger (CfRHx) has been conceptually described and analyzed before by Falter [M12,M13] and Siegrist [M9,M14]. Those designs used moving ‘bricks’ of redox material. Falter et. al. showed that the counterflow arrangement can achieve heat recovery effectives greater than 70%. Their model accounted for heat losses and finite rate of heat diffusion within redox bricks [M13]. They report that slow heat diffusion within the redox brick can hamper CfRHx performance, and it is beneficial to have thinner bricks with high porosity to address this issue.

Siegrist et. al. extend the CfRHx idea with a more complete description of the thermochemical system [M9,M14]. They propose a single, large reduction chamber where moving bricks of redox material are reduced by direct irradiation with concentrated solar radiation. They propose to use a CfRHx to exchange heat between redox bricks that are cooling down and those that are heating up. These authors claim that the moving brick design overcomes some drawbacks of particle-based systems by facilitating precise control of residence time of the redox material in various zones, and reducing dusting.

The moving brick concept faces significant technical challenges because of the need for high-temperature material conveying and pressure regulation. The design of Falter et. al. lacks details of a mechanism for moving the redox material. Siegrist et. al. propose to use a conveying system whereby discrete solid bodies of the redox material are mounted and unmounted from a conveying mechanism like rails, slides, chains, wheels, grippers or sealed, insulated containers. This mounting-unmounting scheme can present significant technical challenges, given the high operating temperatures and the brittle nature of most metal oxides at these conditions. It also requires the bricks to be mechanically robust, while heat transfer considerations favor thinner, porous bricks [M13].

Certain embodiments of the instant Reactor Train system use a scheme whereby the redox material is moved along with the entire reactor. This can eliminate intermittent mechanical contacts at high temperature, and provide greater flexibility in designing the geometry and morphology of the redox material.

Siegrist et. al. make a provision to install a semi-transparent sapphire barrier between the hot and cold streams of the CfRHx [M15]. Radiative transfer is faster when no barrier is used. However, as the cold oxidized redox stream heats up in the CfRHx, it undergoes thermal reduction and release oxygen. If no barrier is present, this oxygen can cross over and recombine with the hot, reduced redox stream which is cooling down. Such recombination leads to reduced fuel production in the water-splitting step. When the extent of heat recovery is high, the oxidized redox stream is heated to higher temperatures and releases more oxygen in the CfRHx, resulting in greater recombination. A recent analysis showed that a CfRHx which facilitates oxygen crossover can result in a net negative impact on cycle efficiency when heat recovery effectiveness is greater than 50% [M16]. The redox material was ceria.

Certain embodiments of the instant Reactor Train employ individual sealed reactors with windows to prevent such oxygen crossover. In fact, this design can isolate a reactor from its neighbors, addressing the need for sealing between the reduction and oxidation zones. With certain embodiments of the mass transfer system described in this disclosure, it is possible to have a controlled, gradual change in pressure and chemical composition as reactors move along the train. The utility of this will be pointed out shortly in the context of vacuum pumping and gas-solid counterflow.

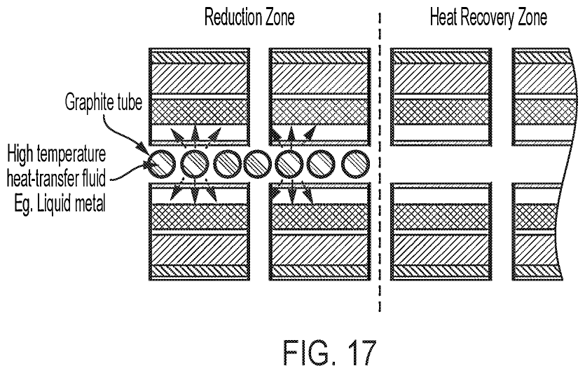

The reduction zone may be maintained at a desired temperature by a radiative heat source, shown schematically in FIG. 15. This can be realized as an array of graphite tubes carrying a molten metal like tin. A schematic of such a system is shown in FIG. 17. Molten tin may subsequently be reheated in a high-temperature solar receiver [M17]. Such an indirect coupling between solar collection and the thermochemical system can facilitate thermal energy storage, guarding against intra-day transients in solar irradiation [M18,M19] and potentially facilitating continuous fuel production through the night. Further, it may be possible to take advantage of other energy sources like cheap, renewable electricity to heat up the heat transfer medium, increasing the flexibility of the system. Potential heat transfer and storage media include molten metals, inert refractory particles, molten silicon, etc.

The oxidation zone may have a radiative heat sink as shown in FIG. 15. The heat sink can harvest unrecovered sensible thermal energy and exothermic reaction enthalpy from the reactors. Molten chloride salts may be used as the heat transfer medium. The heat so harvested may be used in a power cycle to produce electricity. Previous studies have assumed that waste heat may be used to produce electricity [M9,M20-M22].

It is believed that this disclosure is the first time that a reactor system capable of harvesting waste heat is being presented.

Radiation is the primary mode of heat transfer in all zones, in certain embodiments of the Reactor Train. This can avoid direct contact between heat transfer medium and the reactor. Additionally, it can minimize the distance over which heat transfer medium must be transported. A shorter circuit for the heat transfer medium results in lower heat losses, smaller pressure drop, and fewer points of failure. This is in contrast to the elaborate network of liquid metal pipes proposed by Yuan et. al. [M23] or the ‘Particle Mix Reactor’ proposed by Brendelberger et. al, which involves multiple stages of mixing and separation of redox and inert particles [M11,M24].

Efficient heat transfer can be important for the success of the Reactor Train system. In particular, the following are examples of design features that may lead to improved performance: a) Increasing the rate of useful radiative exchange between reactors. b) Ensuring greater uniformity of temperature within the redox material. c) Minimizing heat loss through the insulation.

The rate of useful radiative exchange between reactors may be increased by increasing the window area for a given amount of redox material within the reactor. Other ways of increasing the rate of radiative transfer can include increasing window transmittance and the effective emittance of the porous redox material. The former may be achieved by choosing appropriate window materials that have good transparency in the infrared spectrum. At temperatures between 800-1500° C. most of the black body emission spectrum generally lies between 0.5-10 micrometer wavelengths.

Sapphire can be a promising window material because of its transparency in the infra-red spectrum, high temperature stability, mechanical strength, and chemical inertness. Alternatively, highly absorbing opaque surfaces (e.g., silicon carbide) can be used to facilitate radiative transfer. A thinner window can reduce absorption, although a minimum thickness may be dictated by mechanical strength considerations.

Unlike windows of solar receivers, this window does not necessarily need to be actively cooled. This is acceptable, in certain embodiments, because the window may not be exposed to concentrated solar radiation, and the heat-up time can be several tens of minutes.

Effective emittance of the redox material can be increased by shaping it into a cavity, rather than a brick as suggested previously [M9,M13]. Thermal conductivity of redox materials like ceria can be quite low at the desired operating conditions, slowing down the diffusion of heat to the material further away from the window. This can lead to several issues that have been observed in directly irradiated receiver-reactors.

Thermochemical reactor-receivers that are directly irradiated with concentrated solar radiation are believed to represent the current state-of-the-art in terms of solar-to-fuel efficiency [M6, M25]. Drawbacks of these reactors include difficulty in realizing continuous and scalable operation [M26,M27], and limited scope for solid heat recovery [M7]. Moreover, they experience large temperature gradients within the redox material [M28-M30], leading to cracking and delamination [M25]. Melting and sublimation have been observed at hot spots on the irradiated surface [M28]. These issues stem from a mismatch between high solar heat flux entering the cavity and getting absorbed on the top layer of the redox material, and the much smaller heat flux through the low-conductivity redox material.

One way to reduce temperature gradients within the redox material is to facilitate volumetric absorption of radiation. A smaller extinction coefficient also generally leads to faster internal heat diffusion by radiation. While efforts are underway to realize this by modifying the microstructure [M31,M32], slow heat diffusion within the redox material can limit the thickness of the redox cavity to 2-4 cm. This can be a hindrance for scaling up receiver-reactors beyond 1 MW thermal input [M33].

Certain embodiments of the instant Reactor Train system decouple solar heat collection and the thermochemical cycle. This addresses several issues associated with receiver-reactors. In certain embodiments of the present system, the redox material is not exposed to concentrated solar radiation, and as will be shown later, typical heat-up times can be of the order of tens of minutes. This may result in smaller temperature gradients within the redox material, resulting in lower thermal stresses and longer life of the redox material. This is important because the redox material can make up a significant fraction of the cost of a thermochemical reactor [M4]. Although thermal stresses can be likely to be smaller in the Reactor Train system, stress can build up due to chemically induced volume changes [M34,M35].

The design of the reduction zone (e.g., in FIG. 17) can help to ensure that there are no temperature overshoots, unlike the hot spots found in directly irradiated systems that lead to sublimation and cracking. Unlike receiver reactors, the present system may operate continuously, and may be scaled up easily using bigger reactors or multiple trains. At the same time, the Reactor Train can come with the complexity of high-temperature heat transfer and storage media that are not needed for receiver-reactors.

The use of radiative transfer in the CfRHx can lead to extended cycle times that make heat losses an important consideration. The Reactor Train can use thick, multilayer insulation to reduce heat loss through the insulation, and to reduce the temperature at the outer wall of the reactor. Moving parts of the reactor conveying mechanism and the mass transfer mechanism can be exclusively located in the low-temperature regions of the reactor, thus eliminating high-temperature moving parts. One of the novel features of certain embodiments of the Reactor Train is that the entire reactor is moved between different zones, instead of transporting just the redox material. A potential drawback of this scheme is the added thermal inertia of the insulation and supporting structures within the reactor. This can increase the amount of heat that is to be recovered between the reduction and oxidation zones, and can slow down the process of heat recovery. In this disclosure, the effective thermal inertia due to insulation was, in one example, less than 50% that of the redox material. This can be due to the low density of porous ceramic insulation, along with its low thermal diffusivity.

Mass transfer between moving reactors and their stationary surroundings can be important for the progress of chemical reactions. This can be achieved by temporary connections between external gas tanks and the mobile reactors. An exemplary mass transport system is shown in FIG. 11. It comprises mass transfer ports on the reactor side, and mass transfer ports that are fixed to the system enclosure.

Certain embodiments of this system entail an intermittent motion of the Reactor Train. A reactor can move along the train and come to rest above a mass transfer port on the enclosure. The latter may have a retractable conduit that is connected to gas tanks. The conduit can move as shown by the solid arrow (see FIG. 11) to attach to the mass exchange port on the reactor. Mass may then be exchanged between the reactor and external tanks. After a certain residence time, the conduit can detach from the reactor, and the reactors move. FIG. 15 shows a series of mass transfer ports on the enclosure wall. Reactors can hop from port to port, spending a certain residence time at each port. Highly controllable mass exchange can thus be achieved at any point in the train, including the heat recovery zone.

The retractable conduit in FIG. 11 comprises (e.g., consists of) two co-axial pipes, with mass flowing into the reactor through the annular region (outer arrows), and mass flowing out through the central pipe (inner arrows). Piping within the reactor comprises (e.g., consists of) hollow passages in the insulation. As described in this disclosure, the insulation may be about 20 cm thick. The idea of having two coaxial pipes for inflow and outflow is one way to have only one point of connection between the reactor and its surroundings. Such a system can also facilitate gas-phase heat recovery from the hot gas stream exiting the reactor to the cold gas stream entering it. This may happen within the reactor as well as outside the reactor. [M36]

It could be advantageous for the locations of inlets and outlets within the reactor cavity to facilitate good contact between the gas phase and the redox material. As an example, this may be achieved by placing the inlets at the corners and the outlet at the center of the cavity floor (shown in FIG. 11). Alternative inlet and outlet locations include near the window, along the side walls of cavity, etc.

In some embodiments of this disclosure, oxygen partial pressure is reduced in the reduction zone by vacuum pumping. Other methods like inert gas sweep, and electrochemical or thermochemical [M37,M38] oxygen pumping may also be used. Since each reactor has a dedicated mass transfer system, a ‘pressure cascade’ may be implemented to reduce the pumping work [M39,M40]. As per this strategy, the vacuum pressure within a reactor in the reduction zone can be reduced gradually, so that a fraction of the evolved oxygen can be pumped at higher pressures where pump efficiency is higher [M41]. A pressure cascade can be realized by a series of tanks (similar to FIG. 11) interconnected through vacuum pumps to minimize the overall pumping work.

A gas-solid counterflow configuration in the reduction and oxidation zones has been shown to result in substantial efficiency gains [M42]. When applied to the oxidation zone, this configuration can entail streams of oxidant-fuel mixture (gas) and the redox material (solid) moving in opposite directions. This may reduce chemical irreversibilities in much the same way a counterflow heat exchanger reduces thermal irreversibilities. The Reactor Train can realize such a counterflow configuration. Although each reactor is likely to be internally well-mixed, a chemical potential difference can exist between neighboring reactors. For example, there may be several reactors in the oxidation zone, with oxygen non-stoichiometry reducing gradually as reactors move forward. The oxidant stream may be routed from one reactor to another, in the direction opposite to the motion of reactors to realize a gas-solid counterflow. This can be especially useful for redox materials like ceria-zirconia and perovskites that need a larger oxidant flow than ceria [M42]. A gas-solid counterflow may also be used when an inert sweep gas is used in the reduction zone.

The ability to exchange mass with reactors in the CfRHx may present the opportunity to execute redox reactions in the heat recovery zone. Apart from reducing the cycle time, this may be especially advantageous in thermochemical cycles because of the significant heats of reactions; reduction is generally endothermic, while oxidation by steam or carbon dioxide is generally exothermic. Some of the exothermic heat generated by oxidation of the reduced reactors that are cooling down may be transferred to the reactors that are heating up. Oxidized reactors that are being heated up may use a part of the heat input to undergo endothermic thermal reduction, and the evolved oxygen can be pumped away. This can increase the rate of heat recovery, as shown by results in this disclosure.

The heat transfer considerations detailed above have led to the following embodiments of high-level design of individual reactors. This disclosure presents geometries of the window, the redox material and the insulation. Additionally, some material choices were made and justified. In some embodiments, the operating range of the cycle is taken to be 800-1500° C., which is typical for ceria [M6,M25].

The reactor may be considered to have a square sapphire window of side length 30 cm in one embodiment. Larger windows can be preferred because scaling up the reactor reduces specific heat loss. However, manufacturing large sapphire flats can be challenging [M43]. In one embodiment, the window is considered to be 4 mm thick. A small thickness may be preferred because it increases transmittance and reduces the overall thermal inertia of the reactor. On the other hand, mechanical strength and manufacturability considerations can impose a minimum allowable thickness. The present illustrative 4 mm value is a non-limiting estimate.

In one embodiment, the temperature and wavelength dependent complex refractive index of sapphire was obtained from the measurements of Zhang et. Al[M44]. Temperature and wavelength dependent values of hemispherical transmittance, emittance, and reflectance were then calculated. Geometric optics were assumed to be valid for the purpose of these calculations. Modeling the sapphire-gas interfaces followed the generalized treatment of electromagnetic waves at interfaces between absorbing dielectrics (for example, see Modest [M45] page 50).

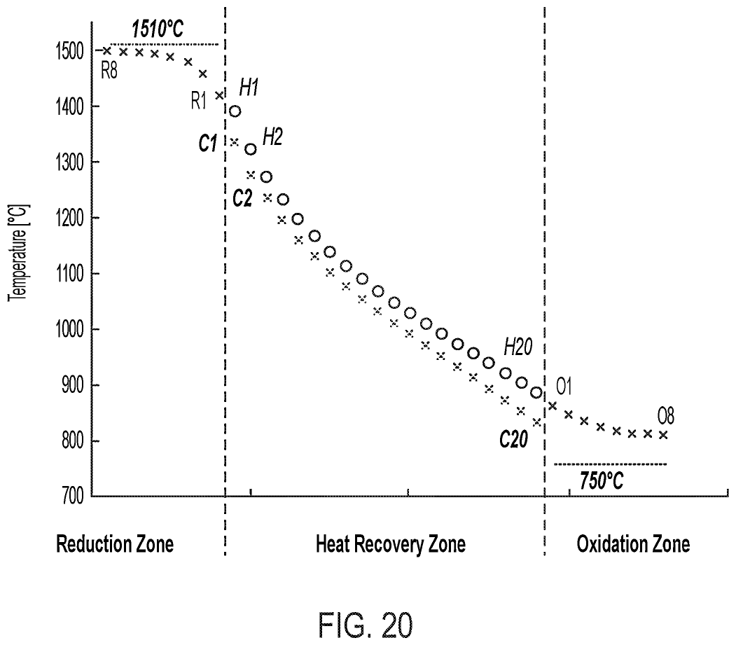

A grey radiative transfer model (that is, assuming no spectral dependence) was employed to reduce computational cost. Accordingly, temperature-dependent hemispherical total transmittance, emittance and reflectance were obtained by averaging spectral quantities over the black body spectrum. The spectrum was taken at the same temperature as the window. This is justified because the bodies emitting radiation towards a window are generally within 100° C. of the window temperature. (See FIG. 20 in this disclosure). The example transmittance thus obtained was 0.55 at 800° C., and 0.66 at 1500° C. Given this narrow range of variation, a further simplification was made by considering constant optical properties averaged over 800-1500° C. Thus, the transmittance, emittance and reflectance were taken to be τ_{w}=0.6087, ε_{w}=0.2044 and r_{w}=0.1869 respectively in this embodiment. It is noted that the reflectance of sapphire is nearly four times as large as that of quartz.

The redox material in one embodiment was considered to be ceria reticulated porous ceramic (RPC) with dual-scale porosity [M46]. Ceria is currently used as a redox material [M8,M25], and the RPC morphology facilitates volumetric absorption and emission of radiant heat [M47]. The low extinction coefficient of RPC can also speed up internal heat cquilibration by radiative transfer.

In one embodiment, the ceria RPC is considered to be arranged as a square cavity of side 30 cm (same as the sapphire window) and depth 15 cm. Ceria mass loading was assumed to be 100 kg/m² window area in this embodiment. This corresponds to a cavity thickness of 2-2.4 cm depending on porosity. In this embodiment, the shape of the cavity as well as ceria mass loading were chosen to be representative, and further modification is expected to improve performance by a significant amount.

In one embodiment, the shape of the cavity leads to an irradiated surface area that is 2.2 times the window area. For a given ceria mass loading, increasing the irradiated surface can result in a thinner cavity, decreasing the length over which heat is to be conducted within the redox material. The resultant improvement in the rate of heat recovery can be an advantage of the Reactor Train design over the moving brick designs of Falter and Siegrist [M9,M12]. Cavities made of RPC can be fragile and likely cannot be repeatedly mounted and unmounted from a conveying system. The irradiated area may be further increased by shaping the redox material into multiple smaller cavities. This can be especially useful when the reactor size is increased to scale up fuel production.

In one embodiment, a lumped capacity model was used to represent the redox material. As per this model, the ceria cavity was assumed to be at a uniform temperature. Previous numerical analyses of thermochemical receiver-reactors have found that large temperature gradients exist within the ceria RPC, with temperature variations of the order of 200° C. However, in certain embodiments, reactors of the proposed Reactor Train undergo a very different heat-up process, which makes the lumped assumption more tenable.

While receiver-reactors are heated by exposure to concentrated solar radiation, cold reactors of the Reactor Train can be heated by a counterflow of hotter reactors. The source temperature witnessed by the cold reactors thus can increase gradually as they traverse the heat recovery zone. Moreover, the illustrative total heat-up time in Reactor Train simulations presented below is about 40 minutes, while the illustrative heat-up time of receiver reactors was 10-15 minutes [M29]. A more homogenous ceria temperature in the illustrative Reactor train compared to receiver-reactors is generally observed. Indeed, certain embodiments have greater similarity to the counterflow radiative heat exchanger (CfRHx) simulations of Falter et. al. [M13] Those authors report a temperature variation of less than 100° C. in 2 cm thick bricks of porous ceria. However, the heat up time was very short at 320 seconds.

In some embodiments, by virtue of having a uniform temperature, the cavity also has a uniform non-stoichiometry (δ in CeO_{2-δ}). The state of the redox material can thus be fully described by a single value of temperature (T_{ceria}) and non-stoichiometry (δ). Apart from justifying the lumped approximation for the purpose of the simulations, the spatial homogeneity can have physical significance too. Internal stresses induced by thermal and chemical volume changes may be lower, leading to longer redox material life.

In one embodiment, radiative exchange between the RPC and its surroundings was modeled as surface absorption and emission of radiation. The lumped model implied an infinitely large thermal conductivity to ensure temperature homogeneity. This model required an effective surface emittance of ceria RPC. This was evaluated for a representative RPC morphology using one-dimensional Monte-Carlo ray tracing.

In this embodiment, the RPC morphology was considered to be similar to that used in the experiments of Zoller et. Al [M25]. This illustrative RPC had dual-scale porosity, with a total porosity of 0.78 and a strut porosity of 0.36, with 7 pores-per-inch. For this morphology the correlations of Ackermann et. al. [M47] yielded an extinction coefficient of 304 m⁻¹. They also reported an anisotropic scattering phase function. The reflectance of ceria struts depends on its non-stoichiometry, with δ=0, 0.0001 and 0.377 corresponding to reflectance of about 0.875, 0.475 and 0.36 respectively. These numbers were obtained by averaging the spectral hemispherical reflectivity reported by Ackermann et. Al [M48]. It is noted that along with changes in non-stoichiometry, reflectance of ceria struts may be altered by dopants even in small concentrations [M49].

With the above properties, in this embodiment, 1D Monte-Carlo simulations were conducted with 10⁵ rays following the methodology presented in the Radiative Heat Transfer textbook by Modest [M45] (page 699). RPC thickness was taken to be 2.2 cm in this embodiment. The effective surface emittance was found to be 0.51, 0.82 and 0.875 corresponding to δ=0, 0.0001 and 0.377. The transmittance was negligibly small. For the purpose of the simulations, an effective surface emittance of ε_{eff-ceria}=0.82 was considered.

In some embodiments, of the six sides of the rectangular reactor (FIG. 15 and FIG. 16 are 2D representations which show four of these sides), one side has the window, while the two lateral sides face neighboring reactors (the ‘left’ and the ‘right’ sides in FIG. 15). In some such embodiments, the other three sides face the system enclosure. These latter sides can witness a temperature drop of several hundred Kelvin, between the redox material that can swing between 800-1500° C. and the system enclosure which can be maintained close to 100° C. In one embodiment, insulation on these sides is considered to be 20 cm thick consisting of a 12.5 cm thick Zirconia [M50] layer and a 7.5 cm thick microporous silica (Microsil) [M51] layer. This can help to ensure that the Microsil temperature remains below its operating limit (950° C.) at all times. Zirconia was chosen for its lower conductivity and heat capacity compared to alumina. The insulation can experience temperature transients, and low heat capacity and diffusivity may be desirable for reducing the overall thermal inertia of the reactor.

On the lateral sides of the reactor which face neighboring reactors, the temperature drop may be, e.g., of the order of 100° C. This was estimated from the temperature difference between neighboring reactors reported in results in the instant disclosure. Thus, in one embodiment, the insulation is taken to be only 5 cm thick and consists of zirconia.

In one embodiment, the system was maintained at low pressure to reduce convective heat losses from reactor surfaces, including the hot window. In one embodiment, the only mode of heat loss considered in these simulations was by conduction through the insulation on the three sides exposed to the enclosure. Based on illustrative dimensions quoted above. this area may be, e.g., 6.2 times the window area. On the other hand, the inner surface area of the insulation that faces the redox cavity may be, e.g., 2.7 times the window area. These numbers are used in the numerical model described below.

Here are presented numerical models used for simulating certain embodiments of the Reactor Train. This includes models for calculating heat fluxes across semi-transparent windows, and heat diffusion through the insulation. The entire reactor was simulated by combining these models into a single ‘layered’ model. A Reactor Train configuration was then described, including the execution of chemical reactions.

In one embodiment, radiative transfer across sapphire windows was modeled using the Net Radiation method following the methodology of Siegel [M52]. This is shown below for the case when a reactor is exposed to the heat source in the reduction zone. It may easily be extended to the case of radiative transfer between two reactors. The latter occurs in the heat recovery zone, and involves two windows in the radiation path.

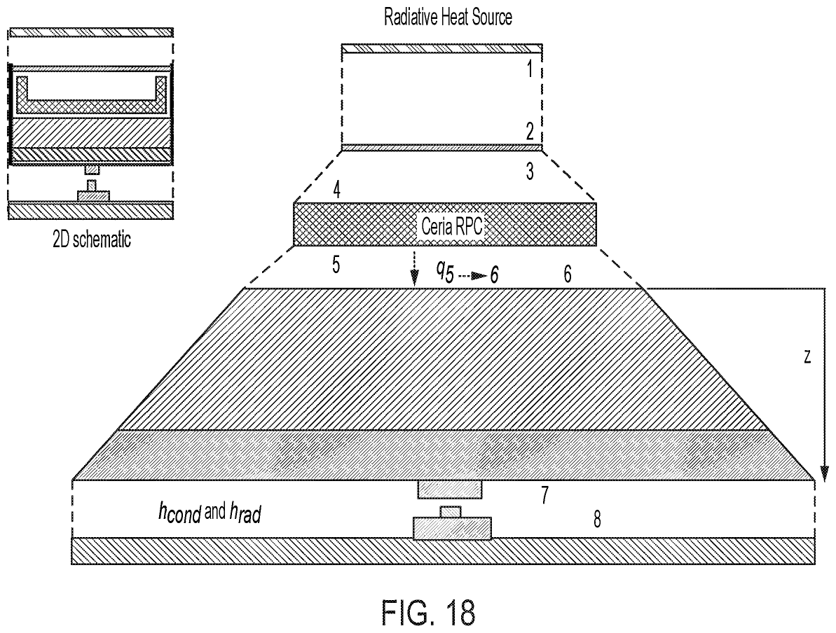

In one embodiment, FIG. 18 shows the ‘layered model’ of the reactor, whereby the window, ceria RPC and insulation were treated as three ‘layers’ of the reactor. While the window and ceria layers were modeled as lumps (zero dimensional in space), the insulation was modeled as a one-dimensional layer. The layers have varying cross-sectional areas, which is captured qualitatively in FIG. 18.

In one embodiment, the window and emitter were assumed to be at a distance much smaller than the dimension of the window. Accordingly, surfaces 1 and 2 had view factor unity. Additionally, based on the construction of the redox cavity, view factor between surfaces 3 and 4 was taken to be unity. According to the net radiation method, surfaces 1 through 4 were assumed to be isothermal and uniformly irradiated.

In one embodiment, considering the conceptual enclosure formed by the emitter (1) and the redox cavity (4), the following net radiation equations may be obtained following Siegel [M52]. Jᵢ and Hᵢ represent radiosity and irradiance at surface i respectively. The transmittance terms in Equations 4 and 5 result from the semi-transparent nature of the sapphire window. Emittance of the heat source was taken to be εₑ=0.95. Tᵢ and Aᵢ are the temperature and area of surface i, and σ is the Stefan-Boltzmann constant.

$$\begin{matrix}{J}_{1} = {ε}_{e} σ {T}_{1}^{4} + ( 1 - {ε}_{e} ) {H}_{1} & ( 3 ) \\ {J}_{2} = {ε}_{w} σ {T}_{2}^{4} + {r}_{w} {H}_{2} + {τ}_{w} {H}_{3} & ( 4 ) \\ {J}_{3} = {ε}_{w} σ {T}_{3}^{4} + {r}_{w} {H}_{3} + {τ}_{w} {H}_{2} & ( 5 ) \\ {J}_{4} = {εe}_{eff - ceria} σ {T}_{4}^{4} + ( 1 - {ε}_{eff - ceria} ) {H}_{4} & ( 6 )\end{matrix}$$

In one embodiment, view-factor based relations can be written as shown in Equation 7, where a=A₃/A₄. An explicit time-stepping scheme was used to calculate radiative heat fluxes. Thus, the temperatures are known, and Jᵢ's and Hᵢ's were evaluated using Equations 1 through 5 (see Modest [M45] for details). Radiative heat transfer between two reactors was solved in a similar manner.

$${H}_{1} = {J}_{2} ; {H}_{2} = {J}_{1} ; {H}_{3} = {J}_{4} ; {H}_{4} = {aJ}_{3} + ( 1 - a ) {J}_{4} \qquad ( 7 )$$

In one embodiment, transient energy conservation equations for the window and ceria cavity were as follows. The sapphire window was assumed to be at a uniform temperature T_{win}. This is likely to be a very good assumption because the window is thin, absorbs and emits heat volumetrically, and has relatively high thermal conductivity compared to other ceramics. Equilibrium non-stoichiometry of ceria was evaluated using the enthalpy and entropy of reduction as reported by Panlener et. al. [M53]

$$\begin{matrix}{( mCp )}_{win} \frac{{dT}_{win}}{dt} = {A}_{2} ( {H}_{2} + {H}_{3} - {J}_{2} - {J}_{3} ) & ( 8 ) \\ {( mCp )}_{ceria} \frac{{dT}_{ceria}}{dt} + \frac{{m}_{ceria}}{{MW}_{ceria}} {H}_{red , ceria} ( δ ) \cdot \frac{d δ}{dt} = {A}_{4} ( {H}_{4} - {J}_{4} ) - {q}_{5 \to 6} & ( 9 )\end{matrix}$$

In one embodiment, the radiative terms Jᵢ's and Hdi's were evaluated explicitly using the temperature field from the previous time step. q_{5→6} is the heat lost by ceria to the insulation, and is described below. dδ/dt is the rate of change of ceria non-stoichiometry, and depends on the execution of chemical reactions.

In one embodiment, a transient heat conduction equation was used to model heat transfer through the insulation. With reference to FIG. 18, insulation temperature was assumed to vary only in the vertical ‘z’ direction, leading to a 1-dimensional heat conduction problem. The governing equation is given by Equation 10. Insulation properties and geometry are presented in this disclosure. Assumed was a linear variation of cross-sectional area (A_{c/s}) from surface 6 to surface 7. Equation 10 was solved using an implicit finite difference scheme that is second order in space and first order in time. K is the thermal conductivity, and it is temperature dependent [M50,M51].

$${A}_{c / s} ρ Cp \frac{dT}{dt} = \frac{d}{dz} ( K ( T ) \cdot {A}_{c / s} \frac{dT}{dz} ) \qquad ( 10 )$$

In one embodiment, surface 6 was assumed to be at the same temperature as the ceria RPC, owing to rapid radiative transfer between surfaces 5 and 6, and much slower heat diffusion into the bulk of the insulation. By conserving energy at surface 6, the rate of heat transfer from surface 5 to 6 (q_{5→6}) was obtained as the heat conducted away from surface 6 within the insulation (Equation 11).

$${{q}_{5 \to 6} = - K ( T ) {A}_{6} \frac{dT}{dz} ]}_{6} \qquad ( 11 )$$

In one embodiment, the system enclosure (surface 8) was assumed to be held at 120° C. This temperature can be controlled by losses to the environment, or by active cooling. There was radiative exchange between surfaces 7 and 8, with both surfaces assumed to have an emittance of 0.3. Further, although the system enclosure is evacuated, heat loss by conduction through the gas phase was considered. This was modeled by a heat transfer coefficient h_{cond}=0.8 W/m2K, which corresponds to a 5 cm gap filled with air at atmospheric pressure. Varying this value by a factor of 5 did not have a measurable impact on temperature distribution within the insulation. The following mixed boundary condition at surface 7 (Equation 12) was obtained, which was solved implicitly for T₇. h_{rad} is the effective heat transfer coefficient due to radiative exchange, and it was obtained using the value of T₇ from the previous time step.

$${- K ( T ) {A}_{7} \frac{dT}{dz} ]}_{7} = {A}_{7} ( {h}_{cond} + {h}_{rad} ) ( {T}_{7} - {T}_{8} ) \qquad ( 12 )$$

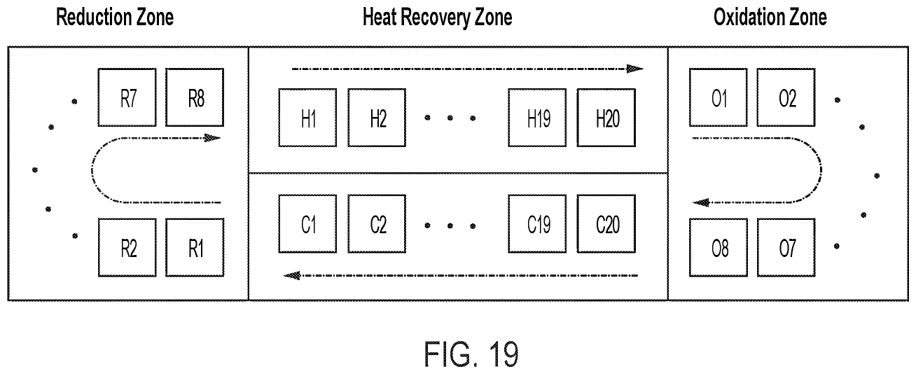

In one embodiment, the models described above were combined to simulate the Reactor Train as shown in FIG. 15. FIG. 19 shows a schematic of a base configuration, which is similar to the system shown in FIG. 15. 8 reactors in the reduction zone at positions R1-R8 were considered. Similarly, there are 8 reactors in the oxidation zone at positions O1-O8. There are 20 reactors on the ‘hot’ and 20 on the ‘cold’ sides of the heat recovery zone at positions H1-H20, and C1-C20 respectively.

In one embodiment, according to intermittent motion, reactors stay at each position for 90 seconds, before moving in unison to the next position. The 90 s period is hereafter called an ‘exchange’. The direction of motion is shown by arrows in FIG. 19. The time spent in motion was assumed to be much smaller than 90 s. Thus, each reactor spent, e.g., 8×90 s=720 s in the reduction and oxidation zones, and, e.g., 20×90 s=1800 s during each pass of the heat recovery zone. This configuration has, e.g., 56 reactors, and each reactor completes a full cycle in, e.g., 84 minutes.

In one embodiment, target reduction and oxidation temperatures for ceria are taken to be 1500° C. and 800° C. respectively. During an ‘exchange’, reactors in the reduction zone exchange heat with the radiative heat source which is maintained at, e.g., 1510° C. Similarly, reactors in the oxidation zone exchange heat with the radiative heat sink which is maintained at, e.g., 750° C. In the heat recovery zone, the reactor at position H1 can exchange heat with the reactor at position C1, H2 with C2, and so on. In one embodiment, after the 90 s ‘exchange’, reactors are moved forward one position.

Ceria can be easily oxidized with steam at 800° C. Thus, in one embodiment, it was assumed that the reactor at O8 is fully oxidized as it leaves the oxidation zone.

In one embodiment, reactors of the C-i and R-i series were maintained at a reduction pressure of 10-4 bar to aid reduction. Thermodynamic equilibrium was assumed to exist in these reactors. This is a good assumption for ceria provided vacuum pumps are able to sweep away oxygen as it is evolved, so that a pressure of 10-4 bar is maintained at all times. At this pressure, ceria can undergo reduction as temperature rises, starting in the heat recovery zone itself. The reactor at R8 may have the highest oxygen non-stoichiometry δₘₐₓ as it leaves the reduction zone. In one embodiment, reactors H1-H20 were assumed to be sealed, so that ceria non-stoichiometry is maintained at δₘₐₓ as the reactor cools down in the heat recovery zone.

At 800° C., ceria is efficient at water-splitting with high steam-to-hydrogen conversion. Thus, the rate of 8 variation in the oxidation zone can be controlled by varying the steam flowrate. For the purpose of some of the instant illustrative simulations, a constant rate of oxidation was assumed. That is, δ varies from δₘₐₓ to 0 at a constant rate throughout the 720 s residence time in the oxidation zone. This assumption avoids the complexities of the actual oxidation process which is governed by water-splitting kinetics and fluid flow within the reactor. Experimental tests reported by Zoller et. al. show that the rate of hydrogen production at the end of oxidation step is about half of the peak rate [M25].

In one embodiment, individual sub-models were validated and basic verification studies were conducted for the full model. Convergence in spatial and temporal discretization was verified. From a numerical standpoint, the insulation sub-model is the most complex piece of the overall scheme. This was validated by simulating transient heat conduction in a semi-infinite body with a step temperature change at its surface. For a fixed conductivity and cross-sectional area, this problem has an analytical solution.

In one embodiment, 25 complete cycles of the Reactor Train were simulated to ensure that the effects of the imposed initial conditions are removed. In other words, results shown below represent repeatable cyclic performance after the start-up transients have died out. The Reactor Train system may operate continuously due to its ability to use stored solar thermal energy (see FIG. 15).

The variation of ceria temperatures at the end of an exchange, that is, just before the reactors move, is shown in FIG. 20, according to some embodiments. The x-axis roughly corresponds to the horizontal span of the Reactor Train system as shown in FIG. 19. Reactor positions are marked (H1, C2, R1, etc.) for easier interpretation of FIG. 20. The central region of FIG. 20 represents the heat recovery zone, with circles representing the hot stream and crosses representing the cold stream. The left region represents the reduction zone, where reactors are arranged R8-R1 for better visualization. Similarly, the right region represents the oxidation zone, where reactors are arranged O1-O8.

In one embodiment, the maximum and minimum temperatures attained by the redox material were 1499° C. and 810° C. respectively. In one embodiment, the difference between the window temperature and redox temperature of a particular reactor was never greater than 37° C.

In one embodiment, the temperature difference between opposing reactors in the Heat Recovery zone increased slightly as the temperature decreased. That is, the difference between ceria temperatures in H20 and C20 was 55° C., which is greater than the difference between H5 and C5 which was 36° C. This was expected from the T⁴ dependence of radiative heat fluxes. However, the temperature differences between H1 and C1 was larger at 56° C. This might have been due to the progress of endothermic reduction reactions in C1. The progress of reduction reactions can lead to slower temperature rise of the cold stream, and can increase the rate of heat transfer. This can increase the net heat recovered.

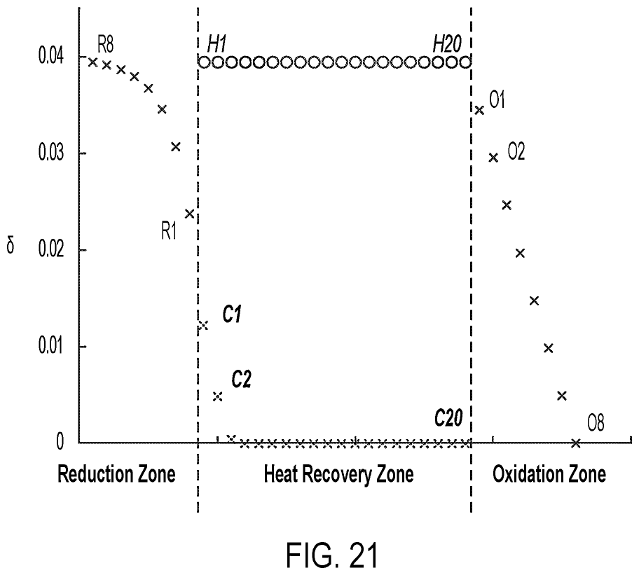

In one embodiment, the variation of ceria non-stoichiometry at the end of an exchange is shown in FIG. 21. This figure has the same layout as FIG. 20. The maximum non-stoichiometry attained was 0.0394 corresponding to a fuel productivity of 229 μmol-H₂/gram-ceria. Ceria underwent reduction in the heat recovery zone, with non-stoichiometry in C1 being 0.0122 at the end of an exchange. The constant rate of oxidation in the oxidation zone (an imposed condition) was evident by the linear variation of 8 with reactor position in the right panel of FIG. 21. It is noted that oxidation may be started in the heat recovery zone itself, say in reactors H15-H20. The exothermic heat could then raise ceria temperature in these reactors, leading to faster heat transfer to the colder reactors.

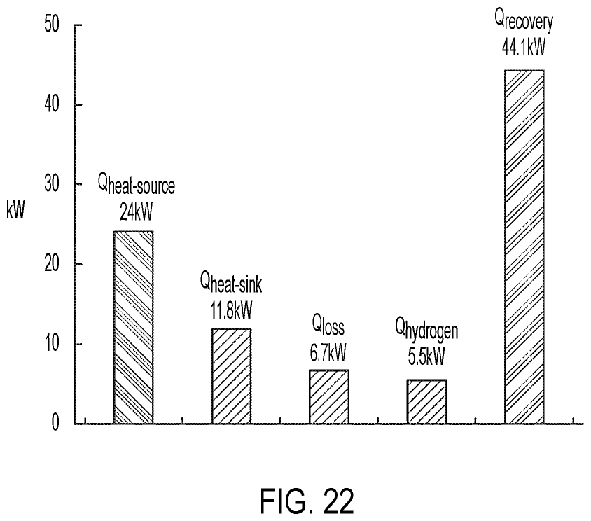

In one embodiment, at δₘₐₓ=0.0394, the fuel production rate was 1.375 mol-H₂/minute. The net rate of high-temperature heat consumption was 24 kW. This is the average power supplied by the heat source in the reduction zone (Q_{heat-source}). Of this, 5.5 kW was obtained as hydrogen (Q_{hydrogen}—lower heating value (LHV) basis), 11.8 kW was harvested by the heat sink (Qₕₑₐₜ₋ₛᵢₙₖ), and 6.7 kW was lost through the insulation (Qₗₒₛₛ). Thus, 22.9% of the input high-temperature heat was converted to hydrogen (LHV basis), while 49.2% was harvested as intermediate-temperature heat. The harvested heat can be used in a power cycle for electricity production. It is noted that the thermochemical system will have other energy expenses in terms of vacuum pumping and fuel separation and compression. The total rate of heat transfer from the hot reactors to cold reactors in the heat recovery zone was 44.1 kW (Q_{recovery}). This is the sum of all 20 reactors in the CfRHx. These values are summarized in FIG. 22.

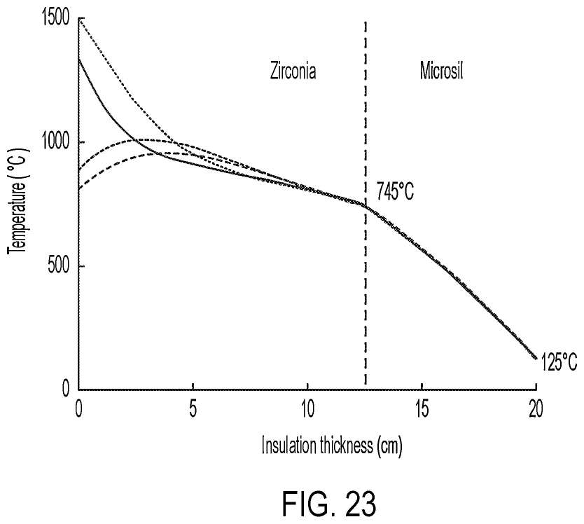

In one embodiment, the temperature profile within the insulation underwent cyclic variations as the reactor traveled along the train. FIG. 23 shows temperature profiles at 4 points—entering reduction zone (C1 position, solid line), exiting the reducing zone (R8 position, dashed line), entering oxidation zone (H20 position, dash-dot line), exiting the oxidation zone (O8 position, dotted line). While the redox material cycled between 800-1500° C., these temperature variations only affected the first 5 cm of the insulation. The rest of the temperature profile was unchanged throughout the cycle. This can be explained as follows.

In one embodiment, thermal diffusivity (α) of the zirconia insulation varies between 4.5×10⁻⁷ m²/s in its operating range. Over a timescale of τ=84 minutes, a heat diffusion lengthscale can be estimated as l_{diff}˜\sqrt{ατ} which is between 4.75-6 cm. An implication of this is that although the insulation was 20 cm thick, its contribution to the overall thermal inertia of the reactor during cyclic operation was much smaller.

In one embodiment, ceria had its highest temperature and non-stoichiometry at the end of reduction (R8 position), and the lowest temperature and non-stoichiometry at the end of oxidation (O8 position). The difference between energy contents of ceria at these two stages of the cycle had a sensible heating component (ΔE_{ceria}=[mCₚΔT]_{ceria}) and a chemical component (ΔE_{chem}=n_{ceria}δH_{red} (δ)). The difference between the highest and lowest energy state of the window, that is the net energy swing of the window, is ΔE_{win}=[mCₚΔT]_{win}. It was found that ΔE_{win}=0.48ΔE_{ceria}. In other words, the effective thermal inertia of the window was 48% of the thermal inertia of the redox material. Similarly, the energy swing of the insulation was 34% of the that of the redox material. Thus, the thermal inertia of all inert, supporting materials was 82% of the thermal inertia of the active redox material.

In one embodiment, most cycle efficiency analyses did not account for the added thermal inertia of inert reactor components. The net energy swing of the entire reactor in a cycle due to sensible heating and cooling was ΔE_{ceria}+ΔE_{win}+ΔEᵢₙₛᵤₗ. This is 5.7× the energy input needed to reduce ceria (ΔE_{chem}). This demonstrates the importance of solid heat recovery in non-stoichiometric redox cycles—the sensible energy swing was much larger than the chemically useful energy input needed to reduce ceria.

In one embodiment, the outer surface of the reactor was at 125° C. throughout the cycle. In this embodiment, all moving parts, including components of the mass transfer system, were located exclusively on this low-temperature part of the reactor. This facilitated reliable operation with a wide array of structural materials.

In one embodiment, heat recovery effectiveness of the CfRHx can be defined in two ways-based on temperature of the redox material (Equation 13), and based on the amount of energy recovered (Equation 14). The former can be helpful for comparing the Reactor Train to other reactor designs, while the latter can be a more physically meaningful metric in terms of energy savings. Equation 13 defines the heat recovery effectiveness as the ratio of increase in ceria temperature within the Heat Recovery Zone divided by the maximum possible temperature rise. T_{ceria}(X) is the temperature of ceria at reactor position X at the end of an exchange.

Equation 14 defines heat recovery effectiveness as the energy gained by a reactor in the heat recovery zone divided by the total energy needed to raise the temperature of the reactor. The heat input needed to reduce ceria (Q_{reduction}) is excluded from the denominator, because the goal of heat recovery is to recover sensible heat. The quantities in Equation 14 follow the definitions associated with FIG. 22.

$$\begin{matrix}{η}_{Hx - 1} = \frac{{T}_{ceria} ( C 1 ) - {T}_{ceria} ( O 8 )}{{T}_{ceria} ( R 8 ) - {T}_{ceria} ( O 8 )} = 76.36 \% & ( 13 ) \\ {η}_{Hx - 2} = \frac{{Q}_{recovery}}{{Q}_{recovery} + {Q}_{heat - source} - {Q}_{reduction}} = 75.59 \% & ( 14 )\end{matrix}$$

In one embodiment, when chemical reactions were ignored, that is when ceria was assumed to be inert, it was found that n_{Hx-1}=82.9% and n_{Hx-2}=75.0%. It is noted that although temperature rise in the CfRHx (represented by n_{Hx-1}) was much higher in the case without reactions, the total amount of heat recovered (represented by n_{Hx-2}) was actually slightly lower.

The value n_{Hx-1}=82.9% may be compared to heat recovery effectiveness reported in other reactor designs. Falter et. al. [M12] report an optimal heat recovery of 73.7% when ceria bricks are assumed to be at a uniform temperature, similar to the instant model. The Sandia CR5 reactor consisting of counter-rotating redox disks was estimated to recovery 86% of sensible heat [M54] although there were technical difficulties in the operation of that reactor [M10].

This disclosure presents a Reactor Train system for efficient thermochemical solar fuel production. Certain embodiments of this system are configured to recover heat from redox materials, which is important for achieving high efficiency, but has been difficult to realize in practice. Certain embodiments of this Reactor Train overcome technical challenges of high temperature thermochemical reactors like solid conveying and sealing, while facilitating continuous, round-the-clock fuel production and efficient gas transfer processes.

Certain embodiments of the Reactor Train comprise (e.g., consists of) multiple reactors moving around a closed loop with demarcated reduction, oxidation and heat recovery zones. In some embodiments, each reactor has a sapphire window, a cavity comprising (e.g., consisting of) the redox material, and thick insulation. Reactors can also have specialized mass exchange ports to exchange gases with the surroundings even as they move along the train. Heat may be recovered from reactors in a counterflow radiative heat exchanger. In one embodiment, it was found that the presence of sapphire windows did not significantly retard radiative exchange between reactors. In some embodiments, the use of thick insulation on reactors reduced heat losses, while not significantly increasing the effective thermal inertia of the reactor. In one embodiment, heat recovery effectiveness of 75-82% was obtained with a train comprising (e.g., consisting of) 56 reactors and a cycle time of 84 minutes. The Reactor Train may employ a variety of redox materials. In one embodiment, with ceria, 23% of the high temperature heat input was converted to hydrogen fuel, while 49% was recovered as intermediate-temperature heat at 750° C.

Certain additional embodiments of the present disclosure are related to Reactor Train Systems (RTS) that address another major source of inefficiency-oxygen removal during metal reduction.

In accordance with certain embodiments, two oxygen pumping schemes were considered-vacuum pumping (VP) and thermochemical oxygen pumping (TcOP). For vacuum pumping, the modularity of RTS facilitated a ‘Pressure Cascade’ which reduced pumping work by a factor of four and the capital expenditure (capex) by a factor of five as compared to a single-step VP scheme. The improved RTS+VP system achieved 31% heat-to-hydrogen conversion efficiency with ceria despite the low efficiency of vacuum pumps at low pressures.

In one embodiment, thermochemical Oxygen Pumping (TcOP) used a second redox material—SrFeO₃—to pump oxygen. This material was transported in reactors moving in the opposite direction to the main RTS train. The improved RTS+TcOP achieved more than 40% heat-to-hydrogen efficiency, while producing twice as much hydrogen per kilogram of ceria as the RTS+VP system.

The following nomenclature is used in the description that follows:
α Oxidation extent of ceria
γ SFO non-stoichiometry (SrFeO_{3-γ})
δ Ceria non-stoichiometry (CeO_{2-δ})
RTS Reactor Train System
SFO SrFeO₃
TcOP Thermochemical Oxygen Pumping
VP Vacuum Pumping

Renewable zero-emission fuels are an important component of economy-wide decarbonization efforts because they may address hard-to-electrify sectors like shipping. aviation, trucking, steel and cement production, and other industrial heating applications. These fuels can serve as carriers of renewable energy-capturing wind, solar, nuclear, and other forms of green energy in the form of chemical energy that may then be transported and stored easily. Examples of such fuels are green hydrogen, syngas, and synthetically produced hydrocarbons like methanol, and liquid hydrocarbons.

Electrochemical devices, especially low-temperature and high-temperature electrolysis, are often regarded as the most promising technology to convert electricity to hydrogen because they use electricity directly to split water. However, electrolyzers may not be well-equipped to address the intermittency of renewable electricity. The typical capacity factor of solar photovoltaic (PV) is only 25-30%, leading to similarly low utilization of the electrolyzer hardware. A recent US DOE study showed that even with technology and manufacturing improvements expected in polymer electrolyte membrane (PEM) electrolyzer by 2035, it is difficult to produce hydrogen at a cost below $2/kg unless very optimistic assumptions are made about the price of electricity and the capacity factor—e.g., availability of electricity with a 97% capacity factor and at 3 cents/kWh. This is optimistic because the Levelized Cost of Energy (LCOE) target for concentrated solar with 12-hour storage, one of the cheaper ways of providing renewable electricity round-the-clock, is 5 cents/kWh. While solar PV may produce electricity at 3 cents/kWh or less, its capacity factor can be much lower. This trade-off between the price of electricity and capacity factor can stem from the high cost of storing electricity. Additionally, matching electrolyzer operation with time-varying renewable electricity production can lead to accelerated degradation of the electrochemical stack.

Liquefaction of hydrogen before transportation can be an attractive option, especially when it is to be transported over long distances and when the target application involves liquified or highly compressed hydrogen. Liquefaction plants can be energy intensive and operate most efficiently when operated at steady throughput-they can have limited ability to vary their operation to match intermittent renewable generation. Coupling electrolyzers producing H₂ intermittently to a liquefaction plant can necessitate buffer storage of hydrogen which adds significantly to the cost. These issues can center around the intermittency of renewables and the high cost of storing electricity. Thermochemical redox cycles may avoid these issues by storing renewable energy as heat, and using such heat directly for water-splitting (or CO2-splitting) in a continuously operating reactor system.

Thermochemical redox cycles can be a promising technology that uses high-temperature heat to split water. This approach may address the intermittency and capacity factor issues because heat is much cheaper to store than electricity, even with projections to 2035 and beyond. Another advantage of thermochemical redox cycles is that they may split water, carbon dioxide, and their mixtures simultaneously in the same hardware, facilitating the production of syngas with tunable composition. While thermochemical technology has been studied extensively with several demonstrations, these reactors were based on direct irradiation with concentrated solar (no energy storage) and had less than 10% heat-to-fuel conversion efficiency. To compete with electrolysis and produce hydrogen at less than $1/kg, thermochemical systems could benefit from a multi-fold increase in efficiency.

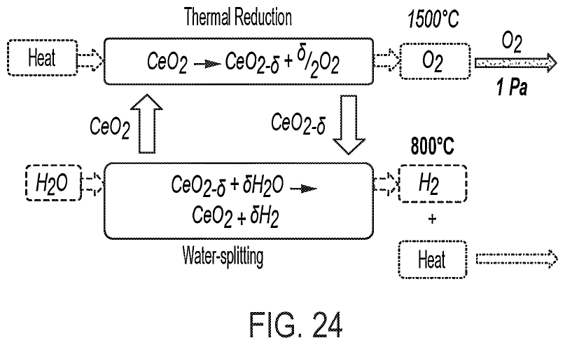

FIG. 24 shows a schematic of a thermochemical water-splitting cycle, in accordance with some embodiments. In these embodiments, ceria (CeO₂) underwent reduction at 1500° C. and low oxygen partial pressure (˜1-10 Pa). Reduced ceria was cooled to an intermediate temperature 800° C. where it was oxidized by steam to produce hydrogen. The oxidized ceria was again heated up to 1500° C. and the cycle continued. The only inputs to this illustrative system were heat and steam, and the outputs were separate streams of hydrogen and oxygen. Instead of steam, carbon dioxide may be used as the oxidizing agent to produce carbon monoxide. In this example the focus was on water-splitting. Along with hydrogen, waste heat was produced at 800° C. because of the exothermic nature of water-splitting. The temperature swing between 1500° C. and 800° C. as well as the low oxygen partial pressure during reduction drove the reactions forward.

Several methods have been considered for lowering the oxygen partial pressure—e.g., vacuum pumping, inert gas sweep, thermochemical oxygen pumping and electrochemical oxygen pumping. While some systems use vacuum pumps, it is uneconomical to operate them at low oxygen partial pressure (<100 Pa) because of efficiency and capital expenditure (capex) considerations. In addition, the capital cost of pumps can remain a critical drawback—the low density of oxygen at these pressures can necessitate very large pumping equipment, leading to a dramatic rise in capex as the pressure is reduced. Inert gas sweep has been analyzed in great detail, and a counterflow arrangement between redox material and the inert sweep can be particularly attractive. However, designing a reactor with moving high-temperature redox particles may present technical challenges. Electrochemical pumping can also be a promising option, although it has not received as much attention in terms of reactor design. In one embodiment herein, the thermochemical oxygen pumping is employed in the system.

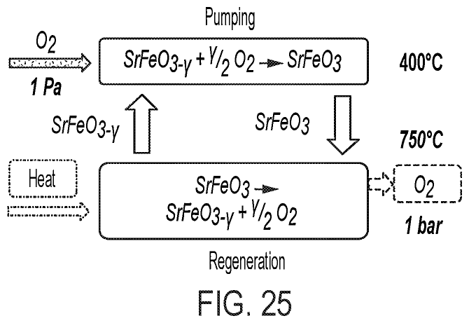

FIG. 25 shows a Thermochemical Oxygen Pumping (TcOP) scheme, which uses a second redox cycle, according to some embodiments. In the figure, a perovskite—strontium iron oxide (SrFcO₃, SFO)—is used as the ‘pumping material’ while ceria in FIG. 24 is the ‘splitting material’. Oxygen released by ceria is absorbed by the reduced SFO. Absorption of oxygen into the SFO lattice is facilitated by maintaining it at a low ‘pumping temperature’ of about 350° C. Lower temperatures can be preferred for SFO oxidation, but reaction kinetics may become a concern. Oxidized SFO is heated up to a ‘regeneration temperature’ where it underwent reduction and released oxygen from its lattice, at higher pressures. SFO may be regenerated at intermediate temperatures, and it is possible to design the system so that waste heat from ceria oxidation may be used to heat up SFO and drive its endothermic reduction reaction. Regenerated (reduced) SFO is then cooled down to the pumping temperature and the cycle continues.

Several perovskite materials have been considered for TcOP, particularly doped SrFcO₃ and CaMnO3 systems. Since pumping materials are also attractive candidates for solar thermochemical air separation and thermochemical storage of solar energy, there is significant ongoing research into the discovery and testing of novel material compositions. Recently, sorption based materials have been proposed for oxygen pumping. For the present modeling in one embodiment, SrFeO₃ was used because it is a well-studied material whose thermodynamics are suited for integration with RTS.

In some thermochemical hydrogen (STCH) production systems, more than 70% of absorbed solar heat can be used to reheat ceria and the reactor from 800° C. to 1500° C. in each cycle. This can be a major source of inefficiency. It may be avoided with isothermal or near-isothermal cycles, where the redox material is oxidized at close to near-reduction temperatures. However, steam-to-hydrogen conversion can be very low for these systems, which reduces efficiency when steam-hydrogen separation work is accurately accounted for. Another option is internal solid heat recovery, where thermal energy released by ceria as it cools down after reduction is used to heat up another batch of ceria. The present inventors have proposed a Reactor Train System (RTS) similar to that elsewhere herein that uses multiple identical moving reactors that execute solid heat recovery in a counterflow radiative heat exchanger. The RTS can recover more than 75% of available thermal energy while overcoming many of the technical challenges faced by previous designs. A schematic of an illustrative RTS is shown in FIG. 26.

Unlike previous STCH systems, certain embodiments of this RTS decouple solar energy harvesting and thermochemical reactions, which facilitates the use of multi-hour thermal energy storage (TES).

STCH can reject heat during ceria oxidation, consisting of unrecovered sensible heat as well as the exothermic heat of water-splitting. The RTS can harvest this “waste” heat radiatively and use it to drive auxiliary applications. For example, it may be converted to electricity in a power cycle to drive vacuum pumps, hydrogen separation and compression, and the like (e.g., as illustrated in FIG. 26). It may also be supplied directly to the TcOP system, since ceria oxidation temperature is close to the temperature at which many perovskite materials may be regenerated (e.g., as shown in FIG. 24). Continuous hydrogen production along with continuous electricity production with waste heat may also make onsite liquefaction an attractive addition to the RTS.

Having addressed the solid heat recovery problem with certain embodiments of the present disclosure, a next major source of efficiency loss is the work that may be needed for oxygen removal during reduction. Next, the use of Vacuum Pumping (RTS+VP) and Thermochemical Oxygen Pumping (RTS+TcOP) to reduce oxygen pumping work is evaluated.

In this disclosure is described the configuration and modeling of four illustrative sub-systems: the Reactor Train (RTS), Pressure Recovery, Vacuum Pumping (VP) and Thermochemical Oxygen Pumping (TcOP). These sub-models are then used to calculate and improve the heat-to-hydrogen efficiency of different RTS configurations.

The computational method used for RTS modeling was the same as that described above. In this embodiment those models are extended to include detailed modeling of the oxygen removal system-VP or TcOP.

In one embodiment, a reactor train with 60 reactors was considered, with 15 reactors in the reduction zone, 15 in the oxidation zone, and 15 on each side of the heat recovery zone. The residence time of a reactor at each station was 1 minute, resulting in reduction and oxidation times of 15 minutes each, and a total cycle time of 60 minutes. This configuration resulted in >70% solid heat recovery while keeping cycle time and conductive heat losses reasonably low. In the present embodiment the RTS configuration was kept fixed, while the oxygen removal system was analyzed in detail.

In one embodiment, reactors with window size 1 m×1 m were considered as a balance between reducing the impact of heat losses and keeping reactor size small enough for factory assembly and shipping. Each reactor contained 150 kg of ceria. Following the heat transfer analysis presented above, this RTS configuration led to 75% solid heat recovery with conductive heat losses of 17 kJ per kilogram of ceria per cycle (about 22% of the HHV of H₂ produced in RTS+VP system). Additionally, 5% of net heat input from the TES was assumed to be lost before it could reach the reactors. The contribution of reactor insulation and window to the thermal inertial of the reactor was taken to be equal to the thermal inertial of the ceria itself.

In one embodiment, ceria is used as the water-splitting redox material. Equilibrium thermodynamics was used to model ceria oxidation and water-splitting because of its fast kinetics compared to the residence time of reactors in reduction and oxidation zones (15 minutes each). Since the gas flow pattern inside each reactor was complex, a well-stirred reactor model (WSR) was used whereby each reactor i had a unique and uniform temperature Tᵢ(t) (for the solid and the gas phases), ceria non-stoichiometry δᵢ(t), oxygen partial-pressure p_{O}_{₂}₋ᵢ(t) and hydrogen mole fraction x_{H}_{₂}₋ᵢ(t) during water-splitting. Moreover, the gas stream leaving the reactor had the same temperature and composition as the gas inside the reactor. The equilibrium assumption dictated that p_{O}_{₂}₋ᵢ(t) corresponded to the equilibrium oxygen partial pressure at δᵢ(t) and Tᵢ(t).

In one embodiment, water-splitting proceeded by injecting separate streams of steam into each reactor in the oxidation zone and extracting a steam-hydrogen mixture. Steam-hydrogen separation was assumed to proceed with a high-temperature device that did not require steam condensation—for example proton-conducting perovskite membranes. While condensation can be a straightforward method for separating steam and hydrogen, the latent heat of vaporization could not be recovered in a heat exchanger and was lost (both condensation and boiling happened at the same temperature and there was no heat transfer from one to the other). This is a large energy penalty, especially when steam to hydrogen conversion during water-splitting is low. In the current illustrative analysis, it was assumed that steam-hydrogen separation was at 300° C. with a second-law efficiency of 20%. The separated steam was recycled and sent back to the reactor along with make-up steam. Gas-phase heat recuperation between the ceria oxidation (water-splitting) temperature (˜800° C.) and separation temperature (300° C.) was assumed to be 75% efficient. This may be achieved with a heat exchanger attached behind each reactor.

In one embodiment, the separated hydrogen was compressed to 100 bar in a compressor with a Second Law efficiency of 30%. The 100 bar pressure was chosen because future hydrogen pipelines will likely operate in that vicinity, and it is also the pressure hydrogen is typically compressed to in the Claude liquefaction cycle.

In one embodiment, the reduction zone of the Reactor Train received heat at 1500° C. from the TES. At the other end, unrecovered sensible heat from reactors and exothermic water-splitting heat was recovered in the oxidation zone at temperatures between 700-1000° C. Such ‘waste heat’ may be used in a power cycle to produce electricity. This intermediate-temperature power cycle was assumed to operate at 40% efficiency which is achievable with steam-Rankine or supercritical carbon dioxide cycles. If the system required additional electricity, heat from the TES at 1500° C. may be used directly in a high-temperature power cycle. The high-temperature power cycle was assumed to operate at 60% efficiency which is achievable with combined-cycle or supercritical carbon dioxide power cycles.

In one embodiment, ceria oxidation temperature (Tₒₓ) was taken as an optimization variable with a lower bound of 700° C. to ensure the reaction kinetics were reasonably fast. The extent of oxidation of ceria (δₒₓ) was also considered as an optimization variable, since complete oxidation can necessitate excessive amounts of steam, reducing efficiency. The lowest oxygen partial pressure achieved during the reduction process (p_{red}) was a third optimization variable. Ceria oxidation was assumed to proceed at 1 bar. Apart from the three optimization variables mentioned above (Tₒₓ, δₒₓ. p_{red}), the TcOP system had its own additional optimization variables.

In one embodiment, as they leave the oxidation zone, ceria reactors are filled with steam at a pressure of 1 bar, potentially with a small concentration of remnant hydrogen. This steam is to be removed before the reactor reaches the reduction zone so that the gas phase was primarily oxygen, which can be important for the TcOP process presented below. Evacuating the steam-filled reactor may be accomplished with vacuum pumps, but this carries an energy penalty. In one embodiment herein is proposed an alternative ‘Pressure Recovery’ scheme to reduce the energy penalty of evacuating the reactor. In some such cases, the ceria reactors leaving the reduction zone are at a very low pressure (p_{red}) and they will eventually be repressurized to 1 bar as they enter the oxidation zone.

In one embodiment, in the heat recovery zone (see FIG. 26), the top row of reactors was at a higher temperature than the lower row, leading to radiative heat transfer from the top to the bottom. Analogously, the bottom row of reactors was at a higher pressure (p_{oxd}) than the top row (p_{red}). Thus, if a gas channel were opened between each top-bottom pair of reactors, steam from the bottom reactor would have flowed to the top reactor till their pressures equalized. Accordingly, in certain embodiments, gas is transported between one or more (or all) of the reactors at the high temperature side of the heat recovery zone to one or more (or all) of the reactors at the low temperature side of the heat recovery zone. This mass transfer de-pressurizes the lower reactors while pressurizing the top reactors as desired. Such ‘Pressure Recovery’ by a series of pressure equalization steps between reactors is also sometimes employed in pressure-swing adsorption processes. Gas flow in the present system may be quite different, though, because it involves sub-atmospheric pressures.

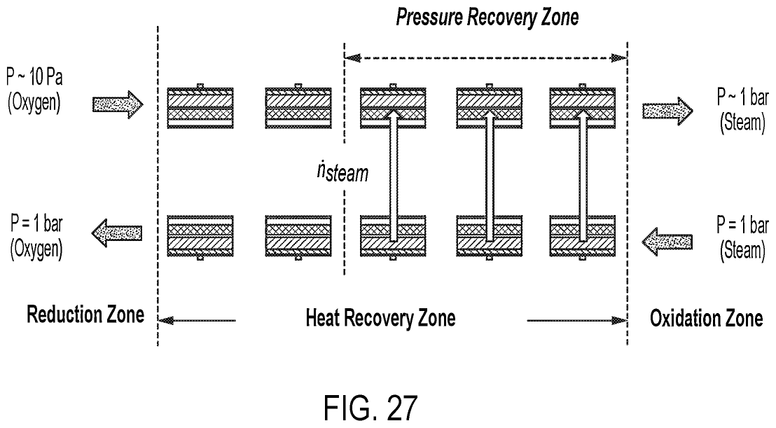

In accordance with one embodiment, FIG. 27 shows a pressure recovery process in the heat recovery zone of a reactor train. Steam (vertical arrows) flowed from high-pressure reactors in the bottom to the low-pressure reactors on top, equilibrating their pressures. As the temperature of the bottom row of reactors increased during heat recovery zone, they started evolving oxygen. It may be undesirable to allow this oxygen to flow into the top row of reactors where it would oxidize the reduced ceria. Such oxygen crossover may significantly reduce the cycle efficiency. Fortunately, ceria releases non-trivial amounts of oxygen only at temperatures above 1200° C. Thus, in accordance with some embodiments, pressure recovery may be executed in the low-temperature sub-section of the heat recovery zone (the 3 rightmost reactor pairs in FIG. 27). In this low-temperature segment the bottom reactors only contain steam, which is transported to the top reactors during pressure recovery. With pressure recovery, work input to pump steam out of reactors after oxidation was ignored in the present illustrative analysis.

In one embodiment, reactors in the high temperature segment of the heat recovery zone (the 2 leftmost reactor pairs in FIG. 27) are sealed. Reactors in the bottom can continue to be heated as they traverse this region, and the ceria in them can began to evolve oxygen. For the reactor geometry considered, the head space in reactors was small enough so that the evolved oxygen pressurized them beyond 1 bar when heated up to 1500° C. These reactors may be vented to 1 bar pressure without work input, and the oxygen may be collected in a manifold. Reactors entering the reduction zone on the bottom left were considered to be at 1 bar and filled with oxygen with a negligible amount of remnant steam.

In one embodiment, vacuum pumps may be used to reduce oxygen partial pressure during the reduction of ceria. For reduction pressures below 100 Pa, multi-stage pumping systems can offer much higher efficiencies than single-stage pumping. All vacuum pump and compressor efficiencies mentioned in this embodiment are Second Law efficiencies, e.g., compared to an ideal isothermal device.

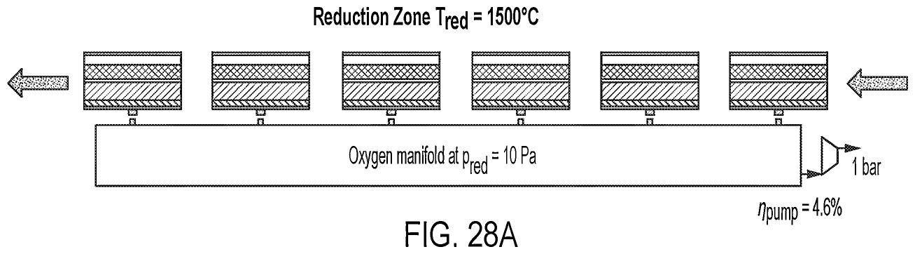

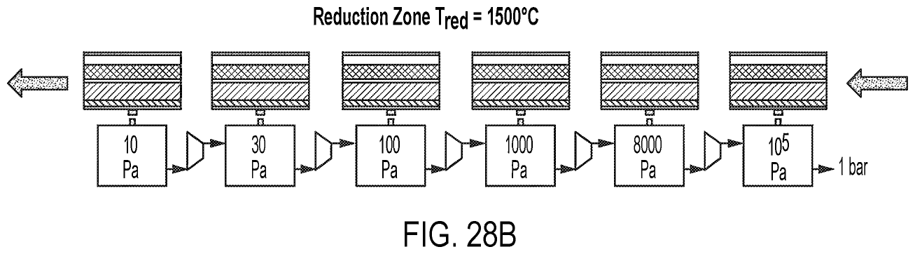

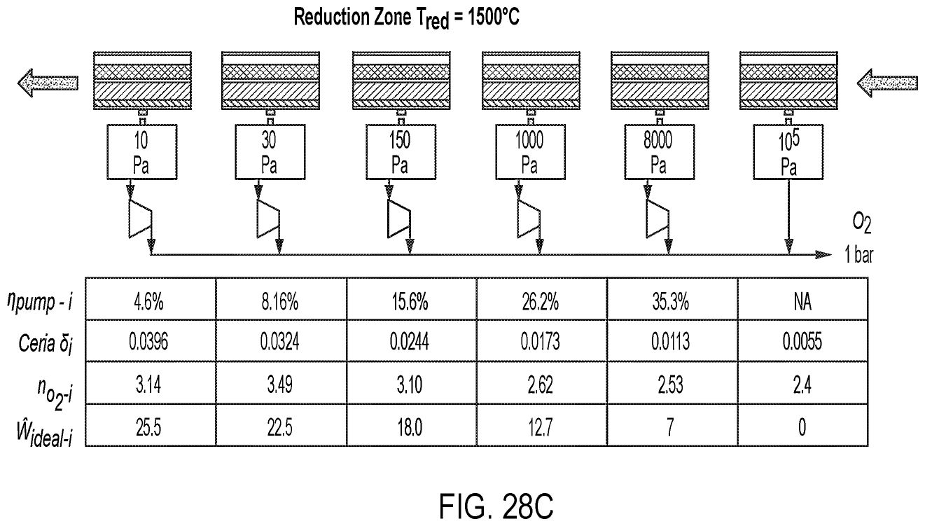

In one embodiment, one method to reduce vacuum pumping work is to employ a pressure cascade whereby the pressure of a ceria reactor is reduced in stages. This is shown schematically for the illustrative RTS in FIGS. 28A-28C, where ceria reactors move through the reduction zone from right to left. FIG. 28A shows a single-manifold scheme whereby reactors are connected to a gas manifold that is maintained at the target reduction pressure (p_{red}=10 Pa in FIG. 28) by a vacuum pump, according to some embodiments. Despite the simplicity of this scheme, the use of a single manifold can result in large and avoidable energy penalties. Ceria and other non-stoichiometric redox materials can evolve oxygen continuously as the oxygen partial pressure is reduced. Collecting oxygen in a manifold maintained at the lowest pressure can result in thermodynamic irreversibility. More importantly, all the pumping work can be done at the lowest pressure (here 10 Pa), where ηₚᵤₘₚ is the lowest.

In some embodiments, the pressure cascade scheme shown in FIG. 28B and FIG. 28C can result in improvements. In these figures the trapeziums do not necessarily depict a single vacuum pump, but an improved system of multiple pumps operating in series and parallel. Because of this, the system in FIG. 28C can be viewed as a re-organization of pumps from FIG. 28B, and both are equivalent from an efficiency stand-point. In system FIG. 28B the flowrates of oxygen added up as one went from left to right and the pressure increases in stages. In FIG. 28C each flowstream was separate, but it went through the same staged pressure increase because of the use of a multi-staged pumping system. While FIG. 28B is simpler and is more likely to be used in practice, reported efficiency values are for vacuum pumping systems that compress oxygen up to 1 bar. Thus, FIG. 28C was considered for modeling, while noting that the same results can be obtained with system FIG. 28B. In these schemes in FIGS. 28A-28C, the final reduction pressure was the same: p_{red}=10 Pa.

In one embodiment, with the pressure cascade (FIG. 28C), each reactor is connected to a separate gas manifold, and the pressure of these manifolds dropped successively as the reactor traveled from right to left in the figure. Each manifold can be maintained at its target pressure by its own vacuum pumping system. Because these pumps operated at different pressures, their efficiencies were different, as shown by the first row of the table in FIG. 28C. The table also shows the equilibrium non-stoichiometry of ceria (CeO_{2-δ}) at 1500° C. at each station, along with the moles of oxygen removed from the reactor at that station (n_{O}_{₂}₋ᵢ). It is noted that the incoming reactor at 1 bar and 1500° C. already had a non-stoichiometry of δ=0.0055, and the corresponding oxygen (2.4 moles per reactor) may be removed without the use of a vacuum pump.

In one embodiment, illustrated in FIG. 28C, a six-stage cascade with six manifolds maintained at different pressures is employed. These pressures were chosen to keep the amount of oxygen released at each station roughly the same, and a logarithmic reduction of pressure from right to left did not produce significantly different results. The last row of the table shows the ideal isothermal pumping work at each stage ‘I’ per mole of oxygen pumped. The effective 2^{nd} law efficiency of the cascade may then be calculated with Equation 15. For the system in FIG. 28C. η_{cascade}=8.2% (Second Law efficiency). Specific pumping work (Ŵ_{ideal-i}) and oxygen release (n_{O}_{₂}₋ᵢ) were higher at lower pressures, So η_{cascade} was weighed higher by the ηₚᵤₘₚ₋ᵢ at lower pressures. All quantities in the final expression in Equation 15 were defined in context to the table in FIG. 28C.

$${η}_{cascade} = \frac{{W}_{cascade - ideal}}{{W}_{cascade - actual}} = \frac{{Σ}_{i} {\hat{W}}_{ideal - i} {n}_{{O}_{2} - i}}{{Σ}_{i} \frac{{\hat{W}}_{ideal - i} {n}_{{O}_{2} - i}}{{η}_{pump - i}}} \qquad ( 15 )$$

While Equation 15 compares the pressure cascade to an ideal cascade, is perhaps more interesting to compare a cascade to a single-manifold system (e.g., FIG. 28A). This may be done with the factor f_{cascade} which is the ratio of total pumping work for the cascade (FIG. 28C) and the single-manifold (FIG. 28A) configurations. For the numbers considered in FIG. 28A and FIG. 28C, f_{cascade}=0.39. Thus, pumping work was reduced by 61% by switching from a single-manifold scheme to a six-stage cascade scheme. Recall that p_{red}=10 Pa is the lowest pressure reached during reduction in both schemes. Thus, Ŵ_{ideal-}_{_{pred}} IS the ideal pump work at p=p_{red}.

$${f}_{cascade} = \frac{{W}_{cascade - ideal}}{{W}_{single - pressure}} = \frac{{Σ}_{i} \frac{{\hat{W}}_{ideal - i} {n}_{{O}_{2} - i}}{{η}_{pump - i}}}{{Σ}_{i} \frac{{\hat{W}}_{ideal - {p}_{red}} {n}_{{O}_{2} - total}}{{η}_{pump - {p}_{red}}}} \qquad ( 16 )$$

In accordance with certain embodiments, as a limit, f_{cascade-∞} can be calculated for an infinite-manifold system with the definition in Equation 17. This may be derived by converting the summation in the numerator of Equation 16 to a continuous integration over ceria non-stoichiometry δ. Here p_{O}_{₂}(δ) is the equilibrium oxygen partial pressure over CeO_{2-δ} at 1500° C., and n_{CeO}_{₂}, is the number of moles of ceria in each reactor. δ₀ is the non-stoichiometry of ceria entering the reduction zone (δ₀=0.0055 in FIG. 28C). η_{cascade-∞} may be calculated in a similar manner by replacing W_{cascade} with W_{cascade-∞}.

$${f}_{cascade - ∞} = \frac{{W}_{cascade - actual - ∞}}{{W}_{single - pressure}} = \frac{\frac{{n}_{{CeO}_{2}}}{2} {\int }_{{δ}_{0}}^{δ ( {p}_{red} )} \frac{{\hat{W}}_{ideal} ( {p}_{{O}_{2}} ( δ ) )}{{η}_{pump} ( {p}_{{O}_{2}} ( δ ) )} d δ}{\frac{{\hat{W}}_{ideal - {p}_{red}} {n}_{{O}_{2} - total}}{{η}_{pump - {p}_{red}}}} \qquad ( 17 )$$

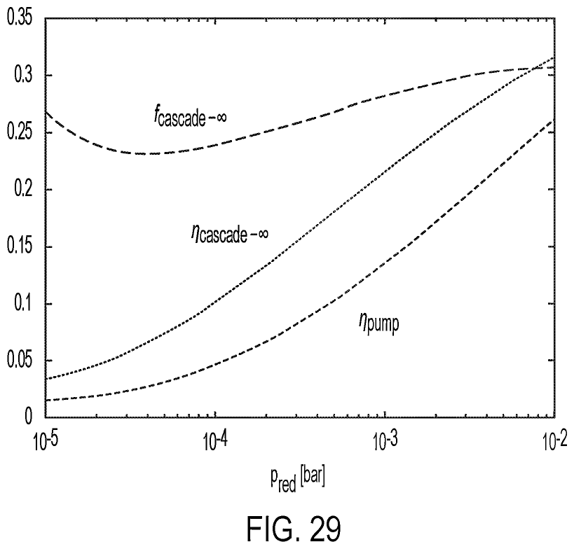

In accordance with certain embodiments, FIG. 29 shows the quantities ηₚᵤₘₚ (data reported by Brendelberger et al. [M56]) η_{cascade-∞} and f_{cascade-∞}. The horizontal axis is the final reduction pressure achieved: p_{red}. At pressures below 10 Pa the cascade was twice as efficient as a multi-stage pumping system (η_{cascade-∞} is twice ηₚᵤₘₚ). This is because ceria evolved oxygen over the entire pressure range. Perhaps more consequential is the ratio f_{cascade-∞}, and at p_{red}=10 Pa, f_{cascade-∞} was 0.25 (which is lower than f_{cascade}=0.39 with 6 manifolds). Thus, the infinite cascade system can result in a four-fold reduction of pumping work compared to the single manifold system. Apart from efficiency gains, the cascade system can also reduce pump capex because of the strong dependence of specific capex ($/mole-O₂/s flowrate) on pressure. Using data from Brendelberger et. al. [M56] it was found that the 6-manifold system reduces pump capex by a factor of 5 compared to the single-manifold system.

In one embodiment, in a cycle efficiency analysis, a cascade system with infinite manifolds was considered. In a practical system with finite number of manifolds, the pressure of each manifold can be improved to minimize the overall pumping work. In the infinite-manifold system, the final reduction pressure of the last manifold (p_{red}) can be the only pumping-related optimization variable. With multi-stage pump efficiency data and an infinite-stage pressure cascade, embodiments herein describe one of the highest performing vacuum pumping systems one may use with present-day, commercial vacuum pumping technology.

The Reactor Train systems presented in various of the embodiments described herein are believed to be the first physical embodiments of a reactor system that may execute a pressure cascade with several pressure stages without using complex, high-temperature pressure locks. Accordingly, in certain embodiments, no high-temperature pressure locks are employed in the system. High-temperature, in this context, refers to temperatures greater than 500° C.

While several perovskite compositions have been studied for thermochemical oxygen pumping (TcOP) and similar applications, in one embodiment, the current analysis was restricted to SrFcO₃ (SFO) which is a well-studied material with published thermodynamic and kinetics data. A TcOP system was considered where SFO was transported in reactors similar to the moving ceria reactors. It was assumed that there exists a mechanism to transfer heat to and from these reactors, and mechanisms to connect and disconnect reactors to gas exchange lines. This could facilitate establishing a connection between ceria reactors and SFO reactors to transport oxygen from ceria to SFO.

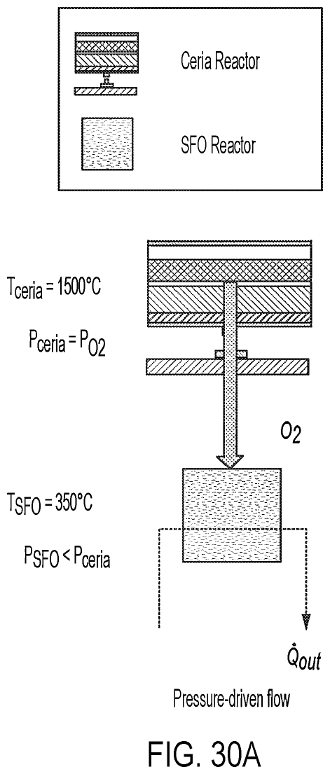

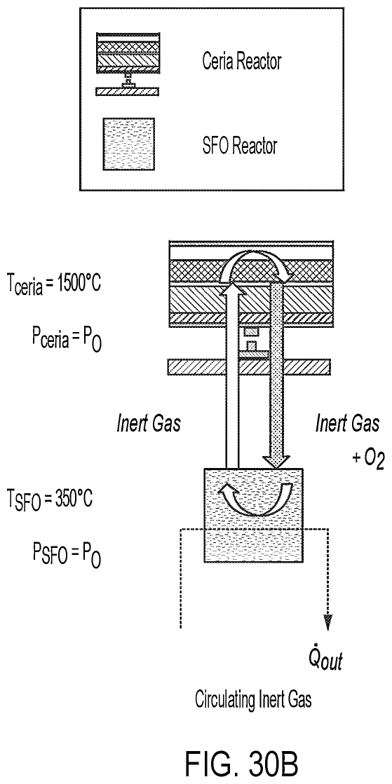

Oxygen flow between ceria and SFO reactors may be induced by a pressure difference between them. In some embodiments, while a ceria reactor is pressurized by the evolution of oxygen, the SFO reactor it is connected to absorbs oxygen, lowering the oxygen pressure and creating a pressure gradient. If oxygen is the dominant species in the gas phase, the oxygen partial pressure gradient can result in a total pressure gradient, inducing flow of oxygen from ceria to SFO reactors. This is shown schematically, e.g., in FIG. 30A. It is noted that leakage of an inert gas into the reactors can equilibrate the total pressure between reactors and stop oxygen flow. As oxygen cools down from the ceria reactor temperature (1500° C.) to the SFO pumping temperature (˜350° C.), its sensible heat may not be recovered, in which case it is assumed to be lost.

An alternative scheme of oxygen transport can be to circulate an inert gas between the ceria and SFO reactors. This is shown schematically, e.g., in FIG. 30B. The gas loop may be maintained at an intermediate pressure pₒ that is higher than the target oxygen partial pressure in the ceria reactor, thus reducing the risk of surrounding gases leaking in. A downside of this scheme can be imperfect heat recovery between the ceria and SFO reactors which operate at very different temperatures (1500° C. and 350° C. respectively). This scheme may also require a blower that drives the flow of inert gas in the loop. The present analysis assumed successful implementation of the pressure-driven flow scheme (FIG. 30A).

In one embodiment, the ceria and SFO reactors are configured to move in a counterflow, thus minimizing the thermodynamic irreversibility of oxygen exchange between them. Consider, e.g., the schematic in FIG. 31, where the non-stoichiometry of ceria is denoted by δ (CeO_{2-δ}) and that of SFO is denoted by γ (SrFeO_{3-γ}). In certain embodiments of the counterflow scheme, the reduced (or regenerated) SFO at γ_{red} is brought into gas-phase contact with the most reduced ceria (δ_{red}). SFO reactors are oxidized as they move counter-clockwise in FIG. 31, finally coming in gas-phase contact with the oxidized ceria (δₒₓ) coming in from the heat recovery zone. This can be thought of as being similar to the use of a counterflow inert gas sweep to remove oxygen generated by ceria, and can analogously be advantageous compared to a co-flow configuration. A counterflow arrangement was possible, for example, because the RTS was modular with multiple sealed, moving reactors that may be readily connected and disconnected.

Oxidized SFO reactors can be heated up to regenerate SFO by thermal reduction. This is similar to the thermal reduction of ceria, but at a much lower temperature. Heat for regeneration can be supplied by the waste heat recovered in the oxidation zone of the ceria train. For this analysis, the regeneration temperature was considered to be T_{regen}=Tₒₓ−50° C. to account for the temperature drop during heat transfer. The thermodynamics of SFO can facilitate the oxygen evolved during regeneration to be swept away by air (p_{O2}=0.21 bar). However, in some embodiments, the air is to be pre-heated up to T_{regen} and only a portion of that heat may be recovered with a practical recuperator. Moreover, the evolved oxygen can be lost in this case while the vacuum pumping system produces pure oxygen. In this illustrative analysis was considered a vacuum pump operating at rough vacuum to remove the evolved oxygen.

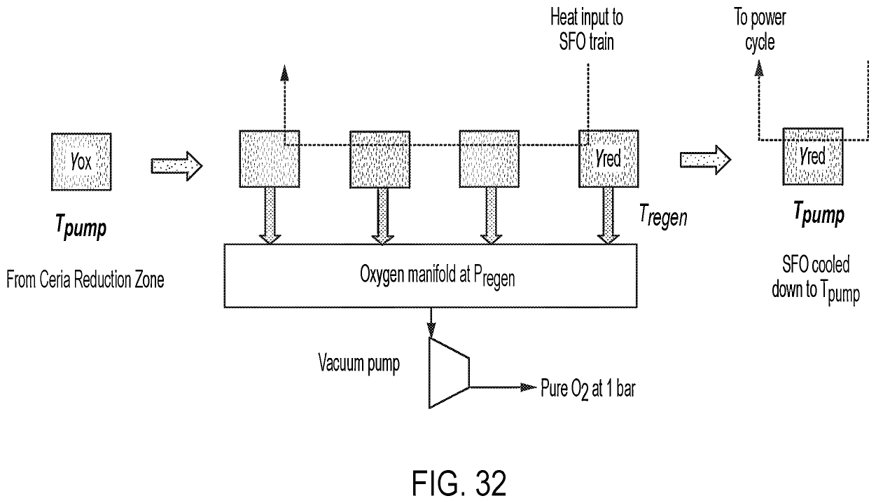

A regeneration vacuum system, e.g., is shown schematically in FIG. 32. In one embodiment, after oxygen exchange with the ceria reactors, oxidized SFO at Tₚᵤₘₚ enters the regeneration section from the left. In this section the SFO is heated up to T_{regen} (typically 700-800° C.) using the waste heat recovered in the oxidation zone. The heat input goes into raising the temperature of SFO as well as driving the endothermic SFO-reduction reaction. Simultaneously, the SFO reactors are connected to an oxygen manifold maintained at p_{regen} (<1 bar) by a vacuum pump. This produces pure oxygen at 1 bar, similar to a vacuum pumping system. It is noted that p_{regen} is set to be much higher than the oxygen partial pressure during ceria reduction (p_{red}), which makes this pumping system much more efficient and cheaper than a VP scheme considered elsewhere herein. A pressure cascade was not considered for achieving p_{regen} because it is a relatively small energy expenditure. SFO left the regeneration section at T_{regen} and in the reduced form (γ_{red}).

In one embodiment, after regeneration the SFO reactor is cooled down to Tₚᵤₘₚ before it starts pumping oxygen from ceria. Heat recovered in this SFO cool-down step can be used to operate an intermediate-temperature power cycle. Of the total sensible heat available in the SFO reactors, 70% was assumed to be recovered and delivered to the power cycle. The intermediate-temperature power cycle converted this heat to electricity at a 40% heat-to-electricity efficiency. As SFO is oxidized in the ceria reduction zone (FIG. 31), the exothermic heat of reaction at Tₚᵤₘₚ can be used to raise make-up steam for ceria oxidation (its enthalpy of vaporization). It was found that all the make-up steam may be produced in this manner in the improved system.

In one embodiment, the SFO pumping temperature (Tₚᵤₘₚ) can be a variable that is modified with a lower bound of 350° C., where SFO oxidation kinetics are reported to be sufficiently fast. The regeneration oxygen manifold pressure (p_{regen}) can also be a variable that is modified, with a lower bound of 0.05 bar. This can help to ensure that the corresponding vacuum pump has a high efficiency and low capex. Finally, the lowest oxygen partial pressure reached in the ceria reduction zone (p_{red} corresponding to δ_{red} at 1500° C.) can also be a variable that is adjusted. Alternatively, the ratio of molar flowrates of SFO and ceria (\dot{n}_{SFO}/\dot{n}_{ceria}) could be used as a variable that is modified, for example, in place of p_{red}. However, using p_{red} can facilitate explicitly setting a lower bound for it. Here the lower bound for p_{red} was considered to be 0.1 Pa. Vacuum Induction Melting is an example of a large-scale, high-temperature (T˜1500° C.) system using vacuum pressures of the order of 0.1 Pa. Thus, in the analysis presented herein, the RTS+TcOP had five modified variables: Tₒₓ, δₒₓ. p_{red}, and two new ones in Tₚᵤₘₚ and p_{regen}.

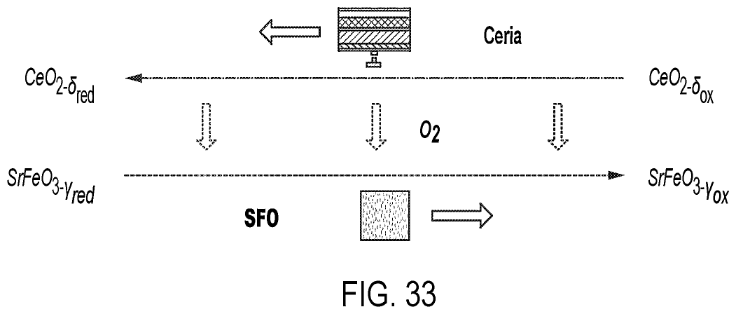

In the analysis presented herein, oxygen exchange between ceria and the SFO reactors is modeled using a method having similar principles as the one presented by Li et. al. [M57] for a counterflow of redox particles and an inert sweep gas. In some embodiments, two continuous counterflowing streams of ceria and SFO with oxygen exchange between them are employed, as shown in FIG. 33. FIG. 10 represents an illustrative case with an infinite number of ceria-SFO reactor pairs in the reduction zone. Ceria and SFO non-stoichiometries obey mass conservation of oxygen in this analysis. Moreover, the flow of oxygen from ceria to SFO can be spontaneous at each point along these streams. This is formalized in the equations below. Equation 18 enforces mass conservation of oxygen, and Equation 19 ensures spontaneity. Equation 19 may also be stated in terms of equilibrium oxygen partial pressures: oxygen partial pressure in the ceria reactor was to be greater than that in the SFO reactor, e.g., p_{O}_{₂}_{-eqm-ceria}(δ, T_{red})>p_{O}_{₂}_{-eqm-SFO} (γ, Tₚᵤₘₚ). \dot{n}_{χ} is the molar flowrate of species X. This pressure difference can drive the flow of oxygen from the ceria reactor to the SFO reactor. Equation 18 and Equation 19 can be derived as follows:

$$\begin{matrix}{\dot{n}}_{CeO 2} [ δ - {δ}_{ox} ] = {\dot{n}}_{SrFeO 3} [ γ - {γ}_{ox} ] & ( 18 ) \\ γ > {γ}_{equilib} ( δ ) & ( 19 )\end{matrix}$$

The illustrative model in FIG. 33 assumed that ceria reduction and SFO oxidation reactions were fast as long as there was a positive thermodynamic driving force for them. Similarly, the flow of oxygen from ceria to SFO reactors was assumed to be fast as long as there was a pressure difference driving the flow. The total reduction time for ceria in this illustrative RTS was 15 minutes, which is much longer than reported timescales for both reactions. A further assumption in this model was that the ceria stream was at 1500° C. throughout the oxygen exchange. The temperature of ceria reactors entering the reduction zone was expected to be below 1500° C. (it was about 1325° C. with 75% solid heat recovery). However, it rose rapidly in the reduction zone because of fast radiative heat transfer at 1500° C.

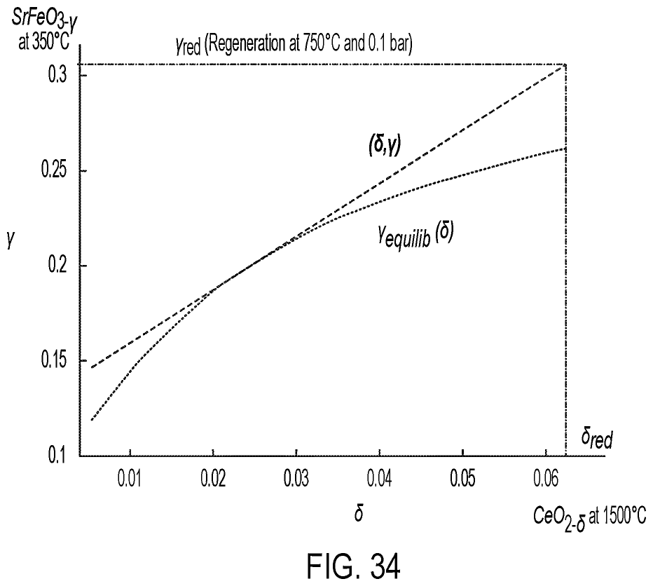

Equations 18 and 19 can be satisfied simultaneously by any realized δ and γ profiles in the counterflow of FIG. 33. This may be solved graphically for the case of ceria particles with counterflowing inert gas sweep. A novelty of this analysis is that the inert gas sweep was replaced with a pumping material that has its own redox thermodynamics. This was done by eliminating the p_{O}_{₂} variable between δ (T_{red}, p_{O}_{₂}) and γ(Tₚᵤₘₚ, p_{O}_{₂}) and working directly in the δ-γ plane as shown in FIG. 34.

The δ and γ profiles realizable in a counterflow may be identified and plotted as shown in FIG. 34, in some embodiments. The dashed curve is the locus of points where ceria at T_{red}=1500° C. had the same oxygen partial pressure as SFO at Tₚᵤₘₚ=350° C. (γ=γ_{equilib} (δ) in Equation 19). The region above this curve satisfies the spontaneity condition from Equation 19. From the mass conservation equation (Equation 18) the locus of realized (δ, γ) points can be a straight line with positive slope, with the magnitude of slope being dependent on molar flowrates of ceria and SFO. This line is to lie above the dashed equilibrium curve to also satisfy Equation 19. The solid line in FIG. 34 represents one such possible trajectory of the oxygen exchange process. SFO regeneration conditions (T_{regen} and p_{regen}) can determine γ_{red}. For a given γ_{red} and given flowrates of ceria and SFO, the extent of reduction of ceria (δ_{red}) can be maximized when the solid line is tangential to the dashed equilibrium curve.

In one embodiment, heat-to-hydrogen conversion efficiency of the RTS is defined as the ratio of HHV of hydrogen produced to the net heat input from the TES at 1500° C. The system considered for enhancement had compressed hydrogen as the only energy output and heat at 1500° C. as the only input. Water was fed to the system as a liquid at room temperature, and pure oxygen at 1 bar was a byproduct. A system-level model was built in MATLAB using submodels described herein. The Nelder-Mead algorithm [M58] was used to enhance efficiency by varying the parameters of each RTS configuration as described herein.

As mentioned previously, the extent of oxidation of ceria (δₒₓ) was a variable that was varied in one embodiment. In the actual implementation the extent of oxidation (α) could be equivalently considered as a variable to be modified. Here, in this analysis, α=1 implies complete oxidation (δₒₓ=0), but this may result in excessive amounts of unconverted steam and may be sub-optimal.

$$α = \frac{{δ}_{red} - {δ}_{ox}}{{δ}_{red}} \qquad ( 20 )$$

In one embodiment, the improved RTS system with vacuum pumping achieved a heat-to-fuel efficiency of 31.2% on a higher heating value basis. The varied parameters were: T_{oxd}=896.4° C. p_{red}=4.32 Pa, and complete oxidation (α>0.9999). This resulted in a reduction extent of ceria δ_{red}=0.0466, corresponding to 0.542 g of H₂ produced per kilogram of ceria in one cycle, or 117 kg H₂ produced by one reactor train in one day.

In one embodiment, for every one mole of hydrogen produced (HHV=286 KJ/mole) the vacuum pumping work was 112.3 kJ. With the 40% efficient intermediate-temperature power cycle used in this analysis, this corresponded to 280.7 kJ of heat that went into oxygen removal. Hydrogen separation and compression each took up about 43 kJ electric work input. In an improved cycle, all of the electricity produced was used up by auxiliary processes (vacuum pumping, hydrogen separation and hydrogen compression).

Although vacuum pumping is a mature technology, future breakthroughs could lead to higher efficiencies. Considered in one embodiment was a hypothetical ‘High Pump Efficiency’ (HPE) case, whereby ηₚᵤₘₚ wax increased by a factor of 2 compared to the base case values, with a cap of 50% efficiency—e.g., η_{pump-HPE}=max (2×ηₚᵤₘₚ, 0.5). The heat-to-fuel efficiency of the improved HPE system was 33.94%. More efficient pumps can drive the system to lower optimal reduction pressures, e.g.: p_{red}=1.85 Pa. This can increase ceria non-stoichiometry to δ_{red}=0.0551, which can increase hydrogen productivity of the reactor train by 18% over the base vacuum pumping case.

Apart from the low efficiency of vacuum pumps, their high capex can also be a concern, especially at low p_{red}. Thus, while p_{red}=4.32 Pa gave the maximum efficiency with the base RTA+VP system, this may not be the technoeconomic most favorable outcome, e.g., when the price of H₂ is minimized. In fact, Falter et. al. reported a technoeconomic best p_{red} of 1.1 kPa for their solar thermochemical system. In certain embodiments of this RTS+VP system herein, when the base case was modified by setting a lower bound of 1 kPa (=1000 Pa) for p_{red}, the best cycle efficiency dropped from 31.2% to 20.4%. Simultaneously, hydrogen productivity (kg-H₂/day/train) was reduced by more than 60% compared to the base case.

In one embodiment, average steam-to-hydrogen conversion in the best base system was 25%, resulting in an oxidizer-to-fuel ratio of \dot{n}H₂O/\dot{n}_{H}_{₂}=4. This is much lower than the ratio at which the performance of alternative water-splitting materials (like perovskites) is reported, which is typically above 100. Realistic accounting of steam-hydrogen separation work can render redox materials with low steam-to-hydrogen conversion unattractive. Similarly, analyses of isothermal and near-isothermal water-splitting cycles can consider the steam-hydrogen or CO₂—CO separation work for more realistic results. When steam and hydrogen are separated by condensing water, the heat rejected by condensing steam may not be used for boil water (both happen at the same temperature) and is typically lost. Thus, high steam-to-hydrogen ratio may carry a separation work penalty.

One embodiment of an improved RTS system with thermochemical oxygen pumping achieved a heat-to-fuel efficiency of 40.81% on a higher heating value basis. The varied parameters were: T_{oxd}=853.0° C. p_{red}=0.23 Pa, and almost complete oxidation (α>0.9987). TcOP thus gave a 10%-point efficiency boost over RTS+VP in this embodiment. Perhaps more importantly, the improved cycle had a reduction extent of ceria dred=0.0809. corresponding to 203 kg H₂ produced by one reactor train in one day which is a 73.5% increase over the RTS+VP base case. Since cycle time was kept constant, the H₂-productivity of the system was directly proportional to dred. The increased productivity directly reduced the capex associated with ceria and reactors.

In one embodiment, for every one mole of hydrogen produced the improved RTS+TcOP system produced 388 kJ of waste heat in the ceria oxidation zone. All of this was fed to the TcOP system directly as heat at the SFO regeneration temperature of T_{regen}=T_{oxd}−50° C.=803° C. The improved regeneration pressure was p_{regen}=0.05 bar. The resulting non-stoichiometry of regenerated SFO was γ_{red}=0.3398. The improved SFO pumping temperature was Tₚᵤₘₚ=376.1° C. resulting in oxidized SFO non-stoichiometry of Yoxd=0.1690. The corresponding mass flowrate ratio of SFO and ceria in the reduction zone was \dot{m}_{SFO}/\dot{m}_{ceria}=0.49.

In one embodiment, of the 388 KJ of intermediate-temperature heat supplied to the TcOP system, 220 kJ is recovered as SFO cooled down from T_{regen} to Tₚᵤₘₚ (representing 70% of the available sensible heat between these temperatures). This produces 88 kJ of electricity, half of which was used to compress hydrogen up to 100 bar. An oxygen vacuum pump that maintained p_{regen}=0.05 bar consumed only 12.2 kJ electricity. This is much lower than the 112.3 kJ electricity used by vacuum pumps in the RTS+VP system.

In one embodiment, once heat is recovered for the power cycle, low-temperature heat at Tₚᵤₘₚ is used to raise make-up steam for water-splitting, which may require 40.5 kJ per mole of H₂ produced. This low-T heat consisted of unrecovered sensible heat of SFO as well as the exothermic heat of SFO oxidation. The remainder of the 388 kJ energy supplied to TcOP is assumed to be lost: Q_{loss-TcOP}=128 KJ/mole-H₂. The net thermal energy used for oxygen removal in the RTS+TcOP system was Q_{loss-TcOP} plus the heat-equivalent of electricity used by the oxygen vacuum pump to maintain p_{regen}. This came out to be 158.5 kJ per mole of hydrogen, 44% lower than the RTS+VP system.

$${Q}_{{O}_{2} removed by TcOP} = {Q}_{loss - TcOP} + \frac{{W}_{{p}_{regen}}}{{η}_{power - cycle}} = 158 kJ / mol \qquad ( 21 )$$

In one embodiment, the optimal p_{red} in RTS+TcOP was quite low: 0.23 Pa. There may be concerns of gas leakage into reactors at this pressure. Additionally, the absolute pressure difference between ceria and SFO reactors may be too low to drive the flow of oxygen (FIG. 30A). To gauge the dependence of cycle efficiency on p_{red}, the lower bound on p_{red} was raised to 1 Pa and the optimization routine was reapplied. The improved cycle efficiency in this ‘High p_{red}’ case was 37.52%, with the improved reduction conditions being p_{red}=1 Pa resulting in δ_{red}=0.0623. This is still higher than the RTS+VP efficiency in the high pump efficiency (HPE) case. It does highlight, however, that significant efficiency and productivity gains may be achieved be going to sub-1 Pa reduction pressure.

The high reduction temperature of thermochemical water-splitting cycles can make the use of concentrated solar energy challenging. This may be because of, at least, material constraints of the solar receiver, as well as the high optical concentration ratios to keep re-radiation losses reasonably low. High T_{red} can also limit the choices of thermal energy storage materials, especially phase-change materials like silicon alloys and iron which have melting points close to or below 1500° C. Thus, it may be beneficial to lower T_{red} if possible without significantly reducing hydrogen production efficiency and productivity.

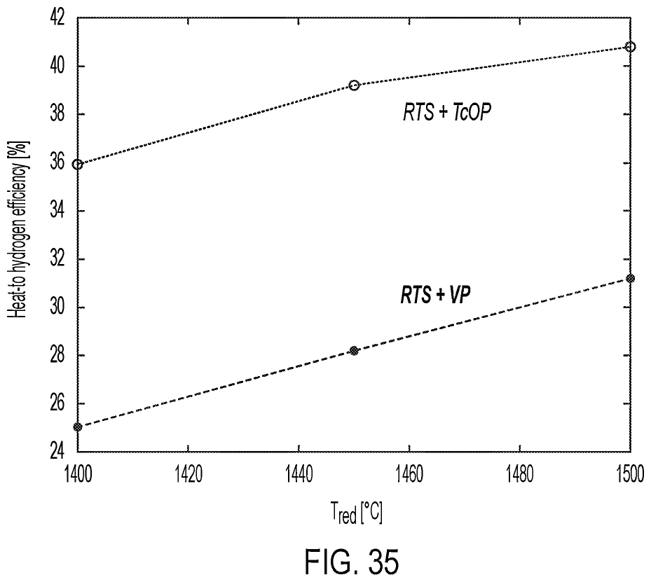

In FIG. 35 is shown the effect of lowering T_{red} on the improved system efficiency of both VP and TcOP systems, according to some embodiments. The efficiency of RTS+VP dropped linearly with T_{red}, dropping by 6.2%-points when T_{red} is reduced from 1500° C. to 1400° C. The efficiency of RTS+TcOP dropped by only 4.9%-points in the same T_{red} range. Moreover, the drop between 1500° C. to 1450° C. was only 1.6%-points. Thus, in these embodiments, the RTS+TcOP system was better able to adapt to lower reduction temperatures than vacuum pumping. Lower T_{red} can lead to lower hydrogen production (lower δ) which reduces efficiency. Since TcOP may reach very low p_{red}, this may make up somewhat for the reduced T_{red}, and does not reduce as much. This can offset some of the loss of efficiency.

In one embodiment, this 50° C. difference may have a big impact on the options available for high temperature heat collection and storage. For example, it may facilitate the use of concentrated solar heat which may be cheaper than converting renewable electricity to heat. It may also facilitate the use of iron-based phase change materials (iron melts at 1538° C.) for thermal energy storage.

In some embodiments herein, different designs were proposed for oxygen removal from the RTS reactors, and system efficiency models were used for improving the heat-to-hydrogen conversion efficiency of the system. Certain embodiments herein of RTS recover heat internally between reduction and oxidation and provide a way to harvest intermediate-temperature waste heat. When vacuum pumps are used for oxygen removal in the reduction zone, the RTS may incorporate a pressure cascade that reduces pumping work by up to a factor of four, and reduces pump capex by a factor of five. This can facilitate the RTS+VP system to achieve, e.g., 31% efficiency (HHV of H₂ basis). Certain embodiments of this model accurately account for the work of separating steam and hydrogen after oxidation, and include the compression of hydrogen to 100 bar.

As an alternative to vacuum pumps, thermochemical oxygen pumping (TcOP) using strontium iron oxide perovskite (SFO) were considered herein. Using TOP in the RTS can be particularly attractive because TcOP may use intermediate-temperature “waste heat” from the oxidation step directly instead of first converting it to electricity as needed for vacuum pumps. A detailed thermodynamic model was built for the exchange of oxygen between counter-moving streams of ceria and SFO reactors. In certain embodiments, the improved RTS+TcOP system had 40.8% heat-to-hydrogen efficiency. It is believed that this is, by far, the highest reported thermochemical heat-to-hydrogen efficiency using tested and proven materials.

In certain embodiments, the improved RTS+TcOP system used 44% less thermal energy than vacuum pumping, and produced lower oxygen partial pressure during reduction, leading to deeper reduction of ceria. Along with increasing system efficiency by 10%-points compared to the vacuum pumping option, certain embodiments of TcOP also increased hydrogen productivity of the RTS by a factor of two—from 117 kg-H₂/train/day to 203 kg-H₂/train/day. This can significantly reduce the use of ceria and lower the physical footprint of the plant along with the capex of reactors.

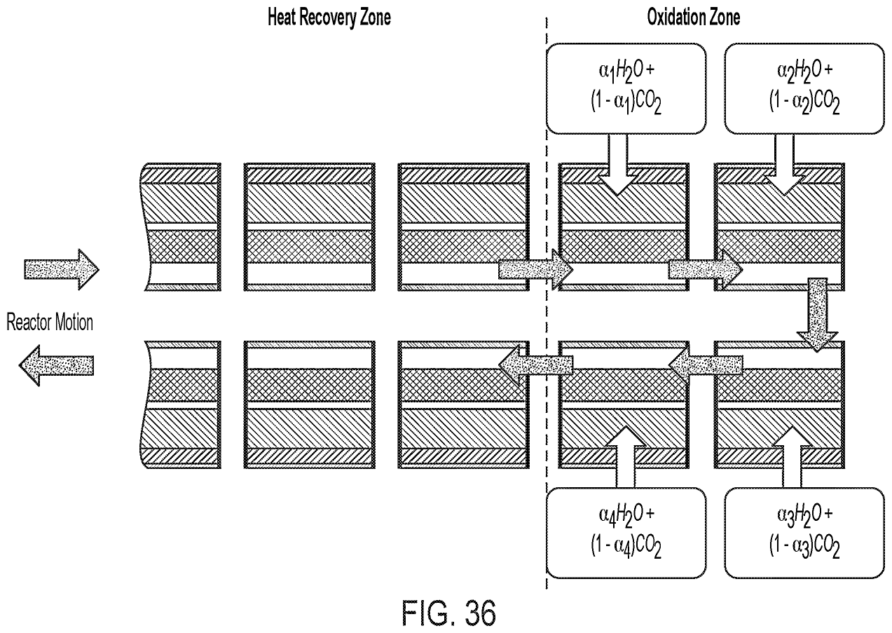

FIG. 36 illustrates a reactor train involving splitting or co-splitting of water and/or carbon dioxide, which produces hydrogen and/or carbon monoxide respectively, in some cases co-occurring within the same reactor, according to some embodiments. An exemplary oxidation reaction of redox material (CeO₂) with water and/or carbon dioxide is illustrated by Equation 22:

$$α {H}_{2} O + ( 1 - α ) {CO}_{2} + \frac{1}{δ} {CeO}_{2 - δ} \to α {H}_{2} + ( 1 - α ) CO + \frac{1}{δ} {CeO}_{2} \qquad ( 22 )$$

in which ‘α’ refers to the fraction of water being split and can be from 0 to 1 (i.e., 0≤α≤1). In Equation 22, when α=0, only CO₂-splitting is being performed. Also in Equation 22, when α=1, only water-splitting is being performed. When 0<α<₁, both CO2-splitting and water-splitting are being performed (also referred to herein as “co-splitting”). In some embodiments, a water-carbon dioxide mixture is injected into one or more reactors during oxidation. The ratio might vary from reactor to reactor as shown in FIG. 36 (α₁-α₄). For example, in some embodiments, α₁<α₂<α₃<α₄, or α₄<α₃<α₂<α₁.

The following outlines non-limiting embodiments of the present disclosure.

Embodiment 1 relates to a system of heat exchange comprising two reactors R1 and R2 and three reaction zones, a high-temperature zone (HT), a low temperature zone (LT), and a heat exchange zone (Recuperation), wherein the lengths of R1 and R2 are much longer than the radiative gap between them in the Recuperation zone; and wherein the system cycles through four successive steps consisting of (a) R1 in LT and R2 in HT; (b) R1 and R2 adjacent in Recuperation; (c) R2 in LT and R1 in HT; and (d) R1 and R2 adjacent in Recuperation; wherein following step d, the system returns to step a.

In some embodiments of Embodiment 1, R1 or R2 or both consists of active redox material and optional inert or participating materials (Embodiment 2).

In some embodiments of Embodiment 2, the redox material is enclosed in a casing that is sealed and/or insulated (Embodiment 3).

In some embodiments of Embodiments 1-3, individual reactors operate at atmospheric pressure, sub-atmospheric pressure or vacuum, or higher than atmospheric pressure (Embodiment 4).

In some embodiments of Embodiments 1-4, R1 or R2 or both comprises pressure and flow control devices (Embodiment 5).

In some embodiments of Embodiments 1-5, R1 or R2 or both comprises vacuum pumps, valves, and/or switches included within its structure (Embodiment 6).

In some embodiments of Embodiments 1-6, the reactor casing of R1 or R2 or both comprises one or more windows or other external surfaces for radiative heat exchange with its surroundings (Embodiment 7).

In some embodiments of Embodiments 1-7, R1 or R2 or both comprises ports for exchanging chemical species with its surroundings in the LT and HT zones (Embodiment 8).

In some embodiments of Embodiments 1-8, R1 or R2 or both comprises features to enhance heat and mass flow within itself and across its boundaries to exchange heat via radiation with the reactor facing it while moving through the Recuperation Zone (Embodiment 9).

In some embodiments of Embodiments 1-9, R1 or R2 or both exchanges charge or electric current with its environment (Embodiment 10).

In some embodiments of Embodiments 1-10, the speed of R1 and R2 as they move past each other in the Recuperation zone is configured for a quick transition and an efficient heat exchange (Embodiment 11).

In some embodiments of Embodiments 1-11, the system comprises a reactor train made of identical reactors linked to each other using flexible hinges such that they can circle in a loop while neighboring reactors do not communicate with each other thermally or exchange gases, and further comprising an external high temperature heat source, wherein the number of reactors in each of the three zones can be varied independently, and wherein the Recuperation zone acts as a counterflow heat exchanger between regions of the reactor train (Embodiment 12).

Embodiment 2.1 relates to a reactor system comprising (e.g., consisting of) two or more reactors such that: (A) reactors move with respect to one another during operation, wherein this movement may be cyclic, so that reactors return to their original position after a fixed period of time; (B) reactors undergo a cyclic operation during which at least one of the following changes with time within at least a portion of the reactor volume: temperature, total pressure, chemical composition, electric potential and electric charge; (C) reactors contain chemically active substance(s) (e.g., a redox material or catalyst) that remains in the reactor at all times during operation; and/or (D) reactors are self-contained in that they have thermal insulation and means for heat and mass transfer with their surroundings and/or with other reactors.

In some embodiments of Embodiment 2.1, reactors have surfaces that facilitate radiative heat transfer with surroundings. This can be windows made of sapphire or other ceramics that are semi-transparent at infrared wavelengths. It may also be opaque, absorptive surfaces like SiC, graphite, etc. (Embodiment 2.2)

In some embodiments of Embodiment 2.1 or Embodiment 2.2, the chemically active substance can be porous to facilitate volumetric absorption and emission of radiation. (e.g., reticulated porous ceramic, structured foams, mesh, honeycombs, particle bed, etc.). The chemically active substance can be shaped into one or more cavities for faster radiative heat transfer while also facilitating high mass loading. (Embodiment 2.3)

In some embodiments of Embodiment 2.1-2.3, reactors can be heated radiatively by concentrated solar irradiation, potentially assisted by mirrors and lightguides. Alternatively, a high-temperature heat source can be used, potentially coupled with thermal energy storage. (Embodiment 2.4)

In some embodiments of Embodiment 2.1-2.4, reactors can reject heat radiatively to a heat sink (e.g., a cooler surface) for waste heat recovery. (Embodiment 2.5)

In some embodiments of Embodiment 2.1-2.5, reactors can exchange heat radiatively with one another. This can be employed for internal heat recovery. (Embodiment 2.6)

In some embodiments of Embodiment 2.1-2.6, the system can have radiation shields to retain heat in reactors for longer periods of time, facilitating flexible operation. Radiation shields can also be used to modify the thermal output from the heat source. (Embodiment 2.7)

In some embodiments of Embodiment 2.1-2.7, reactors have non-radiative means of exchanging energy with their surroundings in the form of heat transfer media (solid particles, liquid, gas, combinations thereof), electric current, induction, etc. (Embodiment 2.8)

In some embodiments of Embodiment 2.1-2.8, reactors can have means of storing thermal energy internally in the form of sensible heat of active and inert components, or phase change materials. (Embodiment 2.9)

In some embodiments of Embodiment 2.1-2.9, reactors have mass transfer ports that can connect to corresponding mass transfer ports in the surroundings or on other reactors. (Embodiment 2.10)

In some embodiments of Embodiment 2.1-2.10, reactors have internal pipes/channels to transport mass from the mass transfer ports to the active material and back. Such internal channels can form a heat exchanger to pre-heat incoming material before it reaches the active material within the reactor. (Embodiment 2.11)

In some embodiments of Embodiment 2.1-2.11, mass transfer ports on reactors can be connected to ports on the surroundings during operation to flow mass for a fixed period of time. After this period the connection is severed. A Reactor can come to a complete stop before such a connection is made and while mass is actively being transported. After the connection is severed, the reactor can move onwards. Alternatively, a sliding contact between reactor and surroundings can facilitate mass transfer while reactors are still moving. (Embodiment 2.12)

In some embodiments of Embodiment 2.1-2.12, the reactor is connected to an external manifold whose pressure is different from that in the reactor. Manifolds may be connected to vacuum pumps to maintain them at a desired pressure. Manifolds may exchange mass between them. Such manifolds can be at different pressures. (Embodiment 2.13)

In some embodiments of Embodiment 2.1-2.13, mass transfer ports on two reactors can be connected. This can be used for equilibrating pressure in the two reactors, reducing the work required for creating vacuum. (Embodiment 2.14)

In some embodiments of Embodiment 2.1-2.14, the reactor may include mechanical pumping devices within its structure for varying the pressure of fluid phase in certain regions of the reactor. (Embodiment 2.15)

In some embodiments of Embodiment 2.1-2.15, reactors can contain electrochemical elements for gas separation within reactor. (e.g., oxygen separation from an inert gas, hydrogen-steam separation). (Embodiment 2.16.)

In some embodiments of Embodiment 2.1-2.16, the system contains more than one type of moving reactors, and reactors of different types can exchange mass and energy between them. This can be advantageously used for thermochemical oxygen pumping. (Embodiment 2.17.)

It should be understood that the subject matter defined in the appended claims is not necessarily limited to the specific implementations described above. The specific implementations described above are disclosed as examples only.

### BIBLIOGRAPHY

1. Lu, Y. et al. Solar fuels production: Two-step thermochemical cycles with cerium-based oxides. Prog. Energy Combust. Sci. 75, 100785 (2019).
2. Tuller, H. L. Solar to fuels conversion technologies: A perspective. Mater. Renew. Sustain. Energy 6, 1-16 (2017).
3. Zhu, X., Imtiaz, Q., Donat, F., Müller, C. R. & Li, F. Chemical looping beyond combustion—a perspective. Energy Environ. Sci. 772-804 (2020) doi: 10.1039/c9ee03793d.
4. Bayham, S. C., Tong, A., Kathe, M. & Fan, L. S. Chemical looping technology for energy and chemical production. Wiley Interdiscip. Rev. Energy Environ. 5, 216-241 (2016).
5. Lapp, J., Davidson, J. H. & Lipiński, W. Heat transfer analysis of a solid-solid heat recuperation system for solar-driven nonstoichiometric redox cycles. J. Sol. Energy Eng. Trans. ASME 135, (2013).
6. Diver, R. B., Miller, J. E., Allendorf, M. D., Siegel, N. P. & Hogan, R. E. Solar thermochemical water-splitting ferrite-cycle heat engines. Am. Sol. Energy Soc.-Sol. 2006 35th ASES Annu. Conf., 31st ASES Natl. Passiv. Sol. Conf., 1st ASES Policy Mark. Conf., ASME Sol. Energy Div. Int. Sol. Energy Conf. 3, 1184-1192 (2006).
7. Yuan, C., Jarrett, C., Chueh, W., Kawajiri, Y. & Henry, A. A new solar fuels reactor concept based on a liquid metal heat transfer fluid: Reactor design and efficiency estimation. Sol. Energy 122, 547-561 (2015).
8. Nakumura, T. Hydrogen Production From Water Utilizing. Sol. Energy 19, 467-475 (1977).
9. Säck, J. P. et al. High temperature hydrogen production: Design of a 750 KW demonstration plant for a two step thermochemical cycle. Sol. Energy 135, 232-241 (2016).
10. Marxer, D., Furler, P., Takacs, M. & Steinfeld, A. Solar thermochemical splitting of CO2 into separate streams of CO and O₂ with high selectivity, stability, conversion, and efficiency. Energy Environ. Sci. 10, 1142-1149 (2017).
11. Kodama, T., Bellan, S., Gokon, N. & Cho, H. S. Particle reactors for solar thermochemical processes. Sol. Energy 156, 113-132 (2017).
12. Lapp. J., Davidson, J. H. & Lipiński, W. Efficiency of two-step solar thermochemical non-stoichiometric redox cycles with heat recovery. Energy 37, 591-600 (2012).
13. Diver, R. B., Siegel, N. P., Miller, J. E. & Moss, T. A. Testing of a CR5 Solar Thermochemical Heat Engine Prototype. 1-8 (2010).
14. Ermanoski, I., Siegel, N. P. & Stechel, E. B. A new reactor concept for efficient solar thermochemical fuel production. J. Sol. Energy Eng. Trans. ASME 135, 1-10 (2013).
15. Herron, J. A., Kim, J., Upadhye, A. A., Huber, G. W. & Maravelias, C. T. A general framework for the assessment of solar fuel technologies. Energy Environ. Sci. 8, 126-157 (2015).
16. Marxer. D. et al. Demonstration of the entire production chain to renewable kerosene via solar thermochemical splitting of H₂O and CO₂. Energy and Fuels 29, 3241-3250 (2015).
M1. Grimm, A., de Jong, W. A., and Kramer, G. J., 2020, “Renewable Hydrogen Production: A Techno-Economic Comparison of Photoelectrochemical Cells and Photovoltaic-Electrolysis.” Int. J. Hydrogen Energy, 45 (43), pp. 22545-22555.
M2. Collodi, G., Azzaro, G., Ferrari, N., and Santos, S., 2017. “Techno-Economic Evaluation of Deploying CCS in SMR Based Merchant H2 Production with NG as Feedstock and Fuel,” Energy Procedia, 114 (November 2016), pp. 2690-2712.
M3. Miller, E. L., Thompson, S. T., Randolph, K., Hulvey, Z., Rustagi, N., and Satyapal, S., 2020, “US Department of Energy Hydrogen and Fuel Cell Technologies Perspectives,” MRS Bull., 45 (1), pp. 57-64.
M4. Falter, C., Valente, A., Habersetzer, A., Iribarren, D., and Dufour, J., 2020, “An Integrated Techno-Economic, Environmental and Social Assessment of the Solar Thermochemical Fuel Pathway,” Sustain. Energy Fuels.
M5. Moser, M., Pecchi, M., and Fend, T., 2019, “Techno-Economic Assessment of Solar Hydrogen Production by Means of Thermo-Chemical Cycles,” Energies, 12 (3).
M6. Marxer, D., Furler, P., Takacs, M., and Steinfeld, A., 2017, “Solar Thermochemical Splitting of CO2 into Separate Streams of CO and O2 with High Selectivity, Stability, Conversion, and Efficiency,” Energy Environ. Sci., 10 (5), pp. 1142-1149.
M7. Brendelberger, S., Holzemer-Zerhusen, P., Von Storch, H., and Sattler, C., 2019, “Performance Assessment of a Heat Recovery System for Monolithic Receiver-Reactors,” J. Sol. Energy Eng. Trans. ASME, 141 (2), pp. 1-9.
M8. Muhich, C. L., Blaser, S., Hoes, M. C., and Steinfeld, A., 2018, “Comparing the Solar-to-Fuel Energy Conversion Efficiency of Ceria and Perovskite Based Thermochemical Redox Cycles for Splitting H2O and CO2,” Int. J. Hydrogen Energy, 43 (41), pp. 18814-18831.
M9. Siegrist, S., Von Storch, H., Roeb, M., and Sattler, C., 2019, “Moving Brick Receiver-Reactor: A Solar Thermochemical Reactor and Process Design with a Solid-Solid Heat Exchanger and On-Demand Production of Hydrogen and/or Carbon Monoxide,” J. Sol. Energy Eng. Trans. ASME, 141 (2), pp. 1-9.
M10. Diver, R. B., Siegel, N. P., Miller, J. E., and Moss, T. A., 2010, “Testing of a CR5 Solar Thermochemical Heat Engine Prototype,” pp. 1-8.
M11. Richter, S., Brendelberger, S., Gersdorf, F., Oschmann, T., and Sattler, C., 2020, “Demonstration Reactor System for the Indirect Solar-Thermochemical Reduction of Redox Particles—The Particle Mix Reactor,” J. Energy Resour. Technol., 142 (5).
M12. Falter, C. P., Sizmann, A., and Pitz-Paal, R., 2015, “Modular Reactor Model for the Solar Thermochemical Production of Syngas Incorporating Counter-Flow Solid Heat Exchange.” Sol. Energy, 122, pp. 1296-1308.
M13. Falter, C. P., and Pitz-Paal, R., 2017, “A Generic Solar-Thermochemical Reactor Model with Internal Heat Diffusion for Counter-Flow Solid Heat Exchange.” Sol. Energy,
144, pp. 569-579.
M14. Siegrist, S., and von Storch, H., 2018, “DE102108201319A1.”
M15. von Storch, H., and Siegrist, S., 2018, “DE102018201317A1.”
M16. Holzemer-Zerhusen, P., Brendelberger, S., Roeb, M., and Sattler, C., 2020, “Oxygen Crossover in Solid-Solid Heat Exchangers for Solar Water and Carbon Dioxide Splitting: A Thermodynamic Analysis.” ASME 2020 14th Int. Conf. Energy Sustain. ES 2020, pp. 14-16.
M17. DeAngelis, F., Seyf, H. R., Berman, R., Schmidt, G., Moore, D., and Henry, A., 2018, “Design of a High Temperature (1350° C.) Solar Receiver Based on a Liquid Metal Heat Transfer Fluid: Sensitivity Analysis,” Sol. Energy, 164 (March), pp. 200-209.
M18. Hoskins, A. L., Millican, S. L., Czernik, C. E., Alshankiti, I., Netter, J. C., Wendelin, T. J., Musgrave, C. B., and Weimer, A. W., 2019, “Continuous On-Sun Solar Thermochemical Hydrogen Production via an Isothermal Redox Cycle,” Appl. Energy, 249 (May), pp. 368-376.
M19. Rowe, S. C., Hischier, I., Palumbo, A. W., Chubukov, B. A., Wallace, M. A., Viger, R., Lewandowski, A., Clough, D. E., and Weimer, A. W., 2018, “Nowcasting, predictive Control, and Feedback Control for Temperature Regulation in a Novel Hybrid Solar-Electric Reactor for Continuous Solar-Thermal Chemical Processing.” Sol. Energy, 174 (August), pp. 474-488.
M20. Ermanoski, I., Miller, J. E., and Allendorf, M. D., 2014, “Efficiency Maximization in Solar-Thermochemical Fuel Production: Challenging the Concept of Isothermal Water Splitting,” Phys. Chem. Chem. Phys., 16 (18), pp. 8418-8427.
M21. Bulfin, B., Lange, M., Oliveira, L. De, Roeb, M., and Sattler, C., 2016, “Solar Thermochemical Hydrogen Production Using Ceria Zirconia Solid Solutions: Efficiency Analysis,” Int. J. Hydrogen Energy, 41 (42), pp. 19320-19328.
M22. Ehrhart, B. D., Muhich, C. L., Al-Shankiti, I., and Weimer, A. W., 2016, “System Efficiency for Two-Step Metal Oxide Solar Thermochemical Hydrogen Production-Part 1: Thermodynamic Model and Impact of Oxidation Kinetics,” Int. J. Hydrogen Energy, 41 (44), pp. 19881-19893.
M23. Yuan, C., Jarrett, C., Chuch, W., Kawajiri, Y., and Henry, A., 2015, “A New Solar Fuels Reactor Concept Based on a Liquid Metal Heat Transfer Fluid: Reactor Design and Efficiency Estimation,” Sol. Energy, 122, pp. 547-561.
M24. Brendelberger, S., and Sattler, C., 2015, “Concept Analysis of an Indirect Particle-Based Redox Process for Solar-Driven H2O/CO2 Splitting.” Sol. Energy, 113, pp. 158-170.
M25. Zoller, S., 2020, “A 50 KW Solar Thermochemical Reactor for Syngas Production Utilizing Porous Ceria Structures,” ETH Zurich.
M26. Li, L., Yang. S., Wang, B., Pye, J., and Lipiński, W., 2020, “Optical Analysis of a Solar Thermochemical System with a Rotating Tower Reflector and a Receiver-Reactor Array,” Opt. Express, 28 (13), p. 19429.
M27. Brendelberger, S., Rosenstiel, A., Lopez-Roman, A., Prieto, C., and Christian Sattler, 2020. “Performance Analysis of Operational Strategies for Monolithic Receiver-Reactor Arrays in Solar Thermochemical Hydrogen Production Plants,” Int. J. Hydrog. Energy, 45. pp. 26104-26116.
M28. Furler, P., and Steinfeld, A., 2015, “Heat Transfer and Fluid Flow Analysis of a 4 kW Solar Thermochemical Reactor for Ceria Redox Cycling.” Chem. Eng. Sci., 137, pp. 373-383.
M29. Zoller, S., Koepf, E., Roos, P., and Steinfeld, A., 2019, “Heat Transfer Model of a 50 KW Solar Receiver-Reactor for Thermochemical Redox Cycling Using Cerium Dioxide,” J. Sol. Energy Eng. Trans. ASME, 141 (2).
M30. Lidor, A., Fend, T., Roeb, M., and Sattler, C., 2020, “Parametric Investigation of a Volumetric Solar Receiver-Reactor,” Sol. Energy, 204 (December 2019), pp. 256-269.
M31. Hoes, M., Ackermann, S., Theiler, D., Furler, P., and Steinfeld, A., 2019, “Additive-Manufactured Ordered Porous Structures Made of Ceria for Concentrating Solar Applications,” Energy Technol., 7 (9).
M32. Hoes, M., Koepf, E., Davenport, P., and Steinfeld, A., 2019, “Reticulated Porous Ceramic Ceria Structures with Modified Surface Geometry for Solar Thermochemical Splitting of Water and Carbon Dioxide,” AIP Conf. Proc., 2126.
M33. Kyrimis. S., Le Clercq, P., and Brendelberger, S., 2019, “3D Modelling of a Solar Thermochemical Reactor for MW Scaling-up Studies,” AIP Conf. Proc., 2126 (July), pp. 1-10.
M34. Marrocchelli, D., Bishop, S. R., Tuller, H. L., and Yildiz, B., 2012, “Understanding Chemical Expansion in Non-Stoichiometric Oxides: Ceria and Zirconia Case Studies,” Adv. Funct. Mater., 22 (9), pp. 1958-1965.
M35. Tuller, H. L., Bishop, S. R., Chen, D., Kuru, Y., Kim, J. J., and Stefanik, T. S., 2012, “Praseodymium Doped Ceria: Model Mixed Ionic Electronic Conductor with Coupled Electrical, Optical, Mechanical and Chemical Properties,” Solid State Ionics, 225, pp. 194-197.
M36. Bala Chandran, R., De Smith, R. M., and Davidson, J. H., 2015, “Model of an Integrated Solar Thermochemical Reactor/Reticulated Ceramic Foam Heat Exchanger for Gas-Phase Heat Recovery.” Int. J. Heat Mass Transf., 81, pp. 404-414.
M37. Brendelberger, S., Vieten, J., Roeb, M., and Sattler, C., 2019, “Thermochemical Oxygen Pumping for Improved Hydrogen Production in Solar Redox Cycles,” Int. J. Hydrogen Energy, 44 (20), pp. 9802-9810.
M38. Ermanoski, I., and Stechel, E. B., 2020, “Thermally-Driven Adsorption/Desorption Cycle for Oxygen Pumping in Thermochemical Fuel Production,” Sol. Energy, 198 (January), pp. 578-585.
M39. Ermanoski, I., 2014, “Cascading Pressure Thermal Reduction for Efficient Solar Fuel Production,” Int. J. Hydrogen Energy, 39 (25), pp. 13114-13117.
M40. Ehrhart, B. D., Muhich, C. L., Al-Shankiti, I., and Weimer, A. W., 2016, “System Efficiency for Two-Step Metal Oxide Solar Thermochemical Hydrogen Production-Part 3: Various Methods for Achieving Low Oxygen Partial Pressures in the Reduction Reaction,” Int. J. Hydrogen Energy, 41 (44), pp. 19904-19914.
M41. Brendelberger, S., von Storch, H., Bulfin, B., and Sattler, C., 2017, “Vacuum Pumping Options for Application in Solar Thermochemical Redox Cycles-Assessment of Mechanical-, Jet- and Thermochemical Pumping Systems,” Sol. Energy, 141, pp. 91-102.
M42. Li, S., Wheeler, V. M., Kreider, P. B., Bader, R., and Lipiński, W., 2018, “Thermodynamic Analyses of Fuel Production via Solar-Driven Non-Stoichiometric Metal Oxide Redox Cycling. Part 2. Impact of Solid-Gas Flow Configurations and Active Material Composition on System-Level Efficiency,” Energy and Fuels, 32 (10), pp. 10848-10863.
M43. “Sapphire Datashet” [Online]. Available: https://global.kyocera.com/prdct/fc/product/pdf/s_c_sapphire.pdf.
M44. Zhang, S. De, Sun, F. X., Xia, X. L., Sun, C., and Ruan, L. M., 2018, “Multi-Layer-Combination Method to Retrieve High-Temperature Spectral Properties of C-Plane Sapphire,” Int. J. Heat Mass Transf., 121, pp. 1011-1020.
M45. Modest, M. F., 2013, Radiative Heat Transfer, 3rd Ed., Elsevier Inc.
M46. Furler, P., Scheffe, J., Marxer, D., Gorbar, M., Bonk, A., Vogt, U., and Steinfeld, A., 2014, “Thermochemical CO2 Splitting via Redox Cycling of Ceria Reticulated Foam Structures with Dual-Scale Porosities,” Phys. Chem. Chem. Phys., 16 (22), pp. 10503-10511.
M47. Ackermann, S., Takacs, M., Scheffe, J., and Steinfeld, A., 2017, “Reticulated Porous Ceria Undergoing Thermochemical Reduction with High-Flux Irradiation,” Int. J. Heat Mass Transf., 107, pp. 439-449.
M48. Ackermann, S., and Steinfeld, A., 2017, “Spectral Hemispherical Reflectivity of Nonstoichiometric Cerium Dioxide,” Sol. Energy Mater. Sol. Cells, 159, pp. 167-171.
M49. Kim, J. J., Bishop, S. R., Thompson, N., Kuru, Y., and Tuller, H. L., 2012, “Optically Derived Energy Band Gap States of Pr in Ceria,” Solid State Ionics, 225, pp. 198-200.
M50. “Zircar Zirconia,” (845), pp. 2-7 [Online]. Available: https://www.zircarzirconia.com/images/datasheets/ZZ-5010_Rev01_-_ZYZ.pdf?type=filc.
M51. “Zircar Microsil” [Online]. Available: https://www.zircarceramics.com/wp-content/uploads/2017/01/MICROSIL.pdf.
M52. Hussain, N., and Siegel, R., 1975, “Radiation Exchange for a System with Partially Transmitting Wall,” 2, pp. 105-114.
M53. Garnier, J. E., Blumenthal, R. N., Panlener, R. J., and Sharma, R. K., 1976, “A Thermodynamic Study on CaO-Doped Nonstoichiometric Cerium Dioxide,” J. Phys. Chem. Solids, 37 (4), pp. 368-378.
M54. James, D. L., Siegel, N. P., Diver, R. B., Boughton, B. D., and Hogan, R. E., 2006, “Numerical Modeling of Solar Thermo-Chemical Water-Splitting Reactor,” Am. Sol. Energy Soc.-Sol. 2006 35th ASES Annu. Conf., 31st ASES Natl. Passiv. Sol. Conf., 1st ASES Policy Mark. Conf., ASME Sol. Energy Div. Int. Sol. Energy Conf., 3, pp. 1217-1223.
M55. Patankar, A., Wu, X., Choi, W., Tuller, H. L. & Ghoniem, A. F. A Reactor Train System for Efficient Solar Thermochemical Fuel Production. Proc. ASME IMECE 2021 (2021).
M56. Brendelberger, S., von Storch, H., Bulfin, B. & Sattler, C. Vacuum pumping options for application in solar thermochemical redox cycles-Assessment of mechanical-, jet- and thermochemical pumping systems. Sol. Energy 141, 91-102 (2017).
M57. Li, S., Wheeler, V. M., Kreider, P. B. & Lipiński, W. Thermodynamic Analyses of Fuel Production via Solar-Driven Non-stoichiometric Metal Oxide Redox Cycling. Part 1. Revisiting Flow and Equilibrium Assumptions. Energy and Fuels 32, 10838-10847 (2018).
M58. fminsearchbnd, fminsearchcon—File Exchange-MATLAB Central. https://www.mathworks.com/matlabcentral/fileexchange/8277-fminsearchbnd-fminsearchcon.

1. A system, comprising:
a first reactor (R1);
a second reactor (R2);
a high-temperature reaction zone (HT);
a low-temperature reaction zone (LT); and
a heat exchange zone (Recuperation);
wherein the system is configured to cycle through the following four successive steps:
a. R1 in LT and R2 in HT;
b. R1 and R2 in Recuperation;
c. R2 in LT and R1 in HT; and
d. R1 and R2 in Recuperation; and
wherein following step d, the system returns to step a.

2. The system of claim 1, wherein the HT zone is configured to contain an endothermic reaction, and the LT zone is configured to contain an exothermic reaction.

3. The system of claim 2, wherein a product of the exothermic reaction is a reactant of the endothermic reaction.

4. The system of claim 2, wherein the endothermic reaction is a reduction reaction, and the exothermic reaction is an oxidation reaction.

5. The system of claim 1, wherein the system is configured such that, during step b, at least 50% of the thermal energy that is transferred from R2 to R1 is transferred via radiative heat transfer.

6. The system of claim 1, wherein the system is configured such that, during step d, at least 50% of the thermal energy that is transferred from R1 to R2 is transferred via radiative heat transfer.

7. The system of claim 1, wherein, during step a:
contents of R1 are at a first pressure; and
contents of R2 are at a second pressure that is lower than the first pressure.

8. The system of claim 7, wherein the first pressure is greater than 0.5 atmosphere.

9. The system of claim 7, wherein the second pressure is less than or equal to 0.1 atmospheres.

10. The system of claim 7, further comprising a third reactor (R3).

11. The system of claim 10, wherein, during step a, contents of R3 are at a third pressure that is lower than the first pressure and greater than the second pressure.

12. The system of claim 11, wherein the third pressure is within 30% of the geometric mean of the first pressure and the second pressure.

13. The system of claim 10, wherein:
R1 is connected to a first external manifold that is at the first pressure;
R2 is connected to a second external manifold that is at the second pressure; and
R3 is connected to a third external manifold that is at the third pressure.

14. The system of claim 1, wherein the maximum temperature within HT is at least 1100° C.

15. The system of claim 1, comprising a reactor train that is made of reactors linked to each other.

16. The system of claim 15, wherein the reactors within the reactor train are linked to each other using flexible hinges.

17. The system of claim 15, wherein the train is configured such that the reactors can circle in a loop.

18. The system of claim 17, wherein, while the reactors circle in the loop, neighboring reactors do not communicate with each other thermally or exchange gases.

19-40. (canceled)

41. A method of operating a system comprising a first reactor (R1), a second reactor (R2), a high-temperature reaction zone (HT), a low-temperature reaction zone (LT), and a heat exchange zone (Recuperation), the method comprising:
cycling through the following four successive steps:
a. positioning R1 in LT and R2 in HT;
b. positioning R1 and R2 in Recuperation;
c. positioning R2 in LT and R1 in HT; and
d. positioning R1 and R2 in Recuperation; and
following step d, positioning R1 in LT and R2 in HT.

42-75. (canceled)

76. A system of heat exchange comprising two reactors R1 and R2 and three reaction zones, a high-temperature zone (HT), a low temperature zone (LT), and a heat exchange zone (Recuperation), wherein the lengths of R1 and R2 are much longer than the radiative gap between them in the Recuperation zone; and wherein the system cycles through four successive steps consisting of
a. R1 in LT and R2 in HT;
b. R1 and R2 adjacent in Recuperation;
c. R2 in LT and R1 in HT;
d. R1 and R2 adjacent in Recuperation;
wherein following step d, the system returns to step a.

77-87. (canceled)
